(19) United States
(12) Patent Application Publication
(10) Pub. No.: US 2025/0121867 A1
(43) Pub. Date: Apr. 17, 2025

(54) HEAVY CONSTRUCTION TOOLS TRANSPORTATION SYSTEM AND METHODS OF USING THEREOF

(71) Applicant: U-KART SYSTEMS, LLC, Berlin, NJ (US)

(72) Inventors: Eric Smith, Berlin, NJ (US); Scott Ziv, Gaithersburg, MD (US)

(73) Assignee: U-KART SYSTEMS, LLC, Berlin, NJ (US)

(21) Appl. No.: 18/986,510

(22) Filed: Dec. 18, 2024

Related U.S. Application Data
(63) Continuation of application No. 18/588,467, filed on Feb. 27, 2024.
Application No. 18/588,467 is a continuation of application No. 18/234,965, filed on Aug. 17, 2023.
Application No. 18/234,965 is a continuation of application No. 18/210,588, filed on Jun. 15, 2023.
(60) Provisional application No. 63/353,561, filed on Jun. 18, 2022.
(60) Provisional application No. 63/434,173, filed on Dec. 21, 2022.

(51) Int. Cl. B62B 1/12; B62B 3/02; B62B 5/00

(52) U.S. Cl. CPC B62B 1/12; B62B 3/025; B62B 5/0033

(57) ABSTRACT

A modular transportation system including a transportation module with loading features, and methods of use. The transportation module comprising: a frame member having a front and a rear opposing ends, wherein the front end comprising an overhang member having an overhang portion protruding downwardly below the frame member; the overhang portion having at least one approach wheel; a base member comprising a plurality of ground wheels; a lifting assembly connected between the base member and the frame member; the lifting assembly configured to lift and lower the frame member relative to the base member; and a leg member comprising a leg body and at least one loading wheel; the leg body having a first end and a second end; the first end connected to the frame member; and the loading wheel connected to the second end. A cart and work cells reconfigure the system for specialty purposes.

This is a non-provisional utility patent application filed under 35 U.S.C. 111(a)

### CROSS-REFERENCE TO RELATED APPLICATIONS

This application is a continuation of U.S. patent application Ser. No. 18/588,467 entitled “WORKSTATION TRANSPORTATION SYSTEM AND METHODS OF USING THEREOF” filed Feb. 27, 2024, currently pending (attorney docket number 240116); which is continuation of U.S. patent application Ser. No. 18/234,965 entitled “MATERIALS TRANSPORTATION SYSTEM AND METHODS OF USING THEREOF” filed Aug. 17, 2023, currently pending (attorney docket number 230729); which is continuation of U.S. patent application Ser. No. 18/210,588 entitled “TRANSPORTATION SYSTEM AND METHODS OF USING THEREOF” filed Jun. 15, 2023, currently pending (attorney docket number 230615), which claims the benefit of priority under 35 U.S.C. § 119(e) to U.S. Provisional Patent Application Ser. No. 63/353,561 entitled “UTILITY TRANSPORTATION SYSTEM AND METHOD OF USING THEREOF” filed Jun. 18, 2022 and to U.S. Provisional Patent Application Ser. No. 63/434,173 entitled “UTILITY TRANSPORTATION SYSTEM AND METHODS OF USING THEREOF” filed Dec. 21, 2022. All of these applications are incorporated herein by reference in their entireties.

### TECHNICAL FIELD

The present disclosure relates generally to the loading and conveyance system, and more particularly to a wheeled modular loading and transporting system, comprising a loading, unloading and transportation device with modular attachments to reconfigure the system for various specialty purposes. The present disclosure further relates to methods of using the system.

### BACKGROUND

Many industries, as well as individual consumers, are routinely engaged in procuring, loading, transporting, and unloading heavy loads. For instance, contractors, farmers, delivery, maintenance, tradesmen, musicians, and others are routinely involved in transporting heavy objects, such as materials, equipment, instruments, goods and tools. This process routinely involves procuring a transportation/conveying device; manually pushing the device to acquire the objects; loading them onto the device; pushing the device back to a vehicle; manually unloading the objects to a vehicle; returning the device to the place of origin; and again, manually unloading the vehicle and further often carrying the objects to destination. This process is physically demanding, time-consuming and routinely requires multiple people to accomplish, thus making it cost-inefficient for business, and often unsafe.

Different types of loading and transporting solutions currently exist. Sometimes, tailgate lift devices that are permanently installed at the rear end of a vehicle, such as a work truck, may be used for loading and unloading heavy items into the vehicle. However, these devices fail to fully address loading and conveying needs of consumers, as they are bulky, unsightly, expensive, and complex to install, operate and maintain. Moreover, an intermediate device is still required for transporting the objects to and from the vehicle, and thus a heavy manual labor is still involved in loading the intermediate device, reloading heavy objects to the lift platform, and later unloading and transferring the objects once again at a point of destination. Furthermore, majority of the vehicles are not capable of accommodating the lifts.

Other attempted solutions include portable devices, such as carts and platform-type trolleys, but these fail to sufficiently address the needs of the industry due to limited weight capacity, poor maneuverability over challenging terrain, and pre-set (“non-flexible”) configurations that restrict their utility to particular applications.

Accordingly, applicants have recognized that there is a prominent need in a single heavy-duty device/system that would enable a fast, efficient, and safe way for a single person to load and unload heavy objects/loads to and from an elevated surface (for instance, a vehicle) and transport them over challenging terrains; and that it is highly desirable for such device/system have at-will customizable (“flexible”) configuration capable of meeting diverse industry and consumer needs.

This background information is provided to reveal information believed by the applicant to be of possible relevance to the present invention. No admission is necessarily intended, nor should be construed, that any of the preceding information constitutes prior art against the present invention.

### SUMMARY

In view of foregoing and other problems, embodiments of the present invention are related to a transportation system that satisfies these needs and to methods of using the system. With its unique and novel features, the present invention advantageously provides an ability for a single person to transport heavy loads (up to 1,000 lb.) and load them along with the transportation system onto a vehicle/elevated surface. The transportation system may provide an ability to easily transport heavy loads in time-efficient, safe, and convenient way, so that once the loads/objects are acquired at a place of origin, there is no need to unload the them until they reach their desired destination. The system allows for heavy loads to be single handedly transported to a vehicle/elevated surface, loaded, and unloaded, along the system, to and from the vehicle/elevated surface, and delivered to a desired location. Embodiments of the system structure allow for enhanced stability and maneuverability, so that it may be advantageously operated on various terrains and often under unfavorable environmental conditions. Embodiments of present invention may also advantageously allow for “flexible” modular design, so that the system may be configured and re-configured at-will to enable multitasking and accommodate specific storage and hauling, organizing and other task-specific needs of diverse consumers.

In some embodiments, the transportation system may include a cart. The cart is a module of the system that is operable to mate to the transportation module. The transportation module and the cart can be interlocked to connect or be separated, by use of interlocking mechanism, herein referred to as a transportation module-to-cart coupling mechanism. The transportation module may be used to relocate carts.

In some embodiments, the transportation system may further comprise interchangeable task-specific modules, herein referred to as work cells that allow further customize the system. The work cells may include pre-configured industry specific units for different types of loads, tasks, storage, hauling and performance needs, or comprise custom-assembled/made-to-order units operable to meet a particular user or industry requirements. The work cells may be configured to be connected to the cart by a cart-to-work cell coupling mechanism. The cart may be configured to host a single work cell at a time, wherein the work cell may comprise a single or multiple features/structures secured upon a work cell platform.

Moreover, the flexibility of the transportation system allows a user freedom to build his/her own work cell configuration in accordance with individual needs and attach it to the cart of the system. However, in order to safely operate the system including the user-built work cell and due to potentially heavy loads involved (up to 1,000 lbs.), a connecting module disclosed herein may be necessary. The connecting module may serve as a coupling and interfacing device between the cart and the user-built work cell.

A single transportation module may be conveniently used to sequentially relocate multiple carts; however, a single cart may be coupled to the transportation module at a time. For instance, once the user may be done using the transportation module to transport and/or load and unload one cart that may have a particular work cell coupled thereto, the transportation module may be disengaged from that cart and be later used with other carts that may optionally have same or different work cells attached; thus, supporting multitasking and advantageously improving work efficiency.

Embodiments of the system structure provide an elegant and robust solution that may improve time and labor efficiency, reduce manpower required to accomplish heavy-duty tasks, eliminate or substantially minimize manual labor, and increase business profits. Moreover, the system may be conveniently used to store and organize items (such as tools and materials, equipment) while they are not in immediate use and may furthermore be configured as a work and/or tool-charging station. While the disclosed system may be particularly adapted for transporting loads, such as materials, tools and equipment, although several features of this invention do not restrict it for that use. For example, and without limitation, the system with no or minimal alteration may be used to transport, load and unload people or animals. The present invention further relates to methods of using the system.

These and other objects, features and advantages according to embodiments of present invention may be provided by a transportation system including a transportation module, wherein the transportation module includes: a frame member defining a longitudinal axis (X1) and having a front and a rear opposing ends, wherein the front end comprising an overhang member having an overhang portion protruding downwardly below the frame member; the overhang portion having at least one wheel, herein referred to as an approach wheel; a base member comprising a plurality of wheels, herein referred to as ground wheels, that are configured for engaging and rolling over a supporting surface; a lifting assembly connected between the base member and the frame member; the lifting assembly configured to lift and lower the frame member relative to the base member; and a leg member comprising a leg body and at least one wheel, herein referred to as loading wheel; the leg body having a first end and a second end; the first end connected to the frame member; and the loading wheel connected to the second end.

In some embodiments, a leg member may include two loading wheels. The overhang member may include a structure that protrudes downwardly from the frame member. The overhang may be connected to the frame member for instance, by welding, bolts, screws or made integrally formed monolithic unit with the frame, for instance, molded, formed or produced by an additive manufacturing method. In some embodiments, the overhang member may wholly or partially be indirectly connected to the frame member; for instance, there may be at least one additional structure positioned between the frame member and the overhang member. The overhang member may include at least one, but preferably two or more approach wheels. The approach wheel(s) may be operable to rest on the vehicle while loading and unloading the transportation module into and from a vehicle and may contribute to stability and mobility, while ground wheels are being retracted or semi-retracted and while advancing the system into/onto a vehicle or onto alternative elevated surface. The system may include at least two, but preferably four ground wheels. The ground wheels may be primarily responsible for the system mobility over a supporting surface, such as a ground surface, elevated surface, vehicle bed, truck platform or any other underlying surface/terrain. The leg member may be used to support and stabilize the system while it is being loaded/unloaded into and from a vehicle/an elevated surface. The leg body may be fixedly or detachably connected to the frame member. The leg member may be wholly or partially retractable to the frame member when not in use, or may be configured to be stored otherwise; for example, and without limitation, under frame member. The leg member may also be foldable. Hence, when referring herein to extending/retracting the leg member, or referring to the leg member as being extended/retracted, the current disclosure intends to encompass any way of extending/retracting the leg member, such as extending/retracting the leg member from the frame member, extending/retracting the leg member from under the frame member, unfolding/folding the leg member, but not limited thereto.

The leg body may be length-adjustable. For example, and without limitation, the leg body may be foldable, collapsible, telescopically extendable, retractable, or any combination of the former; so that it may be shortened and lengthened depending on particular needs of a user; for instance, as when loading/unloading the system to and/from elevated surfaces of various heights.

The leg body length-adjustment mechanism may be manual or motorized. For example, and without limitation, the leg body length-adjustment mechanism may and rely on electrical power, pneumatics, hydraulics, and may include mechanical linkages, screws, latches, hand/foot crank, scissor lift, a lead screw crank, balls screws, roller screws, but not limited thereto. The leg member may additionally include at least one locking element, such as bolt, spring, hinge, pins, or latches, but not limited thereto, that is operable to lock the leg body in a desired length configuration.

For example, and without limitation, the leg body length adjustment mechanism may include telescoping beams, bolts, pins, or latches. In some embodiments, the length of the leg body be adjusted as follows: the leg body may include socket beams with removable pins and extendable beams with two or more sizing holes configured change the protrusion length of the extendable beams; so that the length may be adjusted by removing the pins, extending the beams to a desired length, and replacing the pins.

The frame member may also include leg-receiving means, so that said leg member operable to extend from and retract to these means. The frame member may additionally include at least one holding element operable to prevent the leg member from extending or sliding out of the leg-receiving means while the leg member is in transit or not being used; such as a strap, a pin, a latch, or magnets, but not limited thereto. For example, and without limitation, the leg-receiving means may include at least one tubular or rail-shaped receiver, so that the leg body is operable to extend from and retract into and extend from the receiver. The leg body may be pivotally and/or slidably connected to the frame member, by mounting means having rotational axes, such as, pins, wheels, rollers, ball bearings, or mechanical linkages. In some embodiments, the leg receiving means may comprise, a leg receiving assembly, that may include a pair of spaced apart linear slide rails extending longitudinally, each of the rails having a medially facing track; and wherein the first end of the leg body mounted to the medially facing tracks by mounting means having rotational axes; the tracks configured to translatably receive the leg body, so that the leg body operable to extend and retract from the tracks; and pivot about the rotational axes when extended. In some embodiments the overhang portion of the overhang member may be mounted to or below a front portion of the rails. However, other leg receiving mechanisms can and will suffice and are intended to be within the scope of current disclosure.

The transportation module may have leg body immobilizing means configured to secure the leg member in substantially vertical position. The immobilizing means may include the leg body having a locking element and the frame member having a receiving element, wherein the receiving element configured to releasably couple to the locking element; so that the leg member operable to be secured in a position substantially perpendicular to a supporting surface. The locking/receiving elements may include, but not limited to, at least one of the following: a locking pin, a pivoting pin, a bolt, thumb-screws, a kinematic linkage, a latch, a fastener, a hook, a loop, a magnet, a Velcro-type fastener, or any combination thereof. The immobilizing means may include at least one locking pin on the leg body and at least one gravity latch on the frame member, wherein the gravity latch configured to releasably couple to the pin to secure the leg member in substantially vertical position. However, other immobilizing means and mechanisms can and will suffice and are intended to be within the scope of current disclosure.

In some embodiments, the lifting assembly may be manual. For example, and without limitation, the manual lifting assembly may and include a device, such as manual crank, foot pedal lift, screw type jack lift, leadscrew, pallet jack, manual pump or combination thereof. Alternatively, the lifting assembly may be powered (for instance, electrically powered, hydraulically powered, pneumatically powered or combination thereof) or may comprise a combination of manual and powered components. The powered lifting assembly, as well as the lifting assembly comprising a combination of manual and powered components, are configured to be connected to a source of power and include all necessary power delivery components and user interaction devices/elements to operate them. Likewise, the manual lifting assembly comprises all necessary user interaction devices/elements to operate it. For example, and without limitation, an electrically powered lifting assembly may include scissor lifts, leadscrews, pistons, kinematic linkages, linear actuators, motors, electrical pumps gearboxes, gear motors, bearings, closed loop motors, linear encoders, rotary encoders or combination thereof. The scissor lifts may include a single scissor lift or multiple scissor lift; for instance, double, triple, but not limited thereto. In some embodiments, the powered lift assembly may include an electrically powered linear actuators and a scissor lift, such as a double scissor lift. Alternatively, the lifting assembly may include a leadscrew lift, having at least one, but preferably three or more vertical leadscrews that are configured to rotate simultaneously to raise and lower the frame member. A hydraulically powered lifting assembly may include, for example, and without limitation, electrically or manually powered hydraulic pump, hydraulically lift cylinder, tubes, fittings, pedals or combination thereof. A pneumatically powered lifting assembly may include devices, such as pneumatic cylinders, electrically or manually powered pneumatic pumps, tanks, tubes, fittings, pedals, or connectors for external air pressure (e.g., shop or compressed air), but not limited thereto. For example, and without limitation, electrical power delivery components may include one or more of the following: a battery that may be rechargeable, a power management circuit that may comprise charging and discharging voltage management circuits, a control panel, wires and a power regulator. Although, other powered lifting mechanisms/assemblies and power delivery component can and will suffice and are intended to be within the scope of this disclosure. In some embodiment the frame member may include a pair of lateral slide tracks extending longitudinally along lateral sides of the frame member, and the base member, may be include a pair of base member slide tracks extending longitudinally along lateral sides of the base frame, wherein the slide tracks of the frame member and the base frame may be configured for a scissor lift attachment.

The transportation system may be motorized, and the transportation module may include a first motor, operable to drive at least two of the plurality of ground wheels, the motor configured to be connected to a source of power. The motorized ground wheels may advantageously enable to drive the system over particularly rough terrain without or with unsubstantial manual effort. The motor, for instance, and without limitation, the motor may run on electrical power, gasoline, compressed air, solar energy, or any combination thereof. The motor may be powered, for example, and without limitation, by a single or multiple electric and/or solar batteries, capacitors, inverters, generators, AC wall power or by any combination thereof. The motor may be electrically powered, preferably, by at least one electrical battery, which may be rechargeable. The transportation module may include components used to control the motor that may include one or more of the following: a control board, a DC motor driver, such as integrated monolithic circuit chips (e.g., L298, TB6612FNG), logic system, microcontroller, fully integrated computer, but not limited thereto. A fuse or thermofuse in line with the motor may be included for overcurrent protection.

The transportation module may include a second motor, operable to drive the approach wheel(s), the motor configured to be connected to a source of power. The approach wheel(s) and the ground wheels may be driven by the same (first) motor, for instance, using gears/gear train(s); so that an additional (second) motor may be omitted. The gear(s) may be positioned above some ground wheels, so that when ground wheels are driven by a first motor, the gears may mesh to a gear train that may be connected to the approach wheel(s) to spin them. The second motor may be electrically powered. In other embodiments, the motor(s) and/or the lifting assembly may rely on gasoline or other liquid/solid fuel.

In some embodiments the transportation system may include a single motor operable to drive at least two of said plurality of ground wheels and approach wheels.

The transportation module may include at least one user engagement portion, that may include at least one user engagement device, such as a power control switch controlling motor(s) and/or the powered lifting assembly, switch controlling to ground wheels' brakes, a key switch for accessing the system, secondary control switch, a touch screen device configured to be connected to the integrated computer, a structure operable to host a power source, but not limited to thereto; and wherein the devices may be used alone or in combination and may be grouped together located on a single feature of the transportation module or be spread among multiple features.

The transportation module may include a handle connected to the rear end of the frame member. The handle may be used to push, pull and steer the system. The handle may be fixedly or detachably connected to the frame member. The handle may, furthermore, be length-adjustable, so that a user may adjust its length according to his height and comfort preferences, task at hand, and/or load geometry (e.g., large, bulky, oddly-shaped), or may optionally remove the handle. The handle may be pivotally connected to the frame member. The handle may pivot to assume at least a substantially horizontal position, to accommodate for large/long and/or oddly shaped objects. In some embodiments, the handle may be operable to pivot even further downwardly, so that after assuming the substantially horizontal position, it may be further pivoted downwardly to assume a substantially vertical position. The handle may be foldable. The handle may include at least one user engagement portion. Alternatively, or additionally, at least one user engagement portion may be located elsewhere within the system. In some embodiments, the handle may include at least one first member connected to the rear end of the frame member, and at least one second member mounted at an angle relative to the first member, wherein the first member is length-adjustable. In some implementations, the handle may include a handle container, wherein the container may be fixedly or detachably connected to the handle or may be integrally formed as monolithic unit with the handle. The handle container may additionally include at least one charging port for a mobile device, such as a mobile phone, a tablet, a laptop computer, but not limited thereto.

The frame member may include a platform member that extends longitudinally between its front and rear ends. The platform member may have a top surface and a bottom surface. The platform that may comprise a continuous monolithic unit or may have a dosed geometric shape which may define an enclosed voids/apertures. The platform may have, at least one aperture extending therethrough; for example, and without limitation, hole, slit, slot, opening, groove, gap, perforation, space, passage, vent, or combination thereof; wherein one or more of the apertures may be threaded. The platform may include indentations that do not extend therethrough. In some embodiments, at least one of the apertures may be a part of transportation module-to cart coupling mechanism and may be configured to mate with the transportation module-to-cart mating features. In some embodiments, the handle may be fixedly/pivotally connected to the platform and may be length/adjustable. In some embodiments the leg receiving means may be mounted below the platform member. For example, and without limitation, the slide rails may be mounted below the platform member and extend longitudinally.

The transportation module of the system may include a container for articles that may be mounted to the frame member. The container may include for example, and without limitation, a basket, an open container, a container with lid, a drawer, a tool holder, peg board, hanger or combination thereof. The container may be fixedly or detachably mounted to the frame member.

The rear portion of the frame member may include a strut. The strut may be integrally formed as a monolithic unit with the frame member or may be a separate unit that may be, for instance, welded, bolted, or otherwise affixed to the frame member. The strut may include at least one of the user engagement devices. In some implementations, the strut may host at least one of the following: a power source, such as a battery, battery packs, accumulators; and/or at least one additional device, such as power control switch controlling motor(s), switch controlling the powered lifting assembly, switch controlling to ground wheels' brakes, a key switch for accessing the system, a touch screen device configured to be connected to the integrated computer, or a charging station, but not limited thereto. The strut may further include at least one additional strut handle. In some embodiments, the leg-receiving means may be located on/within the strut or attached thereto; for example, the strut may include a receiver configured to receive the leg member, so that the leg member may be extended from and retracted to the receiver. For example, and without limitation, the receiver may be tubular. In some embodiments, the strut may host at least one leg body immobilizing means element. For example, and without limitation, the leg body may include a laterally protruding locking pin and the strut may include a gravity latch, wherein the latch configured to releasably couple to the locking pin; to secure the leg body in substantially vertical position. In some embodiments, the strut may be mounted to a rear portion of the slide rails and may protrude downwardly. In some embodiments, a contracted lifting assembly and the base member may be configured fit into a cavity formed between the overhang member and the strut, so that the bottom of the ground wheels' may be aligned with the approach wheel of the overhang member. The strut may include at least one user engagement portion; and may be included in the rear end of the frame member.

The user engagement portion may include an ignition switch, operable to prevent theft. The ignition switch may be located on the handle or on the strut. The leg body length-adjustment mechanism may be activated, for instance, by a push-button, lever or knob located on the leg body or the handle, and/or may be controlled from a user engagement portion located on the handle or on the strut.

The transportation module may include the ground wheels immobilizing locks operable to immobilize at least two ground wheels, and configured to secure the position transportation module in place when system is not in motion; that may be particularly advantageous on a sloped terrain. The locks may be located on the ground wheels or elsewhere on the base member. For example, and without limitation, the ground wheels may comprise lockable caster wheels having friction locks or pins operable to prevent the wheels from spinning. At least two ground wheels, such as rear ground wheels, may be swiveling and may allow the system to be loaded/unloaded sideways; wherein swiveling function may be activated on demand, for example, by a manual foot lock. In some embodiments, all ground wheels may be swiveling.

The leg member may include a shock absorbing assembly. The shock-absorbing assembly may be configured to stabilize the leg member, particularly on uneven supporting surface, such as rough terrain. The shock absorbing assembly may include, for example, and without limitation, a shock, a shock pivot, shock arm, or any combination thereof.

The loading wheels of the leg member may be swiveling, wherein the swiveling function may be activated on demand, for example, and without limitation, by a manual foot lock.

The overhang member may have a height h1 and the lifting assembly in a substantially contracted state together with the base member may have a cumulative height h2, and wherein h1 is greater or equal h2 (h1≥h2); so that when the system is being loaded to an elevated surface/vehicle and the approach wheel of the overhand member engages that surface, the lifting assembly may contract, so that the base member may be elevated enough that the ground wheels at least substantially align with or rise above the level/height of the elevated surface upon which the approach wheel is rested. The height h1 may be measured from a top surface of the frame member to the lower portion on the circumference of the approach wheel that is in contact with a surface. In some embodiments, wherein the frame member may include the platform member, the h1 may be measured from a top surface of the platform member to the outer portion of the approach wheel that is in contact with a surface. In some embodiments, h1 and h2 may not necessarily abide to the aforementioned relative dimensions; for example, and without limitation, when the lifting assembly may be mounted to a structure protruding above the frame member.

The frame member may have a length l1, and the base member may have a length l2, and wherein l1 is greater than l2 (l1>l2). The l1 may be measured from the front end to the rear end of the frame member, and l2 may be measured between outermost front and rear ends of the base member. In some embodiments, l1 and l2 may not necessarily abide to the aforementioned relative dimensions.

The transportation module may include at least two side bars that may be retractable form lateral portions of the frame member to engage the supporting surface and provide additional stability. The side bars may be particularly useful when heavy loaded system is being loaded/unloaded to high elevated surface, such as high vehicle platform. The side bars may be wheeled.

The ground wheels may be configured according to a user request and may include custom wheels designed for a particular terrain or task. Alternatively, the ground wheels may be detachable, and the system may include additional wheel sets that that may be exchangeable with the ground wheels. The wheel sets may include wheels configured for different terrains and applications, and may differ in size, material, and design.

The transportation module may include at least one charging port operable to charge devices, such as tools, equipment, mobile devices, but not limited thereto, from the lifting assembly's power source; for instance, from a battery. The charging ports may be internal and/or external.

In some embodiments, the transportation module may include at least one headlight that may be mounted, for example to the overhang member, the frame member, but not limited thereto.

In some embodiments, the transportation module may be autonomous. It may utilize, for example, and without limitation, omniwheels, a steering system, an autonomous computer, sensors, lidar sensors, to move the transportation module from one location to another.

In some embodiments, the transportation system may include a cart. The transportation module and the cart can be interlocked to connect or be separated. A single transportation module may be conveniently used to relocate and load multiple carts; though the carts may be connected to the transportation module one at a time; so that once one cart has been relocated and/or loaded, the transportation module may be disconnected from that cart and used to relocate and/or load other carts. Furthermore, the cart may be relocated over short distances when the transportation module is not immediately available; for instance, when the transportation module is being used for relocating/loading other carts.

The cart includes a cart body and at least one front wheel. The cart body has a front and a rear opposing sections; and the front wheel is mounted to the front section of the cart body. The cart body configured to detachably couple to the frame member of the transportation module.

In some embodiments, the cart may have two front wheels that may be mounted to the front section of the cart body. The front wheel(s) may be operable to rest on the elevated surface/vehicle while loading and unloading the system into and from the elevated surface/vehicle. The front wheel(s) may also enable a user to manually relocate disconnected cart over short distances. The front wheels may be swiveling, wherein the swiveling function can be switched on/off on demand; for example, and without limitation, by a manual foot lock.

In some embodiments, the cart may additionally include at least two rear wheels mounted to the rear section of the cart body, wherein the wheels may be removable and/or retractable.

The cart body configured to detachably couple to the frame member of the transportation module. The cart body may be configured to detachably couple to the frame member of the transportation module by a transportation module-to-cart coupling mechanism; that may include, for example, and without limitation, bolts, screws, fasteners, Velcro-type fasteners, clamps, straps, ratchets, ratchet straps, mechanical linkages, protruding elements (such as, pegs or bars) and apertures, grooves, or any combination thereof. Although, other transportation module-to-cart coupling mechanisms and locking features can and will suffice and are intended to be within the scope of this disclosure.

The cart body may include a cart base and a cart platform; the cart platform may have a top surface and a bottom surface; the cart base may be connected to the bottom surface of the cart platform. In some embodiments, the cart platform may be integrally formed as a monolithic unit with the cart base; while in other embodiments, the cart platform may be connected to a cart base and be optionally detachable.

In some embodiments, the cart platform may be configured to detachable couple to the to the platform member of the transportation module. In some embodiments, the cart platform may be configured to detachably couple to the platform member of the transportation module by the transportation module-to-cart coupling mechanism. For example, and without limitation, the transportation module-to-cart coupling mechanism may include bolting, latching, tongue and grooves, pinning, or adhering, straps, fasteners, Velcro-type fasteners.

In some embodiments, the transportation module-to-cart coupling mechanism may include at least one mating element having a first end and a second end; wherein the first end may be connected to the bottom surface of the cart platform; the second end may be protruding downwardly; and the platform member of the transportation module may have at least one groove extending therethrough configured to receive the mating element; so that the cart may be operable to couple to, and uncouple from the transportation module by guiding the mating element into and out of the groove. The mating element may include peg, pin, magnet, or latch, but not limited thereto. The mating element may additionally be secured in place by a locking feature, such as spring-assisted latch, regular latch, pin, clamp, or solenoid. The locking feature may be mounted to the bottom surface of the platform member and used for securing the mating peg/pin within the groove.

In some other embodiments the transportation module-to-cart coupling mechanism may include at least one mating element having a first end and a second end; wherein the first end may be connected to the top surface of the platform member of the transportation module; the second end may be protruding upwardly; and the cart platform may have at least one groove extending therethrough configured to receive the mating element; so that the cart may be operable to couple to, and uncouple from the transportation module by guiding the mating element into and out of the groove. The mating element may additionally be secured in place by a locking feature.

The cart platform may have a plurality of apertures extending therethrough; herein referred to as a first plurality of apertures. The first plurality of apertures may include a plurality of openings arranged in a pattern/array, wherein the openings may be threaded; wherein the openings may be used to secure, for example, and without limitation, other modules, such as one of the work cells, or other objects to the cart platform by bolts, pins, screws, mechanical linkages, or other fasteners. In some embodiments, the first plurality of apertures may include strategically located openings that may be threaded, wherein the openings may be arranged in one of the specific patterns, herein disclosed and further referred to as connecting bolt opening patterns (CBOPs), wherein the openings may be used to secure other modules, such as a work cell or a connecting module to the cart platform; for instance, by fasteners. The openings of the connecting bolt opening patterns may be strategically positioned to uniformly distribute static and dynamic loads experienced by system's moving and stationary parts and to reduce tensile, torsional shear, shear, compression, and bending stresses experiences by each individual fastener, hence dramatically reducing chances of fastener failure while the cart is involved in supporting, transporting and/or loading the work cell; and thus, contributing to safer user experience. Moreover, some of the openings of the COBP may be strategically positioned to serve as fail-safe features in the event of disengagement or failure a single or multiple fasteners; thus, further contributing to safety, confidence, and satisfaction of the user. Furthermore, several or all openings of the cart's platform CBOP may be simultaneously utilized, depending on applied loads and/or on a particular configuration of the work cell coupled thereto. The cart platform may have a single CBOP that is strategically designed to couple to any work cell, or a connecting module disclosed herein; while a particular work cell or the connecting module may have the same CBOP as the CBOP of the cart platform or have a different CBOP, that may have a reduced number of the matching openings. Exemplary embodiments of the cart platform CBOP are disclosed herein. The apertures/openings may be matching when they could be superimposed, and a fastener may be inserted through.

In some embodiments, wherein a work cell may be included in the transportation system, the work cell may directly or indirectly (e.g., through a single or multiple interconnecting features) be secured to the cart platform through the matching openings. Although, other cart-to-work cell coupling mechanisms and locking features can and will suffice and are intended to be within the scope of this disclosure.

The cart body may have cart platform lifting means, said means positioned between and coupled to the cart platform and the cart base, wherein the means may be operable to lift and lower the cart platform relative to the cart base. The cart platform lifting means may be advantageous for user comfort and/or for easing the process of coupling the cart with the transportation module. For example, and without limitation, the cart platform lifting means may include a jack, a pneumatic piston, a hydraulic piston, an actuator, a scissor lift, an electrical actuator, an electrical linear actuator, or combination thereof. In some embodiments, the platform lifting means may be manual; while in some others, they may be powered or include a combination of manual and powered components. The platform lifting means may be electrically, pneumatically or hydraulically operated. The cart may include at least two rear wheels mounted to the rear section of the cart body.

The rear section of the cart body may include at least one rear handle. The handle may be integrally monolithic with the cart platform or may be fixedly or detachably connected to a rear end of the cart platform; so that a user may manually relocating the cart over short distances, if desired; or when the transportation module is not immediately available. The rear handle may be collapsible, foldable or height adjustable. The cart may additionally include at least two side handles. The side handles may be integrally monolithic with the cart base or may be fixedly or detachably connected to the cart base.

The cart may include a tool carrier that may be mounted to the cart, for instance, to the cart body or the cart platform. The tool carrier may be fixedly or detachably mounted to the cart. The tool carrier may include tool mounting means, that may include hooks, fasteners, Velcro-type fasteners, clamps, or magnets, but not limited thereto. In some embodiment the tool carrier may comprise at least two spaced apart holders; wherein the holders may include tool mounting means, that may be attached thereto or be integrally monolithic with the holders. The tool carrier may be mounted to the cart fixedly or detachably. The tool carrier may be conveniently used for transporting and organizing tools and equipment, such as shovels, bars, brooms, vacuum cleaners, axes, crowbars, pry bars, but not limited thereto.

In some embodiments, the top surface of the cart platform may have at least one upwardly protruding peg.

In some embodiments, the cart may include at least one headlight, that may be operable to be configured to be connected to a battery, that may include a battery operable to powering the lifting assembly.

In some embodiments, the transportation system may include a connecting module (CM), wherein the connecting module includes a plate configured to detachably mount to the cart body. The plate may have a plurality of apertures extending therethrough, herein referred to as second plurality of apertures. The apertures may be threaded. The connecting module may be secured to the cart body, for instance, to the cart platform; for example, by fasteners inserted though matching apertures of the second and the first pluralities.

The second plurality of apertures may include a plurality of openings arranged in a pattern/array, that may be threaded. In some embodiments, the second plurality of apertures may include strategically located openings that may be threaded, wherein the openings may be arranged in one of the connecting bolt opening patterns (CBOPs), wherein the openings may be used to secure the connecting module to the cart platform. The connecting module may have CBOP that may be identical to that of the cart or may have a reduced number of openings. An exemplary embodiment of the connecting module CBOP is disclosed herein. The plate may be configured to detachably connect to the cart platform. Though, cart platform may be used to directly mount materials, equipment, and tools thereto; due to potentially heavy loads involved (up to 1,000 lbs.), the connecting module may be necessary; so that the user-built structures/work cells may be mounted to the connecting module, and the connecting module then be mounted to the cart platform. The connecting module may serve as a coupling and interfacing device between the cart and the user-built work cell. In some embodiments at least a single aperture of the second and the first pluralities may be matching. The apertures of the first and second pluralities may be matching when they could be superimposed, and a fastener may be inserted through.

In some embodiments, and when the cart is coupled to the transportation module, the cart front wheel and the transportation module' approach wheel may be positioned above the ground wheels, so that the ground wheels may be primarily involved in weight bearing; and the cart front wheel may be operable to engage an elevated surface contributing to stability and mobility of the system, while its being loaded/unloaded the system to a vehicle/elevated surface, and while the ground wheels may be retracted or semi-retracted.

Alternatively, the cart front wheel may be substantially aligned with the approach wheel and/or ground wheels and may enhance mobility of the system and partake in weight distribution. Moreover, the system may have other wheels' arrangements. For example, and without limitation, the wheels' arrangements may include: the transportation module's approach wheels placed lower relative to the cart front wheels, or the cart front wheel may be omitted/removed, so that the approach wheel may be relied on while loading/unloading the system. In some other embodiments, the approach wheel of the transportation module may be omitted entirely, and the system may utilize the cart front wheel while loading/unloading. Aforementioned wheel's arrangements may allow the system to accomplish the same/similar function(s) and are intended to be within the scope of this disclosure.

At least one ramp may be extendable from the front end of the frame member and/or from the front section of the cart body. In some embodiments the ramp may be stowable into or below the platform member.

The system may include at least one bumper for preventing/minimizing accidental damage in case of contact or collision with other vehicles or objects. The bumpers may be mounted to the transportation module frame and/or the cart body.

The system may also include at least one hoop, ring, or slot that may be connected to the transportation module frame member and/or to the cart body for securing the system on a vehicle during transit.

The system may include at least one detachable gap-filling wedge that may be stored within transportation frame member and/or the cart body and be used to bridge a gap between the open tailgate and truck bed of a pick-up truck or other vehicle.

The system may include at least one load fastening assembly, that may include a built-in ratchet strap, a ratchet strap handle, but not limited thereto may be connected to the transportation module frame member and/or the cart body; that may be operable for securing items thereto and/or securing the cart and/or transportation module on a vehicle. The straps may be connected to the transportation module frame and/or the cart body.

In some embodiments, the connecting module may include at a plurality of handles mounted to the lateral sides of the plate, that may enable two or more people to manually lift the connecting module, that may have the custom-built or user-built work cell coupled thereto, by conveniently gripping by the handles from opposing lateral sides of the plate.

According to some embodiments, the transportation system may include interchangeable task-specific modules, herein referred to as work cells, that allow further customize the system for particular hauling and performance needs. The work cells may be pre-configured for a specific task or be made-to-order according to user requests and may be detachably connected to the cart; for example, by a coupling mechanism, herein referred to as a cart-to-work cell coupling mechanism. A cart may host a single work cell at a time; however, once one work cell is disconnected from the cart, it may be replaced by another work cell; so that a user may customize the system by choosing between task-specific work cells according to imminent needs. A Materials Transport work cell, a Workstation work cell, a Heavy Construction Tools work cell, and a Custom Toolbox work cell are the task-specific work cells disclosed herein and the following details attributed to “the work cell” may be applicable to all, some, or one of them. Once a task specific work cell is selected and connected to the cart, the transportation module may be conveniently used to relocate/load the cart with the work cell coupled thereto. Moreover, a user may choose to own multiple carts and couple a task specific work cell to each cart in advance, and then use a single transportation module to sequentially load/relocate them. Furthermore, the cart may be used to manually relocate one of the work cells over short distances when the transportation module is not immediately available. An assembly that does not include the transportation module and includes the cart with one of the work cells connected thereto may be referred herein as a work cell unit; for example, an assembly including the cart with the materials transport work cell may be referred herein as a materials transportation unit; an assembly including the cart with the workstation work cell may be referred herein as a workstation transportation unit; an assembly including the cart with the heavy construction tools work cell may be referred herein as a heavy construction tools transportation unit; and an assembly including the cart with the custom toolbox work cell may be referred herein as a custom toolbox transportation unit. Therefore, the system advantageously has a “flexible” modular design that may allow it to be configured and re-configured at-will according to specific needs of diverse consumers, advantageously enabling multitasking, saving time, and improving labor efficiency, while providing heavy-duty (up to 1,000 lb.) loading and transporting capacity.

In some embodiments, the work cell includes a plate member, wherein other components that are specific to the particular work cell may be connected to fixedly or detachably. The plate member defines a longitudinal axis X2, and comprising a first end, an opposite second end, and a first lateral side and an opposite second lateral side, wherein the plate member has a top surface, a bottom surface, and a width defined by the first and second lateral sides. The plate member extends longitudinally between the first and second ends; and a perimeter defined by the first and second ends and the first and second lateral sides. The plate member configured to detachable couple to the cart body.

The plate member configured to detachable couple to the cart body; for example, and without limitation, to the cart platform. The plate member may be configured to detachably couple to the cart platform by the cart-to-work cell coupling mechanism. For example, and without limitation, the cart-to-work cell coupling mechanism may include bolting, latching, tongue and grooves, pinning, or adhering, straps, fasteners, screws, mechanical linkages, Velcro-type fasteners.

In some embodiments, the cart-to-work cell coupling mechanism may include the plate member including a plurality of apertures extending therethrough, referred herein as a third plurality of apertures, wherein the openings may be threaded. The plate member may be mounted to the cart platform; for example, by fasteners inserted though matching apertures of the third and the first pluralities. The third plurality of apertures may include a plurality of openings arranged in a pattern/array, that may be threaded. In some embodiments, the third plurality of apertures may include strategically located openings that may be threaded, wherein the openings may be arranged in one of the connecting bolt opening patterns (CBOPs), wherein the openings may be used to secure the work cell to the cart platform. The work cell may have an identical CBOP to that of the cart platform, or have a different CBOP with a reduced number of the matching openings, depending on the load distribution requirements for a particular work cell configuration. For example, and without limitation, one work cells may preferably be fastened to the cart along the perimeter of cart platform, while another may preferably be fastened through the center and the corners of the cart platform, and so on; so that the work cell plate member may use only some of the openings of the cart's platform CBOP for coupling, while other may other openings may be left unused. Exemplary embodiments of CBOPs that may be advantageous for various work cells are disclosed herein. In some embodiments at least a single aperture of the third and the first pluralities may be matching; so that the work cell may be connected to the cart platform through matching apertures of the third and the first pluralities; for instance, by fasteners. The apertures may be matching when they could be superimposed, and a fastener may be inserted through.

Alternatively, the cart-to-work cell coupling mechanism may include the cart platform having grooves, slots or tracks, and the work cell plate member having pins/pegs or rails protruding from its bottom surface, wherein the pins/pegs or rails may be configured to slide into the groves, slots or tracks, and may further be locked in position.

In some other embodiments, the cart-to-work cell coupling mechanism may rely on the cart platform having pins/pegs or rails protruding upwardly from its top surface, and the work cell plate member having grooves, slots or tracks wherein the pins/pegs or rails may be configured to slide into the groves, slots or tracks, and may further be locked in position. The pegs/pins may be locked in position, for instance, by a latch, such as spring latch.

Although, other cart-to-work cell coupling mechanisms can and will suffice and are intended to be within the scope of this disclosure. In some embodiments, the work cell may be configured to couple to the cart base.

In some embodiments, the work cell may include a table, configured to fixedly or detachably mount to the plate member. In some embodiments, the work cell may include a work cell frame, that may be configured to connect to the plate member; for instance, to the top surface of the plate member. The table may be mounted atop of the work cell frame. The work cell frame may include at least one storage compartment. The table and/or the work cell frame may include at least one extendable platform, that may provide additional working area.

In some embodiments the work cell may include a hood. The hood may be configured to enclose at least a part of a work cell. For example, and without limitation, the hood may be connected to the work cell frame, the table or the plate member. For example, and without limitation, wherein the hood may be mounted to the plate member, and the hood may encase at least one element that may be mounted to the plate member; while wherein the hood may be mounted to the work cell frame, the hood may incase at least one element that may be mounted to the work cell frame; and wherein the hood may be mounted to the table, the hood may incase at least one elements that may be mounted to the table. Alternatively, the hood may be connected to the cart body, so that it may be operable to enclose totality of a work cell coupled thereto; and wherein the work cells may be interchangeable. The hood may include a lock to restrict access to the enclosed elements and contents. Some exemplary hood configurations that may be advantageous for a particular work cell are disclosed herein and referred to as a workstation hood, heavy construction hood, and a custom toolbox hood. However, the aforementioned hood designations do not necessarily limit a particular hood configuration to the designated work cell. For example, and without limitation, the heavy construction hood configuration may be used with the custom toolbox work cell and/or the materials transport work cell; the workstation hood configuration may be used with the heavy construction tools or toolbox work cells. Therefore, wherein a particular work cell is claimed of including “a hood”, all disclosed hood configurations are intended to be included in the claim scope, unless explicitly stated otherwise. In some embodiments, the work cell and/or the cart may not include the hood.

In some embodiments, the work cell may include a plurality of handles mounted to the lateral sides of the plate member, that may enable two or more people to manually lift the work cell by gripping by the handles from opposing lateral sides.

The work cell may include a tool carrier that may be mounted to the plate member. The tool carrier may be fixedly or detachably mounted to the plate member. The tool carrier may include tool mounting means, that may include hooks, fasteners, Velcro-type fasteners, clamps, magnets, or pegboards, but not limited thereto. In some embodiments the tool carrier may comprise at least two spaced apart holders; wherein the holders may include tool mounting means that may be attached thereto or be integrally monolithic with the holders. The tool carrier may be conveniently used for transporting and organizing tools and equipment, such as shovels, bars, brooms, vacuum cleaners, axes, crowbars, pry bars, but not limited thereto. The tool carrier may be alternatively mounted to the work cell frame or the table. In some embodiments there may be at least one additional tool carrier that may be attached to the work cell frame and/or the table.

In some embodiments, the work cell may include at least one lighting feature that may include a light-reflective feature, allowing a user to use the work cell and the transportation system in a low-light conditions; that may be located on, for example, and without limitation, to the hood or plate member. In some embodiments, the roof and/or roof extension of the hood may also include at least one lighting feature. In some embodiments, the transportation module and/or the cart may include at least one lighting feature.

In some alternative embodiments a work cell may not include the plate member and its features and structures may be directly (fixedly or detachably) connected to the cart; for example, to the cat platform, but not limited to thereto. Alternatively, the work cell features/structures may be connected to the cart through an additional interconnecting assembly; that may have a frame-like structure or include several supporting elements, that that may be fixedly or detachably connected to the cart platform or cart base, and wherein the work cell features/structures may be mounted to the interconnecting assembly. The interconnecting assembly may include the work cell frame. The supporting elements may include beds, bridges, but not limited thereto. In some embodiments, the work cell frame, or the table may be further omitted and the hood, when included, and some of remaining work cell elements may be configured to be detachably mounted to the platform member of the transportation module or the cart platform.

The user-designed work cell may be coupled to the cart through the connecting module; for instance, as aforementioned.

According to some embodiments, the transportation system may include a materials transport work cell, wherein the system may be referred herein as a materials transportation system. The material transportation system includes the transportation module, the cart, and the materials transport work cell. The transportation module includes a frame member defining a longitudinal axis and having a front and a rear opposing ends, wherein the front end includes an overhang member having an overhang portion protruding downwardly below the frame member, the overhang portion having at least one approach wheel; a base member comprising a plurality of ground wheels, the wheels configured for engaging and rolling over a supporting surface; a lifting assembly connected between the base member and the frame member, the lifting assembly configured to lift and lower the frame member relative to said base member; and a leg member, having a leg body and at least one loading wheel, the leg body having a first end and a second end, the first end connected to the frame member; and the loading wheel connected to the second end. The cart includes a cart body; and at least one front wheel; the cart body having a front and a rear opposing sections, the front wheel mounted to the front section of the cart body; the cart body configured to detachably couple to said frame member of the transportation module. The materials transport work cell includes a plate member that defines a longitudinal axis X2, and comprising a first end, an opposite second end, a first lateral side and an opposite second lateral side, wherein the plate member may have a top surface, a bottom surface, and a width defined by the first and second lateral sides; the plate member extends longitudinally between the first and second ends; and a perimeter defined by the first and second ends and the first and second lateral sides. The plate member configured to detachably couple to the cart body. The materials transport work cell includes a plurality of rails.

The plurality of rails may be fixedly mounted to the top surface of the plate member, or detachably mounted to the plate member; so that the user could customize the load supporting surface based on the immediate transporting needs; for instance, from substantially flat to having different combinations of upright rails. The plurality of rails may include at least two rails configured as discrete elements and/or at least two rails that may be interconnected to form a rail assembly. The plurality of rails may be mounted to the plate member, for instance, by a flange, bolts, magnets, screws, or pins. For example, and without limitation, the plurality of rails may be positioned on the plate member longitudinally or transversely. Although, other arrangements of rails within the plurality may and will suffice and included in the scope of the current disclosure.

For example, and without limitation, the plurality of rails may include substantially U-shaped rails, wherein each rail may have a first end, first curved portion, substantially straight and horizontal portion, second curved portion and a second end; wherein the first and second ends of each rail may individually be affixed to the plate member. In some embodiments, the U-shaped rails may lack the substantially straight and horizontal portion in the middle. The rails may be alternatively shaped; for example, and without limitation, the rails may be shaped substantially as one or more of the following: straight upright posts, T-shaped, square-shaped, rectangular-shaped, or trapezoid. The shapes of rails of the plurality are not limiting, and other shapes may suffice and included in the scope of this disclosure. The rails may additionally include some means for additional elements for securing transported materials; for instance, straps, locks, Velcro-type fasteners, but not limited thereto.

In some embodiments, the rails of the plurality may be may further be configured to be disassembled to multiple shorter discrete sections.

In some embodiments, the plurality of rails may be directly mounted to the plate member, while in some alternative embodiments, the plurality of rails may be mounted to the plate member through at least one interconnecting structure, such as a rail bed assembly, but not limited thereto. The rail bed assembly may be fixedly or detachably mounted to the top surface of the plate member, and the rails may be mounted atop of the rail bed assembly. The rail bed assembly may include a single continuous/interconnected structure mounted along the perimeter of the plate member. Alternatively, the rail bed assembly may include several discrete rail beds mounted along the first and the second ends and/or along the first and the second lateral sides of the plate member. The rail bed assembly may include at least one shock-absorbing material. The shock absorbing material may include a polyether-based polyurethane material, acrylic-based resin, silicon-based resin, thermoplastic polymer, thermoset polymer, polymer composites, polymer nanocomposites, but not limited thereto. The rail bed assembly may include at least one storage assembly. The storage assembly may include, for example, and without limitation, at least one of the following: a drawer, a container, a basket, a pegboard, or a strap.

The materials transport work cell may include at least one rails junction that may extend between and be connected to at least two rails of the plurality of rails. At least one of the included rails junctions may be height-adjustable; so that it may be elevated and lowered relative to the plate member. At least one of the included rails junctions may be detachably connected to the rails, so that it may be disconnected and removed; so that the user may organize the load according to immediate preferences.

The plate member of the materials transport work cell configured to detachably couple to the cart body; for example, and without limitation, to the cart platform. The plate member of the materials transport work cell may be configured to detachably couple to the cart platform by the cart-to-work cell coupling mechanism. For example, and without limitation, the cart-to-work cell coupling mechanism may include bolting, latching, tongue and grooves, pinning, or adhering, straps, fasteners, screws, mechanical linkages, Velcro-type fasteners. In some embodiments, the cart-to-work cell coupling mechanism may include the plate member of the materials transport work cell including the third plurality of apertures extending there through; so that the materials transport work cell may be connected to the cart platform through matching apertures the third and the first pluralities; for instance, by fasteners. The third plurality of apertures may include a plurality of openings arranged in a pattern/array, that may be threaded. In some embodiments, the third plurality of apertures may include strategically located openings that may be threaded, wherein the openings may be arranged in one of the connecting bolt opening patterns (CBOPs), wherein the openings may be used to secure the materials transport work cell to the cart platform. Exemplary embodiments of CBOPs that may be advantageous for the materials transport work cell are disclosed herein. In some embodiments other cart-to-work cell coupling mechanisms may be used, as aforementioned.

In some embodiments, the materials transport work cell may include a table, configured to fixedly or detachably mount to the plate member. In some embodiments, the materials transport work cell may include a work cell frame, that may be configured to connect to the plate member; for instance, to the top surface of the plate member, and the table may be mounted atop of the work cell frame. The work cell frame may include at least one storage compartment. The plurality of rails may be mounted to the table directly, or through other intermediate/interconnecting structure(s). In some embodiments, the plurality of rails may be mounted to the rail bed assembly, that is mounted to the table. The table may include at least one extendable platform, that may provide additional working area. The extendable platform may contain mounting hardware, single or multiple mounting holes, mechanical connectors for power tools, but not limited thereto. For example, and without limitation, the extensible platforms may include mounting hole(s) for mounting a table router, that may allow a routing bit to be leveled with the extendable platform. The extendable platform may be pivotally mounted to the table and may be foldable. At least one storage compartment may be located within the work cell frame and may include a compartment sized to store detached rails of the plurality of rails.

The materials transport work cell may include at least one or more of the load securing means that may be connected to the plate member, and may include a strap, a brace, a mechanical linkage, a net, but not limited thereto. The load securing means may be configured to extend between the first and the second end and/or between the lateral sides of the plate member. For example, and without limitation, at least two straps may be connected to the plate member; wherein the straps may be extendable between the first and the second lateral sides of the plate member; and, moreover, may be retractable into the plate member when not in use. In some embodiments, the plate member may include at least two securing means, wherein at least one extends longitudinally, and at least one another extends transversally.

The materials transport work cell may have a tool carrier that may be mounted to the plate member. The tool carrier may be fixedly or detachably mounted to the plate member. The tool carrier may include tool mounting means, that may include hooks, fasteners, Velcro-type fasteners, clamps, or magnets, but not limited thereto. In some embodiment the tool carrier may comprise at least two spaced apart holders; wherein the holders may include tool mounting means, that may be attached thereto or be integrally monolithic with the holders. The tool carrier may be conveniently used for transporting and organizing tools and equipment, such as shovels, bars, brooms, vacuum cleaners, axes, crowbars, pry bars, but not limited thereto. The tool carrier may be alternatively mounted to the [symbol] cell frame or the table. In some embodiments there may be at least one additional tool carrier that may be attached to the work cell frame and/or the table.

In some embodiments, the materials transport work cell may include at least one electrical outlet, that may be configured to draw power from a battery that may be powering the lifting assembly of the transportation module.

In some embodiments, the materials transport work cell may include at least one rails storage compartment configured to store the plurality of rails, such as detached rails, detached and disassembled rails and/or additional rails. For example, and without limitation, the rails storage compartment may be located within the work cell frame or included as a part of the rail bed assembly. The rail storage compartment may also be mounted to or be an integral part of the plate member. In some embodiments the rails storage compartment may be mounted to the cart, fixedly or detachably.

In some embodiments, one or more or the elements, such as the plate member, the work cell frame, or the table may be omitted and some of the remaining the elements may be configured to be detachably mounted to the platform member of the transportation module or the cart platform. For example, in some embodiments, the plurality of rails may be configured to be mounted to the platform member of the transportation module or the cart platform, wherein the plurality of rails may be mounted detachably; the plurality of rails also may be mounted directly or through an interconnecting structure, such as the rail bed assembly, but not limited thereto.

According to some embodiments, the transportation system may include a workstation work cell, wherein the system may be referred herein as a workstation transportation system. The workstation transportation system includes the transportation module, the cart, and the workstation work cell. The transportation module includes a frame member defining a longitudinal axis and having a front and a rear opposing ends, wherein the front end includes an overhang member having an overhang portion protruding downwardly below the frame member, the overhang portion having at least one approach wheel; a base member including a plurality of ground wheels, the wheels configured for engaging and rolling over a supporting surface; a lifting assembly connected between the base member and the frame member, the lifting assembly configured to lift and lower the frame member relative to said base member; and a leg member having a leg body and at least one loading wheel, the leg body having a first end and a second end, the first end connected to the frame member; and the loading wheel be connected to the second end. The cart includes a cart body; and at least one front wheel; the cart body having a front and a rear opposing sections, the front wheel mounted to the front section of the cart body; the cart body configured to detachably couple to said frame member of the transportation module. The workstation work cell includes a plate member that defines a longitudinal axis X2, and comprising a first end, an opposite second end, a first lateral side and an opposite second lateral side, wherein the plate member has a top surface, a bottom surface, and a width defined by the first and second lateral sides. The plate member extends longitudinally between the first and second ends; and a perimeter defined by the first and second ends and the first and second lateral sides. The plate member configured to detachably couple to the cart body. The workstation work cell includes a table.

The table may be mounted to the plate member fixedly or detachably.

In some embodiments, the workstation work cell may include a work cell frame that may be connected to the plate member, for instance, the top surface of the plate member; and the table may be mounted atop of the work cell frame.

The work cell frame may include at least one storage compartment, such as drawer, basket, container, or combination thereof.

The plate member configured to detachably couple to the cart body; for example, and without limitation, to the cart platform. The plate member of the workstation work cell may be configured to detachably couple to the cart platform by the cart-to-work cell coupling mechanism. For example, and without limitation, the cart-to-work cell coupling mechanism may include bolting, latching, tongue and grooves, pinning, or adhering, straps, fasteners, screws, mechanical linkages, Velcro-type fasteners. In some embodiments, the cart-to-work cell coupling mechanism may include the plate member of the workstation work cell including the third plurality of apertures extending therethrough; so that the workstation work cell may be connected to the cart platform through matching apertures the third and the first pluralities; for instance, by fasteners. The third plurality of apertures may include a plurality of openings arranged in a pattern/array, that may be threaded. In some embodiments, the third plurality of apertures may include strategically located openings that may be threaded, wherein the openings may be arranged in one of the connecting bolt opening patterns (CBOPs), wherein the openings may be used to secure the work cell to the cart platform. Exemplary embodiments of CBOPs that may be advantageous for the workstation work cell are disclosed herein. In some embodiments other cart-to-work cell coupling mechanisms may be used, as aforementioned.

The workstation work cell may include a hood, herein referred to as a workstation hood, that may be operable to encase at least some part of the workstation work cell. In some embodiments, the workstation hood may be connected to the work cell fame, while in some other embodiments, it may be connected to the table. The workstation hood may include a lock to restrict access to the enclosed elements and contents. The workstation hood may include tool storage means configured to safely and conveniently hold tools, such as levels, hand saws, screw guns, nail guns, but not limited thereto. For example, and without limitation, the tools storage means may include designated spaces, holders, hooks, clamps, magnets, containers, drawers, cabinets, racks, and patterns of threaded/unthreaded mounting holes; that may be mounted to an inner surface of the hood. The tools storage means may also include at least one small tools container, such as drawer, basket, peg board, that may be configured to store organize small tools, such as drill bits, blades, screwdrivers, nails, screws, but not limited thereto that may be connected to the inner surface of the hood. Alternatively, or additionally the small tools container may be located within the work cell frame. The tools storage means may also include at least one fastener connected to the inner surface of the hood, wherein the fastener may be operable to store items, such as flat items, elongated items, small tools, but not limited thereto; and may include straps, Velcro-type fasteners, but not limited thereto. The tools storage means may include at least one slot-shaped holder formed within the inner surface of the hood. The tools storage means may be fixedly or detachably mounted to the hood.

The table may include device mounting means that may include elements that be operable to secure tools and devices, such as table saws, routers, drill presses, chop saws, but not limited thereto, to the table. For example, and without limitation, device mounting means may include a plurality of threaded/unthreaded openings that may be formed within the table for securing the tools by fasteners; a clasp that may be connected to the table and operable to secure the tool/device; an orifice within the table operable to receive some portion of the tool/device and secure in within; or any combination thereof.

The table may include at least one extendable platform, that may provide additional working area. The extendible platform may include mounting hardware, such as at least one mounting hole, mechanical connectors for power tools, but not limited thereto. For example, and without limitation, the mounting hardware may include at least one mounting hole for mounting a table router, that may allow a routing bit to be leveled with the extendable platform. The extendable platform may be pivotally connected to the table and may be foldable. Alternatively, the extendable platforms may be configured to extend and retract from the table. A table saw may be built into the table, and the work cell frame may have a leveling assembly operable to level the table, so that it may assume a substantially horizontal orientation. In some embodiments, the work cell frame may include at least one additional extendable platform.

In some embodiments, the work cell frame may include, at least one extendable platform, that may provide additional working area.

The extendable platform may be configured to be used in conjunction with sawhorses. In some embodiments, the workstation work cell may include at least one alternative or additional detachable platform-like structure that may be stored within the workstation work cell when not in use, and that may be configured to be supported by the table or the extendable platform on one side, and by sawhorses or other supporting features on another side when installed.

The workstation hood may include a roof, that may extend over the table when the hood is open. In some embodiments the roof may include a roof extension that may be connected to the roof and operable to extend from the roof. The roof extension may be operable to slide out or unfold from the roof to shield the user from elements, such as sun or rain. The roof and/or roof extension may include additional compartments.

In some embodiments, the roof extension may be configured to cover at least one extendable platform. The roof and/or roof extension may also have connecting elements operable to secure tarps or canopies.

In some embodiments, the workstation work cell may include at least one lighting feature, that may include light reflective feature, allowing a user to safely operate the system in low-light conditions. For example, and without limitation, the lighting feature may include a light bulb, a linear light bulb, light panel, chemiluminescent element, or any combination thereof. The lighting feature may be mounted, for example, and without limitation, to the hood, the plate member, the work cell frame, the table. The roof and/or roof extension may as well include at least one lighting feature.

The workstation work cell may include at least one tool carrier, that may include tool mounting means, that may include hooks, fasteners, Velcro-type fasteners, clamps, magnets, or pegboards, but not limited thereto. In some embodiments, the tool carrier may comprise at least two spaced apart holders; wherein the holders may include tool mounting means that may be attached thereto or be integrally monolithic with the holders; and that may be operable to hold, for instance, shovels, bars, brooms, vacuum cleaners, but not limited to thereto. The tool carrier may be mounted to the plate member fixedly or detachably. The tool carrier may be conveniently used for transporting and organizing tools and equipment, such as shovels, bars, brooms, vacuum cleaners, axes, crowbars, pry bars, but not limited thereto. The tool carrier may be alternatively mounted to the work cell frame or the table. In some embodiments there may be at least one additional tool carrier that may be attached to the work cell frame and/or the table.

In some embodiments, the workstation work cell may include a detachable disposal container and may also include janitorial tools, such as a vacuum cleaner, compressor, a mop bucket, but not limited thereto.

The power tools, including janitorial tools, may be powered by a power source that may be permanently or detachably mounted within the work cell frame. The work cell frame and/or the table may include an electrical outlet. In some embodiments, the workstation work cell may not be configured to include the power source, and the electrical outlet may draw power from a battery that may be powering the lifting assembly of the transportation module; for example, and without limitation, through an additional battery having a power inverter, or through a 12V automotive connector. The workstation work cell may include a power strip operable to connect the included power tools to an external device; wherein the power strip may be operable to plug into a power source at the work site.

In some embodiments, the workstation wok cell may have at least one device for mounting it to an external wall or vertical surface when it is not being immediately connected to the cart; that may advantageously allow the work cell to be used at the owner's shop or place of business, and may also ease the efforts involved in coupling it to the cart, when it needs to be transported to a work cite. The devices may include, but not limited to, hooks, holes, adhesive, Velcro-type fasteners, or latches or any combination thereof.

In some embodiments the workstation work cell may further include at least one of the following: a charging station, operable to charge mobile devices, a charging station for a battery; a power source/plug-in for tools requiring AC power, such as compressors, external generators, power tools.

In some embodiments, at least one of the elements, such as the plate member, the work cell frame, or the table may be omitted and the workstation hood and some of the remaining the elements may be configured to be detachably mounted to the platform member of the transportation module or the cart platform. In some embodiments, the workstation hood may be mounted to a frame-like structure that may be detachably mounted to the cart platform or the platform member of the transportation module.

According to some embodiments, the transportation system may include a heavy construction tools work cell, wherein the system may be referred herein as a heavy construction tools transportation system. The heavy construction tools transportation system includes the transportation module, the cart, and the heavy construction tools work cell. The transportation module includes a frame member defining a longitudinal axis and having a front and a rear opposing ends, wherein the front end includes an overhang member having an overhang portion protruding downwardly below the frame member, the overhang portion having at least one approach wheel; a base member comprising a plurality of ground wheels, the wheels configured for engaging and rolling over a supporting surface; a lifting assembly connected between the base member and the frame member, the lifting assembly configured to lift and lower the frame member relative to said base member; and a leg member, having a leg body and at least one loading wheel, the leg body having a first end and a second end, the first end connected to the frame member; and the loading wheel connected to the second end. The cart includes a cart body; and at least one front wheel; the cart body having a front and a rear opposing sections, the front wheel mounted to the front section of the cart body; the cart body configured to detachably couple to said frame member of the transportation module. The heavy construction tools work cell includes a plate member that defines a longitudinal axis X2, and comprising a first end, an opposite second end, a first lateral side and an opposite second lateral side, wherein the plate member having a top surface, a bottom surface, and a width defined by the first and second lateral sides. The plate member extends longitudinally between the first and second ends; and a perimeter defined by the first and second ends and the first and second lateral sides. The plate member configured to detachably couple to the cart body. The heavy construction tools work cell includes at least one retainer assembly.

The retainer assembly may be mounted to the plate member directly or indirectly. For example, and without limitation, the retainer assembly may be mounted directly to the plate member, or be mounted to a supporting structure, such as a pole, a frame grid, but not limited thereto; and wherein the supporting structure in its turn may be mounted to the plate member. The retainer assembly may include a plurality of holders that may be configured to hold tools and items, such as, tubes, pipes, picks, shovels, digging bars, sledgehammers, rakes, push-brooms, lumber but not limited thereto. The retainer assembly may include a plurality of tubular holders. The tubular holder may have the same or assorted diameters. The retainer assembly may also include at least one holder, such as a hanger, a tube, a slot, a rack, but not limited thereto.

The supporting structure may include a labeling system that may include alphanumeric and/or color-coded indicators, that may be located adjacent to a designated location for the particular tool/item. The labeling system that may be advantageous to keep tools organized, preserve a space for a designated tool, and facilitate sorting; thus, improving labor efficiency, preventing tools misplacement or loss, and save time that otherwise would be required to locate and retrieve a desired tool/item.

A divider may be mounted to the plate member. The divider may extend longitudinally to the plate member and may include at least one peg board.

In some embodiments the heavy construction tools work cell may include storage means. The storage means may include, for example, and without limitation, a storage unit, a cabinet, a drawer, a pegboard, a magnetic rail, a bucket, a slot for small tools or any combination thereof; wherein the elements of the storage means may be interconnected or discrete. In some embodiments, the heavy construction tools work cell may include the storage means, that may include at least one storage unit, at least one shelve, and at least one peg board.

The plate member configured to detachably couple to the cart body; for example, and without limitation, to the cart platform. The plate member of the heavy construction tools work cell may be configured to detachably couple to the cart platform by the cart-to-work cell coupling mechanism. For example, and without limitation, the cart-to-work cell coupling mechanism may include bolting, latching, tongue and grooves, pinning, or adhering, straps, fasteners, screws, mechanical linkages, Velcro-type fasteners. In some embodiments, the cart-to-work cell coupling mechanism may include the plate member of the heavy construction tools work cell including the third plurality of apertures extending therethrough; so that the heavy construction tools work cell may be connected to the cart platform through matching apertures the third and the first pluralities; for instance, by fasteners. The third plurality of apertures may include a plurality of openings arranged in a pattern/array, that may be threaded. In some embodiments, the third plurality of apertures may include strategically located openings that may be threaded, wherein the openings may be arranged in one of the connecting bolt opening patterns (CBOPs), wherein the openings may be used to secure the work cell to the cart platform. Exemplary embodiments of CBOPs that may be advantageous for the heavy construction tools work cell are disclosed herein. In some embodiments other cart-to-work cell coupling mechanisms may be used, as aforementioned.

In some embodiments, the heavy construction tools work cell may include a table, configured to fixedly or detachably mount to the plate member. In some embodiments, the heavy construction tools work cell may include a work cell frame, that may be configured to connect to the plate member; for instance, to the top surface of the plate member and the table may be mounted atop of the work cell frame. The work cell frame may include at least one storage compartment. The retainer assembly may be mounted to the table. In some embodiments, the retainer assembly may be mounted to the supporting structure, such as the pole, that may be mounted to the table.

The table may include at least one extendable platform, that may provide additional working area. The extendible platform may contain mounting hardware, such as at least one mounting hole, mechanical connectors for power tools, but not limited thereto. For example, and without limitation, the mounting hardware may include at least one mounting hole for mounting a table router, that may allow a routing bit to be leveled with the extendable platform. The extendable platform may be pivotally connected to the table and may be foldable. Alternatively, the extendable platforms may be configured to extend and retract from the table. In some embodiments, the work cell frame may include at least one additional extendable platform.

The heavy construction tools work cell may include a hood, herein referred to as a heavy construction hood, that may operable to encase at least some part of the heavy construction tools work cell, wherein the heavy construction hood may be mounted to the plate member, and may include a front panel, an opposing back panel and two opposing side panels, that define its perimeter, and a top panel that may function as a roof. The hood may include the storage means. For example, and without limitation, the tools storage means may include designated spaces, holders, hooks, clamps, magnets, containers, drawers, cabinets, racks, and patterns of threaded/unthreaded mounting holes; and may be mounted to inner surfaces of the panels. The storage means may also include at least one small tools container, such as drawer, basket, peg board, that may be configured to store organize small tools, such as drill bits, blades, screwdrivers, nails, screws, but not limited thereto; that may be connected to the inner surfaces of the panels. Alternatively, or additionally, some storage means may be located within the work cell frame. The storage means may also include at least one fastener that may be connected to inner surfaces of the panels, wherein the fastener may be operable to store items, such as flat items, elongated items, small tools, but not limited thereto; and may include straps, Velcro-type fasteners, but not limited thereto. The storage means may include at least one slot-shaped holder formed within at least one of the panels. The storage means may be fixedly or detachably mounted to the hood panels.

In some embodiments, the heavy construction hood may be connected to the work cell frame; while in some others, it may be connected to the table. In some embodiments, the hood may include a top panel extension, that may be configured to extend out of the top panel and shield the user from weather elements. The top panel extension in its turn may include compartments and/or holders. The top panel extension may be configured to cover the extendable platforms, and/or include elements operable to connect tarps or external features, and/or to secure a larger canopy.

The hood panels may include a plurality of doors that may conveniently allow the user access enclosed structures and items from a most convenient side. The doors may include, for example, and without limitation, a rolling door, a hinged door, a pivoting door, a sliding door, or any combination thereof. The doors may conveniently allow the user to easily access the tools. The back panel may include a back door; that may allow the user to conveniently access the tools, even without unloading the system from the vehicle/elevated surface. The back door may be pivotally connected to the top panel and may be configured to shield a user from elements, such as sun or rain, when the door is opened. The doors may include locks.

In some embodiments, the heavy construction tools work cell may include at least one lighting feature, that may include a light-reflective feature, allowing a user to safely operate the system in low-light conditions. For example, and without limitation, the lighting feature may include a light bulb, a linear light bulb, light panel, chemiluminescent element, but not limited thereto. The lighting feature may be mounted, for example, to the plate member, to the hood and/or back door.

The heavy construction tools work cell may have at least one tool carrier that may include tool mounting means, that may include hooks, fasteners, Velcro-type fasteners, clamps, magnets, or pegboards, but not limited thereto. In some embodiments, the tool carrier may comprise at least two spaced apart holders; wherein the holders may include tool mounting means, that may be attached thereto or be integrally monolithic with the holders; and that may be operable to hold, for instance, shovels, bars, brooms, vacuum cleaners, but not limited to thereto. The tool carrier may be mounted to the plate member fixedly or detachably. The tool carrier may be conveniently used for transporting and organizing tools and equipment, such as shovels, bars, brooms, vacuum cleaners, axes, crowbars, pry bars, but not limited thereto. The tool carrier may be alternatively mounted to the work cell frame or the table. In some embodiments there may be at least one additional tool carrier that may be attached to the work cell frame and/or the table.

The heavy construction tools work cell may include at least one electrical outlet that may draw a power from a battery that may be powering the lifting assembly of the transportation module. The heavy construction tools work cell may include a power strip operable to connect power tools to an external device, wherein the power strip may be operable to plug into a power source at the work site.

In some embodiments, the heavy construction tools work cell may have at least one device for mounting it to an external wall or vertical surface, when it is not being immediately connected to the cart; that may advantageously allow the work cell to be used at the owner's shop or place of business, and may also ease the efforts involved in coupling it to the cart, when it needs to be transported to a work cite. The devices may include, but not limited to, hooks, holes, adhesive, Velcro-type fasteners, or latches or any combination thereof.

In some embodiments the heavy construction tools work cell work cell may include at least one of the following: a charging station, operable to charge mobile devices, a charging station for a battery; a power source/plug-in for tools requiring AC power, such as compressors, external generators, power tools.

In some embodiments, at least one of the elements, such as the plate member, the work cell frame, or the table may be omitted and the heavy construction hood and some of the remaining the elements, such as the retainer assembly or the supporting structure may be configured to be detachably mounted to the platform member of the transportation module or the cart platform. In some embodiments, the heavy construction hood may be mounted to a frame-like structure that may be detachably mounted to the cart platform, or the platform member of the transportation module.

According to some embodiments, the transportation system may include a custom toolbox work cell, wherein the system may be referred herein as a custom toolbox transportation system. The custom toolbox transportation system includes the transportation module, the cart, and the custom toolbox work cell. The transportation module includes a frame member defining a longitudinal axis and having a front and a rear opposing ends, wherein the front end include an overhang member having an overhang portion protruding downwardly below the frame member, the overhang portion having at least one approach wheel; a base member comprising a plurality of ground wheels, the wheels configured for engaging and rolling over a supporting surface; a lifting assembly connected between the base member and the frame member, the lifting assembly configured to lift and lower the frame member relative to said base member; and a leg member having a leg body and at least one loading wheel, the leg body having a first end and a second end, the first connected to the frame member; and the loading wheel connected to the second end. The cart includes a cart body; and at least one front wheel; the cart body having a front and a rear opposing sections, the front wheel mounted to the front section of the cart body; the cart body configured to detachably couple to said frame member of the transportation module. The custom toolbox work cell includes a plate member that defines a longitudinal axis X2, and comprising a first end, an opposite second end, a first lateral side and an opposite second lateral side, wherein the plate member having a top surface, a bottom surface, and a width defined by the first and second lateral sides. The plate member extends longitudinally between the first and second ends; and a perimeter defined by the first and second ends and the first and second lateral sides. The plate member configured to detachably couple to the cart body. The custom toolbox work cell includes a plurality of toolboxes.

The plate member configured to detachably couple to the cart body; for example, and without limitation, to the cart platform. The plate member of the custom toolbox work cell may be configured to detachably couple to the cart platform by the cart-to-work cell coupling mechanism. For example, and without limitation, the cart-to-work cell coupling mechanism may include bolting, latching, tongue and grooves, pinning, or adhering, straps, fasteners, screws, mechanical linkages, Velcro-type fasteners. In some embodiments, the cart-to-work cell coupling mechanism may include the plate member of the custom toolbox work cell including the third plurality of apertures extending therethrough; so that the custom toolbox work cell may be connected to the cart platform through matching apertures the third and the first pluralities; for instance, by fasteners. The third plurality of apertures may include a plurality of openings arranged in a pattern/array, that may be threaded. In some embodiments, the third plurality of apertures may include strategically located openings that may be threaded, wherein the openings may be arranged in one of the connecting bolt opening patterns (CBOPs), wherein the openings may be used to secure the work cell to the cart platform. Exemplary embodiments of CBOPs that may be advantageous for the custom toolbox work cell are disclosed herein. In some embodiments other cart-to-work cell coupling mechanisms may be used, as aforementioned.

The custom toolbox work cell may include a hood, herein referred to as a custom toolbox hood that may include a pair of spaced apart peripheral walls, at least one longitudinal wall and at least one hood wing. The peripheral walls may be mounted to the first and the second end of the plate member. The longitudinal wall may be connected to the plate member along one of its lateral sides. Alternatively, the longitudinal wall may be connected to the plate member substantially parallel or along its longitudinal axis X2. At least one hood wing may be mounted to the longitudinal wall. For example, and without limitation, the hood wing may be pivotally or hingedly connected to one or more of the following: the longitudinal wall, the peripheral walls, a beam extending between the peripheral walls. The hood may be locked. The hood wing may include at least one handle that may be mounted thereto or be integrally formed as monolithic structure with the wing. The hood wing may include a single wing panel or include a plurality of wing panels.

The custom toolbox work cell may also include at least one holder, such as a fastener, a strap, a Velcro-type strap, a magnet, a slot-shaped compartment, a peg board, a container, a basket, a hook, a loop, or any combination thereof. The holder may be mounted to the inner surface of the hood wing. The holder may be additionally, or alternatively mounted to the hood walls; for example, to the inner surface of the hood walls.

In some embodiments, at least one shelving unit may be mounted to the hood walls. for example, to the inner surface of the hood walls. The shelving unit may include at least one shelf.

The plurality of toolboxes may include an assortment of boxes, herein referred to as toolboxes, that may be configured to interlock to each other to form a custom arrangement that most suits immediate needs of the user. The toolboxes may be stackable. At least one of the toolboxes may be configured to detachably couple to the plate member. The user may choose to use one toolbox, or create a custom arrangement that may include multiple or all toolboxes of the plurality. The toolboxes may have assorted sizes and shapes. The toolboxes may include a color-coded and/or alphanumeric labeling system. At least one of the toolboxes may include compartments and/or drawers, that may, likewise, be labeled. In some embodiments the plurality of toolboxes may include at least two task-specific sets of boxes; wherein the boxes may be compatible between the sets; so that the user may mix-and-match boxes from different sets and interlocked them together to create a custom arrangement according to a particular storage needs and task at hand.

In some embodiments, the plurality of toolboxes may include a pre-configured arrangement that may be fixedly or detachably coupled to the plate member.

In some embodiments, the plate member/table may include at least one ratchet strap or clamp, that may be operable to secure the plurality of toolboxes during transit.

In some embodiments, the custom toolbox work cell may include a table, configured to fixedly or detachably mount to the plate member. In some embodiments, the custom toolbox work cell may include a work cell frame, that may be configured to connect to the plate member; for instance, to the top surface of the plate member and the table may be mounted atop of the work cell frame. The work cell frame may include at least one storage compartment. The plurality of toolboxes may be mounted to the table. In some embodiments at least one of the boxes may be configured to detachably couple to the table. The table may include at least one extendable platform, that may provide additional working area. The extendable platform may contain mounting hardware, single or multiple mounting holes, mechanical connectors for power tools, but not limited thereto. For example, and without limitation, the extensible platforms may include mounting hole(s) for mounting a table router, that may allow a routing bit to be leveled with the extendable platform. The extendable platform may be pivotally connected to the table and may be foldable. Alternatively, the extendable platforms may be configured to extend and retract from the table. The work cell frame may include at least one additional extendable platform, that may provide additional working area.

In some embodiments, the longitudinal wall is mounted to the plate member substantially along the X2 and may divide the toolbox work cell lengthwise into two sections. A pair of hood wings may be mounted to the longitudinal wall; for instance, hingedly or pivotally, but not limited thereto; and the wings may be operable to provide the user a separate access to each section, wherein the access may be restricted by a lock. The longitudinal wall may define an enclosed void, herein referred to, as a cutout. For example, and without limitation the cutout may be substantially rectangular or square. In some embodiments, the longitudinal wall may include at least two spaced apart wall sections, wherein the wall section may be separated by a gap, wherein the gap may be operable as the cutout.

In some embodiments, the custom toolbox hood may be connected to the work cell fame; while in some others, it may be connected to the table. In some embodiments, at least one hood wing may include a wing extension, that may be configured to extend out of the hood wing and shield the user from weather elements. The wing extension, in its turn, may include compartments and/or holders. The wing extension may be configured to cover the extendable platform(s), and/or include elements for connecting tarps or external features or to secure a larger canopy.

In some embodiments, the custom toolbox work cell may include at least one lighting feature, that may include light-reflective feature, allowing a user to safely operate the system in low-light conditions. The lighting feature may include, for example, and without limitation, a light bulb, a linear light bulb, lighting panel, chemiluminescent element, or any combination thereof. The lighting feature may be mounted, for example, to the plate member, the custom toolbox hood and/or the hood wing.

The custom toolbox work cell may have at least one tool carrier that may include tool mounting means, that may include hooks, fasteners, Velcro-type fasteners, clamps, magnets, or pegboards, but not limited thereto. In some embodiment the tool carrier may comprise at least two spaced apart holders; wherein the holders may include tool mounting means, that may be attached thereto or be integrally monolithic with the holders; and that may be operable to hold, for instance, shovels, bars, brooms, vacuum cleaners, but not limited to thereto. The tool carrier may be mounted to the plate member fixedly or detachably. The tool carrier may be conveniently used for transporting and organizing tools and equipment, such as shovels, bars, brooms, vacuum cleaners, axes, crowbars, pry bars, but not limited thereto. The tool carrier may be alternatively mounted to the workstation frame or the table. In some embodiments there may be at least one additional tool carrier that may be attached to the work cell frame and/or the table.

The custom toolbox work cell may include at least one electrical outlet that may draw a power from a battery that may be powering the lifting assembly of the transportation module. The custom toolbox work cell may include a power strip operable to connect power tools to an external device; wherein the power strip may be operable to plug into a power source at the work site.

In some embodiments, the custom toolbox wok cell may have one or more devices for mounting it to an external wall or vertical surface, when it is not being immediately connected to the cart; that may advantageously allow the work cell to be used at the owner's shop or place of business, and may also ease the efforts involved in coupling it to the cart, when it needs to be transported to a work cite. The devices may include, but not limited to, hooks, holes, adhesive, Velcro-type fasteners, or latches or any combination thereof.

In some embodiments the custom toolbox work cell may include at least one of the following: a charging station, operable to charge mobile devices, a charging station for a battery; a power source/plug-in for tools requiring AC power, such as compressors, external generators, power tools.

In some embodiments, one or more or the elements, such as the plate member, the work cell frame, or the table may be omitted and the custom work cell hood and the plurality of toolboxes and/or other custom toolbox work cell elements may be configured to be detachably mounted to the platform member of the transportation module, or to the cart platform. In some embodiments, the custom toolbox hood may be mounted to a frame-like structure that may be detachably mounted to the cart platform or the platform member of the transportation module.

The transportation system may be configured as a standard, reduced, or oversized configurations that may comprise the transportation module in standard, reduced or oversized configurations, and may further comprise the cart in standard, reduced, and oversized configurations accordingly. In some embodiments, the system may also include the work cell in a matching configuration. The configurations may be based on physical dimensions. Furthermore, the system may be configured to have different carrying capacities. For example, and without limitation, the standard configuration of the transportation module may have a load capacity of about 600-1000 lbs., preferably about 750-1000 lbs.; the reduced configuration may have a load capacity of about 100-600 lb., preferably about 300-600 lbs.; and the heavy duty configuration may have a load capacity of about 1000-3000 lb., preferably about 1000-2000 lbs. In some embodiments, the size and the load carrying capacity may not necessarily directly correlate.

In some embodiments, the transportation module's components, such as the frame member, the handle, the platform member, the lifting assembly, the base member frame, the leg body and the linear slide rails, but not limited thereto, may be made of a material comprising aluminum, steel (e.g., stainless, cold-rolled or hot-rolled steel), titanium, titanium alloys, fiber reinforced plastic (FRP) composites, plastic, or wood. However, any other materials used alone or in any combinations that would allow for structural integrity, heavy lifting and transporting capacity (up to 1,000 lbs. and above) of system should be viewed to be included in the scope of current disclosure by those of ordinary skill in the art. In some embodiments, a rubber or other thermoplastic and/or thermoset polymers, polymer composites and any combinations thereof may be used for example, and without limitation for handles, grips, bumpers and other components of the work cells, the cart and the transportation module. The labeling system may be applied by stamping the alphanumeric and/or colored indicators directly to a part/structure or include a plurality of stickers operable to adhered to the surfaces. The stickers, that may include colored/and alphanumeric indicators may be included in the system as a set to be applied and repositioned at user's convenience.

In some embodiments, polymers and composites including ABS, PEEK, PAEK, PVDF, TPI, PPSF, PA, PEI, PPSU, PC, but not limited to thereto, may be used, for example, and without limitation, for user engagement devices and/or be included in wheels; and FR-4 Fiberglass PCBs, for example, may be used for electronic components.

Furthermore, in some embodiments, some material and/or composites applicable to the system may have intrinsic or imparted shock absorbing and/or vibrational damping properties, to suppress shock and/or vibrations that may affect the system, it's modules and a user while relocating the system over particularly challenging terrains. For example, and without a limitation, at least one of the rails bed, the leg member, the frame member, the platform member, the base member, the slide rails, the cart body, any handles, wheels, bumpers and joint connections may include at least one shock absorbing and/or vibration damping material; wherein the materials may significantly extend the lifetime of the system, its modules and parts and enhance user comfort and safety. It should be understood, however, that neither aforementioned materials listed herein nor the parts, structures and modules of the system that they are referring to are intended to limit the scope of invention in any way and are only exemplary. Other materials can and will suffice and will readily suggest themselves to a skilled person having the benefit of this disclosure. In some embodiments, the system as whole and/or each of its modules and their structures may be composed of several discrete joint sections; while in other embodiments, at least some of them may be welded together or otherwise formed as a monolithic unit.

Embodiments of methods of using the transportation system are provided.

According to some embodiments, a method provided for loading the transportation system to an elevated surface; for example, and without limitation, to a vehicle, wherein the method comprising: providing the system comprising a transportation module, wherein the transportation module comprising: a frame member defining a longitudinal axis and having a front and a rear opposing ends, wherein the front end comprising an overhang member having an overhang portion protruding downwardly below the frame member; the overhang portion having at least one approach wheel; a base member comprising a plurality of ground wheels, the wheels configured for engaging and rolling over a supporting surface; a lifting assembly connected between the base member and the frame member; the lifting assembly configured to lift and lower the frame member relative to the base member; a leg member comprising a length-adjustable leg body and at least one loading wheel; the leg body having a first end and a second end; the first end mounted to the frame member; and the loading wheel mounted to the second end. Then advancing the transportation module along a supporting surface toward an elevated surface edge via said plurality of ground wheels of the base member; lifting the frame member relative to the base member via said lifting assembly, so that the approach wheel is elevated to a height exceeding a height of the elevated surface; advancing the transportation module via said plurality of ground wheels until the base member is adjacent to an edge of the elevated surface and the approach wheel is positioned above the elevated surface; extending the leg member; so that the leg body has achieved substantially vertical position relative to the supporting surface; securing the leg member in a position substantially vertical to the supporting surface; lowering the frame member relative to the base member via the lift assembly until the approach wheel engages the elevated surface; lifting the base member relative to the frame member via the lifting assembly, so that the ground wheels have substantially aligned with the elevated surface; advancing the module via the approach wheel and the loading wheel until the ground wheels engaged the elevated surface; retracting the leg member.

According to some embodiments, a method provided for loading the transportation system to an elevated surface; for example, and without limitation, to a vehicle, wherein the method comprising: providing the system comprising a transportation module and a cart, wherein the transportation module comprising: a frame member defining a longitudinal axis and having a front and a rear opposing ends, wherein the front end comprising an overhang member having an overhang portion protruding downwardly below the frame member; the overhang portion having at least one approach wheel; a base member comprising a plurality of ground wheels, the wheels configured for engaging and rolling over a supporting surface; a lifting assembly connected between the base member and the frame member; the lifting assembly configured to lift and lower the frame member relative to the base member; a leg member comprising a length-adjustable leg body and at least one loading wheel; the leg body having a first end and a second end; the first end mounted to the frame member; and the loading wheel mounted to the second end; and wherein the cart comprising: a cart body and at least one front wheel; the cart body having a front and a rear opposing sections; the front wheel mounted to the front section of the body; the cart body configured to detachably couple to the frame member of the transportation module. Then coupling the cart body of the cart to the frame member of the transportation module; advancing the system along a supporting surface toward an elevated surface edge via the plurality of ground wheels of the base member; lifting the frame member relative to the base member via the lifting assembly, so that the front wheel is elevated to a height exceeding a height of the elevated surface; advancing the system via the plurality of ground wheels until the base member is adjacent to an edge of the elevated surface and the front wheel is positioned above the elevated surface; extending the leg member; so that the leg body has achieved substantially vertical position relative to the supporting surface; securing the leg member in a position substantially vertical to the supporting surface; lowering the frame member relative to the base member via the lift assembly until the front wheel engages the elevated surface; lifting the base member relative to the frame member via the lifting assembly, so that the ground wheels have substantially aligned with the elevated surface; advancing the system via the front wheel and the loading wheel until the ground wheels engaged the elevated surface; retracting the leg member.

According to some embodiments, a method provided for loading the transportation system to an elevated surface; for example, and without limitation, to a vehicle, wherein the method comprising: providing the system comprising a transportation module, a cart, and a work cell, wherein the transportation module comprising: a frame member defining a longitudinal axis and having a front and a rear opposing ends, wherein the front end comprising an overhang member having an overhang portion protruding downwardly below the frame member; the overhang portion having at least one approach wheel; a base member comprising a plurality of ground wheels, the wheels configured for engaging and rolling over a supporting surface; a lifting assembly connected between the base member and the frame member; the lifting assembly configured to lift and lower the frame member relative to the base member; a leg member comprising a length-adjustable leg body and at least one loading wheel; the leg body having a first end and a second end; the first end mounted to the frame member; and the loading wheel mounted to the second end; wherein the cart comprising: a cart body and at least one front wheel; the cart body having a front and a rear opposing sections; the front wheel mounted to the front section of the body; the cart body configured to detachably couple to the frame member of the transportation module; and wherein the work cell comprising: a plate member, the plate member comprising a first end, an opposite second end, and a first lateral side and an opposite second lateral side, wherein the plate member having a top surface, a bottom surface, and a width defined by said first and said second lateral sides, the plate member extending longitudinally between the first and second ends; and a perimeter defined by the first and second ends and the first and second lateral sides, wherein the plate member configured to detachable couple to the cart body. Then coupling the plate member of the work cell to the cart body of the cart; coupling the cart body of the cart to the frame member of the transportation module; advancing the system along a supporting surface toward an elevated surface edge via the plurality of ground wheels of the base member; lifting the frame member relative to the base member via the lifting assembly, so that the front wheel is elevated to a height exceeding a height of the elevated surface; advancing the system via the plurality of ground wheels until the base member is adjacent to an edge of the elevated surface and the front wheel is positioned above the elevated surface; extending the leg member; so that the leg body has achieved substantially vertical position relative to the supporting surface; securing the leg member in a position substantially vertical to the supporting surface; lowering the frame member relative to the base member via the lift assembly until the front wheel engages the elevated surface; lifting the base member relative to the frame member via the lifting assembly, so that the ground wheels have substantially aligned with the elevated surface; advancing the system via the front wheel and the loading wheel until the ground wheels engaged the elevated surface; retracting the leg member.

It should be noted that according to the aforementioned method, the work cell may include any one of the work cells disclosed herein having the plate member.

In some embodiments, the methods may include a step of adjusting the length of the leg body, wherein the leg member of the transportation module is length-adjustable. So that the length of the leg member may correlate with the height of the elevated surface; and the loading wheel of the leg member may engage the supporting surface.

It should be noted that, although the methods, describe the process of loading the transportation system to an elevated surface, the process of unloading the system from that surface will easily become apparent to the ordinary skilled in the art, having the benefit of the current disclosure, and intended to be included in the scope of the current disclosure. Moreover, the steps of the methods may be reversed and/or performed in order other than aforementioned.

Particular examples of methods of using the transportation system will be further be described by way of exemplary embodiments. Although, other methods of using the system, and its modules that may be evident to ordinary skilled in the arts in view of current disclosure, are intended to be within the scope of the invention disclosure presented herein.

The transportation system is a heavy-duty system of unsurpassed flexibility and versatility. Contractors, farmers, delivery personnel, maintenance men, tradesmen, musicians and others, that constantly involved in transporting materials, tools or equipment may benefit from the system. The system may have the following exemplary advantages and applications. However, other advantages and applications may become easily apparent to the skilled in the art having the benefit of the current disclosure and are intended to be within the scope of the current disclosure.

The system allows to relocate heavy objects, such as materials, equipment and tools (up to 1,000 lbs.), without necessitating loading/unloading objects piece-by-piece. It may be conveniently operated by one person and may be easily loaded to a vehicle along with heavy cargo, often within minutes. The system makes loading and unloading heavy items quick and efficient, and while it may be primarily geared toward commercial and industrial use, it can equally accommodate everyday consumer needs. The system may have all terrain-style ground wheels, so that the system may be used in both indoor and outdoor settings; including construction worksites that may have a particularly rough terrain; and as a result, providing accessibility to various types of work environments, that otherwise be inaccessible. A single transportation module may be used to sequentially load multiple carts; so that the user may, for example, load multiple carts into a vehicle, wherein the carts each may have the same or different work cells coupled thereto according to a task at hand; thus, reducing labor costs. The handle of the transportation module may fold/pivot from an upright position to a position that is substantially parallel to a supporting surface, which may be particularly advantageous when loading/unloading the system from a vehicle, so that the user may easily push and pull the system into and from the vehicle, while standing on the ground; this functionality of the handle also allows for longer and oddly shaped items to be easily accommodated.

The unique structure of the system allows the user to elevate the cargo by adjusting the height frame member of the transportation module with a push of a button, even while the system is in motion; for example, while approaching the vehicle. Moreover, the leg member may additionally be deployed to assist with stability while the system is in motion, if desired. This functionality significantly improves work efficiency, by saving time during loading the system to a vehicle/elevate surface.

The modular design of the system and its flexibility eliminate the need for the user consumers to look and select one of many different types of carts scattered around a parking lot of a construction store, for example; as the transportation system including desired task-specific work cell may be already preconfigured and immediately available to use. This versatility of the system provides great convenience, timesaving, and safety to consumers. Moreover, having the system, a consumer doesn't have to spend time to acquire and return a store provided cart; further saving time and providing convenience.

Having the system handy, a consumer doesn't need to reload items to a vehicle; in contrary to the store carts, when the consumer needs to reload the items to a vehicle manually, right after he just loaded them manually to a cart at the store. Hence, providing convenience and safeguarding consumers from injury that otherwise may arise while lifting heavy items manually, therefore providing safety to the consumers and decreasing injury-related liability to businesses.

A business owner will greatly appreciate convenience and benefits provided by the system, as it eliminates the need for more than one worker to make pick-ups and deliveries of heavy items, thus allowing to maintain a larger workforce at the working site, while reducing overall workforce needed. This translates to an improved labor efficiency and reduced business expenses. Moreover, the business owner can efficiently manage his workforce, as workers do not need to interrupt their workflow to help unload heavy incoming items, as a single person is sufficient for the task and can unload 1,000 lbs. in a time-efficient and safe manner.

The user having the system readily available may benefit large home improvement retailers by providing significant costs reduction associated with workforce required for managing shopping carts, such as collecting them around parking lots.

The versatility of the system enables the user to pre-load the work cell unit (the cart with the work cell coupled thereto) with items beforehand, and couple it with the transportation module later, when desired. Moreover, upon delivering the loaded system to destination, the transportation module may be disengaged from the work cell unit and used elsewhere to transport other carts/units.

The versatility of the system also allows the user to interchange pre-configured or custom-made work cells on the cart, thus accommodating specific industry needs and enabling the end user to change functionality of the system at will. Moreover, the system allows to alignment its loading surfaces with shelves in a warehouse/retailer outlet, minimizing an effort required to transfer materials and/or tools from the shelves to the systems load bearing surfaces and structures.

The system not only provides a safe and convenient way to transport heavy materials, but also allows for the materials to be organized and securely stored when not in use. The multiple locks and other security features prevent theft, save money, and provide a peace of mind to consumers. The structural design of the system enables the user to load and unload heavy items on and off vehicles of ranging heights; and the portability of the system allows it to be available when needed.

Though the utility of the transportation system in the construction sector may be apparent in the view of the current disclosure, the utility of the system and its modules is not limited to the construction applications. Any sectors that routinely involved in transporting and loading heavy cargo, would greatly benefit from the system. For instance, the system may be used for securing and transporting people/animals. For example, and without limitation, the system may be used as an ambulance gurney and/or hospital gurney. The UTS system used as a mobile modular gurney will allow to transport a patient to and from medical or another facility with safety, ease and convenience. For example, the transportation module of the system may be leveled with a surface from which a patient needs to be transferred from, and once the patient is transferred to the module and secured upon, the transportation module with the patient may be loaded to ambulance or another vehicle. Once transported to a destination, the patient may be unloaded and wheeled to a destination with ease, safety and convenience. In some implementations, the transportation module of the system may be configured to couple with a hospital bed, so that a patient may be undisturbed, if transporting and loading/unloading to him to an elevated surface; for instance, an ambulance vehicle, is necessitated. In some embodiments, the transportation module may include a storage for an ancillary medical equipment and medications; and the cart may include additional structural elements; for example, and without limitation, a powered bed frame, pedal controls, and elements operable to allow for reorientation of the patient for comfort or ease of access to medical equipment and operation sites. In other implementations, the cart of the system may serve as a mobile bed, wherein the transportation module may be used to transport it to and from a facility, decreasing number of times a person need to be transferred from one surface to another, reducing efforts of personnel so involved, minimizing chances of transfer-related trauma, and saving time that can be life-changing.

These and other features, aspects, and advantages of present invention will become better understood with reference to the following description and appended claims.

The transportation system, its modules, part and features, and the methods of using thereof will now be described more fully hereinafter with reference to the accompanying drawings, which are intended to be read in conjunction with this summary, the detailed description, and embodiments specifically discussed or otherwise disclosed. The invention may, however, be embodied in many different forms and should not be construed as limited to the embodiments set forth herein. Rather, these embodiments are provided so that this disclosure will be thorough and complete, and will fully convey the scope of the invention to those skilled in the art. Moreover, while the system is often described herein with reference to loading and unloading heavy items to and from a vehicle, the system may be equally operable to load and unload items to alternative elevated surfaces.

### BRIEF DESCRIPTION OF THE DRAWINGS

Application contains 55 drawing sheets containing 47 figures, wherein each figure may have a single or multiple views. The figures depicting some of the exemplary embodiments of the invention.

The figures represent some exemplary configurations of the present invention and some exemplary methods of using thereof, where like structure is indicated with like reference numerals. All features/functionalities that are depicted are not to be considered to be entirely bound to the particular configuration and can be included in any combination in any other embodiment of the present invention. Furthermore, all shapes and dimensions of embodiments as whole and all dimensions, shapes and patterns of its depicted features, are not limiting and serve for an exemplary purpose only. The embodiments and all their features, dimensions and patterns are not depicted to scale.

The following indicia were used in FIGS. 1-47 and throughout the entirety of the disclosure to facilitate an understanding of embodiments of the invention: (100) transportation system (TS); (200) transportation module (TM); (300) cart; (400) work cell; (500) exemplary Connecting Bolt Openings Pattern (CBOP) of cart platform; (600) materials transport work cell; (700) user-designed work cell; (800) connecting module; (900) exemplary embodiment of COBP; (1000) workstation work cell; (1100), (1200), (1300), (1400) and (1500) exemplary embodiments of CBOP of the plate member of a work cell; (1600) exemplary CBOP of connecting module; (1700) heavy construction tools work cell; (1800) custom toolbox work cell; (1900) work cell unit; (2000) materials transport unit; (2100) workstation transportation unit; (2200) heavy construction tools transportation unit; (2300) custom toolbox transportation unit; (2400) materials transportation system; (2500) workstation transportation system; (2600) heavy construction tools transportation system; (2700) custom toolbox transportation system; (1) platform member; (2) overhang portion; (3) strut; (4) linear slide rails, (4a) first linear slide rail; (4b) second linear slide rail; (5) medially facing slide tracks; (6) laterally facing slide tracks; (7) sliding scissors, (8) upper sliding wheel; (9) linear actuator; (10) pivoting handle mount; (11) stationary scissors, (12) lower sliding wheel; (13) upper bolted connection; (14) lower mounting beam; (15) base member; (16) ground wheels; (17) strut handle; (18) castor; (19) leg body; (20) loading wheels; (21) lower gravity latch; (22) upper gravity latches; (23) mounting pivoting pins; (24) locking pins; (25) spring loaded pin; (26) base slide track; (27) lower bolted connection; (28) battery; (29) power management system; (30) handle grip; (31) secondary control switch; (32) approach wheels; (33) short coupling grooves; (34) long coupling groove; (35) mating pegs; (36) cart platform; (37) spring latch; (38) handle; (39) ratchet straps connections; (40) front wheels; (41) first plurality of apertures; (42) rear handles; (43) toggle switch; (44) key switch; (45) handle adjustment knob; (46) plate member; (47) bolts; (48) rail bed assembly; (49) medial rails; (50) lateral rails; (51) rails junction; (52) cart base; (53) tool carrier; (54), (55) straps; (56) workstation hood; (57) extendable platform; (58) lock; (59) specialized compartments; (60) roof; (61) mounting holes; (62) drawers; (63) table; (64) work cell frame; (65) heavy construction hood; (66) sliding doors; (67) sliding rails; (68) tubular holders; (69) storage unit; (70) door hinge; (71) divider; (72) lock; (73) back door; (74) door hinge; (75) shelves; (76) mating slot; (77) mating peg; (78) thumb screw; (79) extendable platform hinges; (80) lock; (81) hood wings; (82) handles; (83) reinforcement strut; (84) hinge; (85) longitudinal wall; (86) wall cutout; (87) shelving unit; (88) toolboxes; (89) hydraulic fluid reservoir; (90) electric pump; (91) hydraulic cylinder; (92) tubes; (94) switch valve; (95) hydraulic pump; (96) crank; (97) leadscrew; (98) leadscrew nut; (99) stationary pivot; (101) sliding carriages; (102) draw latch; (103) draw; (104) container for articles; (105) ground wheel motor (first motor); (106) ground wheel chain; (107) ground wheel drive gear; (108) ground wheel axle; (109) approach wheel motor (second motor); (110) approach wheel chain; (111) approach wheel drive gear; (112) approach wheel axle; (113) ground wheel mating gear; (114) approach wheel mating gear; (115) loading wheel shocks; (116) loading wheel shock pivots; (117) loading wheel shock arms; (118) extensible beams; (119) socket beams; (120) sizing holes; (121) pins; (122) frame member; (123) front end of the frame member; (124) rear end of the frame member; (125) overhang member; (126) plate; (127) leg member; (128) manual leadscrew lifting assembly; (129) first end of the leg body; (130) second end of leg body; (131) tubular receiver; (132) shock absorbing assembly; (133) top surface of platform member; (134) bottom surface of the platform member; (135) cart body; (136) front section of cart body; (137) rear section of cart body; (138) top surface of cart platform; (139) bottom surface of cart platform; (140) top surface of the plate member; (141) bottom surface of the plate member; (142) first end of the plate member; (143) second end of the plate member; (144) first lateral side of the plate member; (145) second lateral side of the plate member; (146) first plurality of apertures; (147) second plurality of apertures; (148) third plurality of apertures; (149) table saw; (150) inner surface of the workstation hood; (151) outer surface of the workstation hood; (152) table openings; (153) roof extension (shown in retracted position); (154) pole; (155) labeling system; (156) front panel; (157) back panel; (158) side panel; (159) top panel; (160) retainer assembly; (161) custom toolbox hood; (162) peripheral wall; (163) lateral wing panel; (164) medial wing panel; (165) base frame; (166) hybrid hydraulic-electrical lifting assembly; (167) scissor lift; (168) sliding wheels; (169) upper end of overhang portion; (170) lower end of overhang portion; (171) plurality of rails; (172) sliding wheel; (173) rail bed; (174) tension spring; (175)-electrical outlet; (176) peg board; (177) pin.

FIG. 1 is a diagram of modules of a transportation system including a transportation module, a cart, and a work cell (shown schematically as a block), according to exemplary embodiments of the invention.

FIG. 2 is a perspective exploded view of the transportation system including the transportation module and the cart according to exemplary embodiments of the invention.

FIG. 3A is a side view, and FIG. 3B is a rear view of the transportation module according to an exemplary embodiment of the invention.

FIGS. 4A-H show various views of the transportation module illustrated in FIG. 3, wherein a lifting assembly is expanded; and wherein FIG. 4A and FIG. 4B are perspective views, FIG. 4C is a bottom view, FIG. 4D is a top view, FIG. 4E is a side view, FIG. 4F is a rear view, FIG. 4G is a front view, and FIG. 4H is another side view.

FIGS. 5A-H show various views of the transportation module illustrated in FIG. 3, wherein the lifting assembly is contracted; and wherein FIG. 5A and FIG. 5B are perspective views, FIG. 5C is a bottom view, FIG. 5D is a top view, FIG. 5E is a side view, FIG. 5F is a rear view, FIG. 5G is a front view, and FIG. 5H is another side view.

FIG. 6A is a side view of the transportation module illustrated in FIG. 3, and FIG. 6B is a cross-sectional view on the line A-A of FIG. 6A and showing a leg receiving assembly according to an embodiment of the invention, and wherein a leg body is shown retracted to the leg receiving assembly.

FIG. 7A is a front view of the transportation module illustrated in FIG. 3, and FIG. 7B is across-sectional view on the line B-B of FIG. 7A and showing the leg receiving assembly according to an embodiment of the invention; wherein the leg body is mounted to medially facing tracks by a pair of pins, and wherein the leg body is shown retracted to the leg receiving assembly.

FIG. 8A is a front view of a transportation module according to another embodiment of the invention, and FIG. 8B is across-sectional view on the line I-I of FIG. 8A, and FIG. 8C is close-up view of section B of FIG. 8B; wherein the leg body is mounted to the medially facing tracks by a pair of sliding wheels, and wherein the leg body is shown retracted to the leg receiving assembly.

FIG. 9A is a front view of a transportation module according to another embodiment of the invention, and FIG. 9B is across-sectional view on the line J-J of FIG. 9A, and FIG. 9C is close-up view of section B of FIG. 9B; wherein the leg body is mounted to the medially facing tracks by a pair of sliding carriages, and wherein the leg body is shown retracted to the leg receiving assembly.

FIG. 10A is a perspective view of a transportation module according to another embodiment of the invention, wherein a leg member is length-adjustable, and FIG. 10B is close-up view of section A of FIG. 10A showing an exemplary mechanism of the leg member length adjustment; and wherein the leg is shown extended from the leg receiving assembly.

FIG. 11A is a top view of a transportation module according to another embodiment of the invention, wherein the leg member includes a shock absorbing assembly, and FIG. 11B is close-up view of section A of FIG. 11A showing an exemplary shock absorbing assembly.

FIG. 12 is an exemplary diagram of a power delivery system according to an exemplary embodiment of the invention.

FIG. 13A is a side view of a transportation module according to another embodiment of the invention, showing an exemplary mechanism for immobilizing the leg body, and FIG. 13B is a close-up view of section A of FIG. 13A.

FIG. 14A is a side view and FIG. 14B is a rear view of a transportation module according to another embodiment of the invention, wherein the lifting assembly including a hybrid lifting assembly, that is including a hydraulics system in addition to an electrical system.

FIG. 15A is a side view and FIG. 15B is a rear view of a transportation module according to another embodiment of the invention, wherein the lifting assembly including a manually operated lifting assembly, that is including a manual hydraulic lifting assembly.

FIG. 16A is a side view and FIG. 16B is a rear view of a transportation module according to another embodiment of the invention, wherein the lifting assembly including a manually operated lifting assembly, that is including a manual leadscrew assembly.

FIG. 17A is a perspective view of a transportation module according to another embodiment of the invention, and FIG. 17B is a close-up view of section A of FIG. 17A showing an exemplary first motor (ground wheel motor) operable to drive ground wheels.

FIG. 18A is a perspective view of a transportation module according to another embodiment of the invention, and FIG. 18B is a close-up view of section B of FIG. 18A, and FIG. 18C is a close-up view of section A of FIG. 18A, showing an exemplary combination of exemplary motors, the first motor (ground wheel motor) and a second motor (approach wheel motor), wherein the first motor operable to drive the ground wheels, and the second motor operable to drive approach wheels.

FIG. 19A is a perspective view and FIG. 19B is a front view of a transportation module according to another embodiment of the invention, and FIG. 19C is a close-up view of section A of FIG. 19A, showing an exemplary motor operable to drive the ground wheels and the approach wheel.

FIG. 20A is a perspective view of a transportation module according to another embodiment of the invention, and FIG. 20B is a close-up view of section A of FIG. 20A, showing a container for articles mounted to a frame member of the transportation module.

FIG. 21A and FIG. 21B are perspective views of a transportation module according to another embodiment of the invention, showing an exemplary leg-receiving assembly, wherein the frame member includes a tubular receiver, and wherein the leg member configured to extend from and retract to the receiver.

FIG. 22 is a perspective view of a transportation module according to another embodiment of the invention, showing a platform-less embodiment of the transportation module.

FIG. 23 is a perspective view of the transportation module illustrated in FIG. 3, wherein the lifting assembly is contracted, and wherein an overhang member having a height h1 and the lifting assembly in a substantially contracted state together with a base member having a cumulative height h2, and wherein h1 is greater or equal h2 (h1≥h2), and the frame member having a length l1, and the base member having a length l2, and wherein l1 is greater than l2 (l1>l2); according to an exemplary embodiment of the invention.

FIGS. 24A-J. illustrate method steps for loading the transportation system including a transportation module to an elevated surface.

FIGS. 25A-H show various views of a cart in accordance with an exemplary embodiment of the invention; wherein FIG. 25A and FIG. 25B are perspective views, FIG. 25C is a bottom view, FIG. 25D is a top view, FIG. 25E is a side view, FIG. 25F is a rear view, FIG. 25G is a front view, and FIG. 25H is another side view.

FIGS. 26A-H show various views of an exemplary embodiment of the invention, wherein a transportation system includes a transportation module and a cart, wherein the cart is shown coupled to the transportation module and the lifting assembly of the transportation module is expanded; so that the transportation system is shown in elevated position; wherein FIG. 26A and FIG. 26B are perspective views, FIG. 26C is a bottom view, FIG. 26D is a top view, FIG. 26E is a side view, FIG. 26F is a rear view, FIG. 26G is a front view, and FIG. 26H is another side view.

FIGS. 27A-H show various views of the transportation system illustrated in FIG. 26, wherein the transportation system includes the transportation module and the cart, wherein the cart is shown coupled to the transportation module and the lifting assembly of the transportation module is contracted; so that the transportation system is shown in lowered position; wherein FIG. 27A and FIG. 27B are perspective views, FIG. 27C is a bottom view, FIG. 27D is a top view, FIG. 27E is a side view, FIG. 27F is a rear view, FIG. 27G is a front view, and FIG. 27H is another side view.

FIG. 28-30 show an exemplary transportation module-to-cart coupling mechanism.

FIG. 28A shows side views of a transportation module and a cart positioned for coupling, and FIG. 28B is a cross-sectional view on the line C-C of FIG. 28A, and wherein direction of coupling is shown with dashed arrows.

FIG. 29A shows the side view of the transportation module coupled to the cart and secured in place by a latch, and FIG. 29B is a cross-sectional view on the line D-D of FIG. 29A.

FIG. 30A shows the side view of the transportation module coupled to the cart and, and FIG. 30B is a cross-sectional view on the line E-E of FIG. 30A, showing the latch being released, and wherein direction of uncoupling is shown with dashed arrows.

FIG. 31 shows a block diagram of some exemplary methods of loading and unloading the transportation system, according to some exemplary embodiments.

FIG. 32 and FIG. 33 show top views of exemplary non-limiting embodiments of connecting bolt opening patterns (CBOPs) of a cart platform.

FIG. 34A shows perspective view of an exemplary embodiment of the invention, wherein a transportation system includes a transportation module, a cart, and a connecting module; and FIG. 34B is a bottom view of the connecting module showing an exemplary non-limiting embodiment of a CBOP of a plate of the connecting module.

FIG. 35A shows perspective view of an exemplary embodiment of the invention, wherein a transportation system includes a transportation module, a cart, and a work cell (shown schematically), and showing an exemplary cart-to-work cell coupling mechanism; and FIG. 35B-F are bottom views of the work cell showing exemplary, non-limiting, embodiments of CBOPs that may be advantageous for various work cells disclosed herein. FIG. 35G shows perspective view of another exemplary embodiment of the invention, wherein a transportation system includes a transportation module, a cart, and a work cell (shown schematically), and wherein the work cell includes a work cell frame and a table.

FIG. 36A shows perspective view of an exemplary embodiment of the invention, wherein a transportation system includes a transportation module, a cart, and a work cell (shown schematically), and showing an alternative exemplary cart-to-work cell coupling mechanism; and FIG. 36B is a bottom view of the work cell.

FIG. 37A shows perspective view of an exemplary embodiment of the invention, wherein a transportation system includes a transportation module, a cart, and a materials transport work cell; and FIG. 37B is a bottom view of the materials transport work cell showing exemplary, non-limiting, embodiment of CBOP of a plate member of the materials transport work cell.

FIG. 38 shows a perspective view of another embodiment of a materials transport work cell coupled to the cart and showing exemplary straps for securing a load.

FIG. 39 shows a perspective view of an exemplary embodiment of the invention, wherein the materials transport work cell is shown coupled to the cart, and the cart is shown coupled to the transportation module, and wherein the and the lifting assembly of the transportation module is expanded; so that the transportation system is shown in elevated position.

FIG. 40 shows a perspective view of a workstation work cell coupled to a cart according to an exemplary embodiment of the invention, and wherein a workstation hood is shown opened.

FIG. 41 shows a perspective view of the workstation work cell illustrated in FIG. 40, shown coupled to the cart, and wherein the workstation hood is shown partially closed.

FIG. 42 shows a perspective view of the workstation work cell illustrated in FIG. 40, shown coupled to the cart, and wherein the workstation hood is shown closed.

FIG. 43A shows a perspective view of a heavy construction tools work cell coupled to a cart according to an exemplary embodiment of the invention, and wherein a heavy construction hood is shown opened; and FIG. 43B is a close-up view of section A of FIG. 43A showing a retainer assembly having a plurality of tubular holders.

FIG. 44A shows a perspective view and FIG. 44B is a front view of the heavy construction tools work cell illustrated in FIG. 43A, shown coupled to the cart, and wherein the heavy construction hood is shown closed.

FIG. 45A shows another perspective view and FIG. 45B shows a rear view of the heavy construction tools work cell illustrated in FIG. 43A, shown coupled to the cart, and wherein the heavy construction hood is shown opened. FIG. 45C is a cross-sectional view on the line K-K of FIG. 45B.

FIG. 46 shows a perspective view of a custom toolbox work cell coupled to a cart according to an exemplary embodiment of the invention, and wherein a custom toolbox hood is shown opened.

FIG. 47 shows a perspective view of the custom toolbox work cell illustrated in FIG. 46, shown coupled to the cart, and wherein the custom toolbox hood is shown closed.

### DETAILED DESCRIPTION

The aspects and exemplary embodiments will now be described more fully hereafter with reference to the accompanying drawings, wherein like reference numbers are generally utilized to refer to like elements throughout. The invention may, however, be embodied in many different forms and should not be construed as limited to the embodiments set forth herein. Rather, these embodiments are provided so that this disclosure will be through and complete and fully convey the scope of the invention to those skilled in the art. Those of ordinary skill in the art realize that the following descriptions of the embodiments of the invention and the methods of using the invention are illustrative and are not intended to be limiting in any way. Other embodiments of the present invention and methods will readily suggest themselves to such skilled persons having the benefit of this disclosure. In the following description, for purposes of explanation, numerous specific details are set forth in order to provide a thorough understanding of one or more aspects of the exemplary embodiments. It may be evident, however, to one skilled in the art that one or more aspects of the exemplary embodiments may be practiced with a lesser degree of the specific details and that many variations and alterations to the following details are within the scope of the invention. Accordingly, the following embodiments of the invention are set forth without any loss of generality to, and without imposing limitations upon the scope of current disclosure. Mentioning one or more representative features of a given embodiment is likewise exemplary. Such an embodiment can typically exist with or without feature mentioned; likewise, those features can be applied to other embodiments of the presently disclosed subject matter. In other instances, known structures and elements are shown in schematic form in order to facilitate describing one of more aspects of the exemplary embodiments. It is to be understood that other examples may be utilized, and structural or other logical changes may be made without departing from the scope of the present disclosure. It should be noted further that the drawings are not to scale or not necessarily to scale. In the following detailed description, reference is made to the accompanying drawings, which form a part thereof and in which shown by way of illustration exemplary embodiments of the invention. Specific examples of components and their arrangements are described below are exemplary and are not intended to be limiting. In addition, the disclosure may repeat reference numerals and/or letters in the various examples. This repetition is for the purpose of simplicity and clarity and does not itself dictate a relationship between various embodiments and/or configurations discussed.

Further, spatially relative terms, such as “above”, “below”, “upper”, “lower”, “proximal”, “distal”, “medial”, “lateral”, “front”, “back”, “left”, “right”, “top”, “bottom”, as well as terms such as “first”, “second”, “third”, and other like terms, are used for convenience of the reader in reference to the drawings. As used herein, the term “distal” refers to that portion of the device/system, or component thereof, farther from a user, while the term “proximal” refers to that portion closer to the user. The term “medial” means toward the middle or center of an object/device/system or part or, in some instances, towards its longitudinal axis, and it is the opposite of lateral. These terms are used to describe general positions of parts and elements. Also, a person skilled in the art should notice that this description may contain other terminology to convey position, orientation, and direction without departing from the principles of the present invention; thus, spatially relative terms are intended to encompass different orientations in addition to orientation depicted in the drawings. The embodiments may be otherwise oriented (rotated at 90 degrees or other orientations) and the spatially relative descriptions used herein may likewise be interpreted accordingly. Furthermore, in this detailed description, a person skilled in the art should note that quantitative qualifying terms such as “generally”, “substantially”, “mostly”, and other like terms are used, in general, to mean that the referred to object, characteristic, or quality constitutes a majority of the subject of the reference. The meaning of any of these terms is dependent upon the context in which it is used, and meaning may be expressly modified. The terms “detachably mounted”, “detachably coupled” and “detachably connected” and like terms intend to encompass that some feature may be removable manually without tools, or with aid of mobile tools, such as screws, thumbscrews, nails, straps, or latches. Additionally, while a particular feature or aspect of an exemplary embodiment may be disclosed with respect to only one of several embodiments, such feature or aspect may be combined with one or more other features or aspects of other embodiments as may be desired and advantageous for any given or particular application. Furthermore, to the extent that the terms “include”, “have”, “with” or other variations thereof used in the disclosure or the claims, such terms are intended to be inclusive in a manner similar to the term “comprise”. The terms “coupled” and “connected”, “mounted” along with derivatives may be used. It should be understood that these terms may be used to indicate that two elements co-operate or interact with each other regardless of whether they are in direct connection with each other, or they are not in direct connection with each other. A direct connection can have a meaning of a positive or form-fitting connection of two elements. Also, even if two elements are described to be in direct connection with each other there can still be a layer, for example a solder layer, a sinter layer or a glue layer between the two elements, which layer has only the function of effectuating and ensuring the connection between two elements. Moreover, these terms are intended to encompass stationary connections, such as being connected fixedly; as well as functional connections, such as pivoting and, and such as detachable.

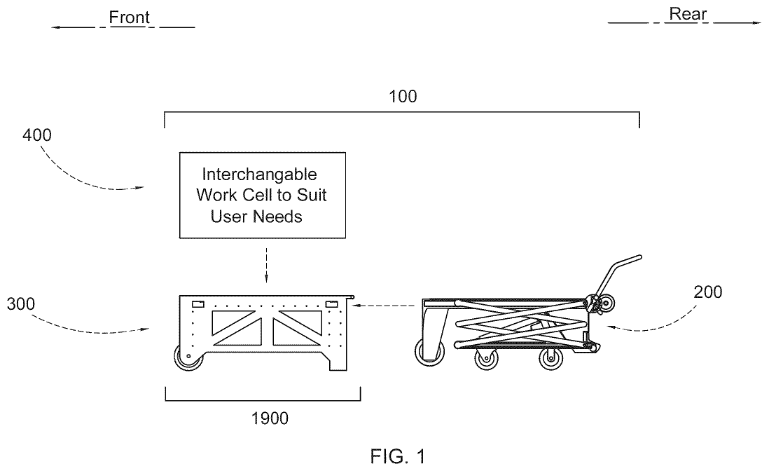

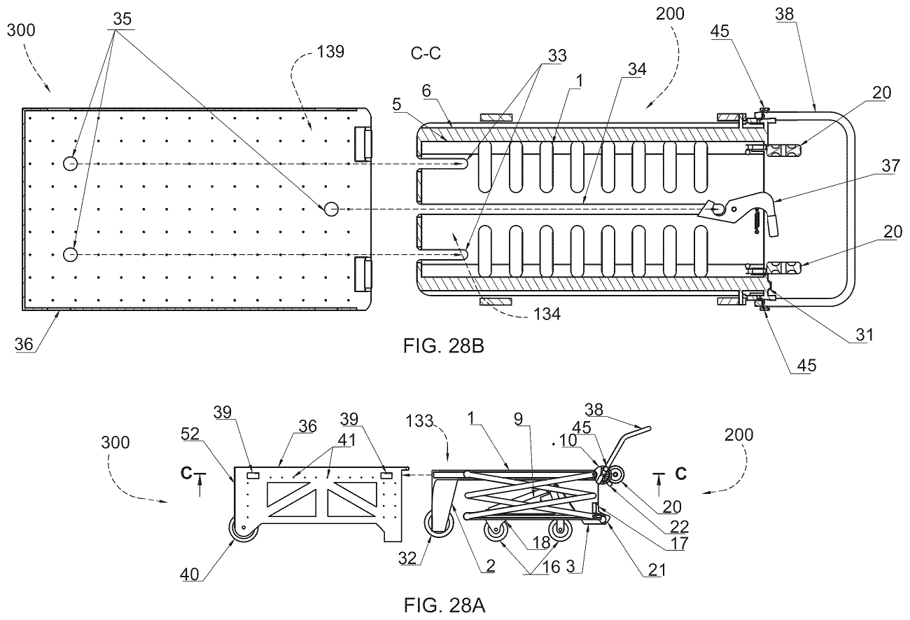

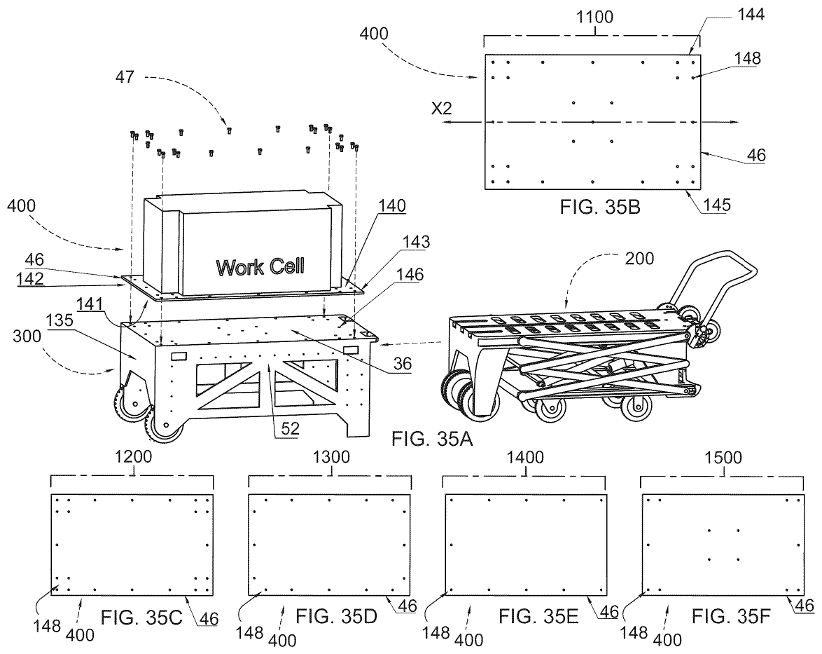

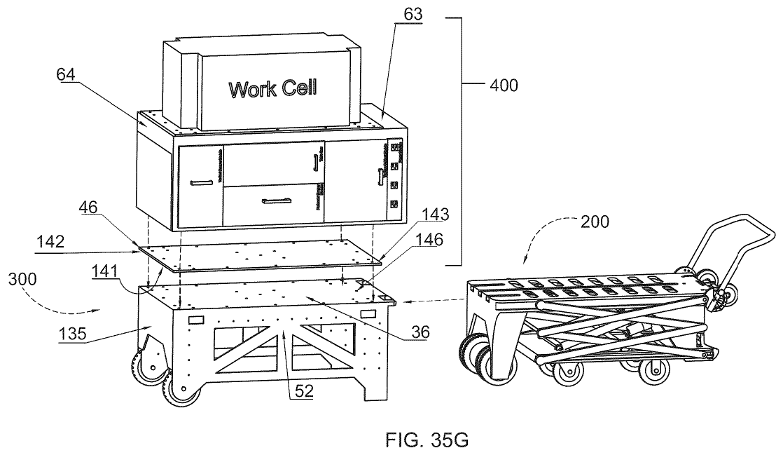

FIG. 1 is a diagram illustrating modules of a transportation system (100) in accordance with an exemplary embodiment of the invention. As shown, the transportation system (100) includes a transportation module (200), and may include a cart (300) and further may include an interchangeable task-specific work cell (400) herein depicted conceptually; wherein the cart (300) is configured to detachably couple to the transportation module, and the work cell (400) is configured to detachably couple to the cart. The work cell (400) allows to customize the system (100) for particular hauling and performance needs. The work cells may be pre-configured for a specific task or be made-to-order according to user requests. The work cell (400) may detachably couple to the cart (300), for example, by a cart-to-work cell coupling mechanism. Some exemplary embodiments of the cart-to-work cell coupling mechanism are depicted on FIGS. 35A-F and described in greater details thereafter. The transportation module (200) may detachably couple to cart (300), for example, by a transportation module-to cart coupling mechanism. Some exemplary embodiments of the transportation module-to cart coupling mechanism are depicted on FIGS. 28A-B, 29A-B, 30A-B, and described in greater details thereafter. However, the coupling mechanisms are not limiting and other exemplary embodiments of the cart-to-work cell coupling mechanisms and the transportation module-to cart coupling mechanisms are described in the summary section of this disclosure. The cart (300) may host a single work cell (400) at a time; however, one work cell (400) is disconnected from the cart, it may be replaced by another work cell (400); so that a user may customize the system (100) by choosing between task-specific work cells according imminent needs. The work cell (400), may be one of the following task-specific work cells, such as a Materials Transport work cell (600), a Workstation work cell (1000), a Heavy Construction Tools work cell (1700), and a Custom Toolbox work cell (1800), which exemplary embodiments are disclosed herein and depicted on the following figures. Once the task specific work cell is selected and coupled to the cart (300), the transportation module (200) may be coupled to the cart (300) and to relocate and load the cart (300) with the work cell (400) coupled thereto to an elevated surface. Moreover, a user may choose to own multiple carts (300) and couple a task specific work cell (400) to each cart (300) in advance, and then use a single transportation module (200) to sequentially load/relocate them. Furthermore, the cart (300) may be used to manually relocate one of the work cells (200) over short distances when the transportation module (200) is not immediately available; and an assembly that does not include the transportation module (200), and includes the cart (300) with the work cells (400) coupled thereto is referred herein as a work cell unit (1900). For example, an assembly including the cart (300) with the materials transport work cell (600) may be referred herein as a materials transportation unit (2000); an assembly including the cart (300) with the workstation work cell (1000) may be referred herein as a workstation transportation unit (2100); an assembly including the cart (300) with the heavy construction tools work cell (1700) may be referred herein as a heavy construction tools transportation unit (2200); and an assembly including the cart (300) with the custom toolbox work cell (1800) may be referred herein as a custom toolbox transportation unit (2300).

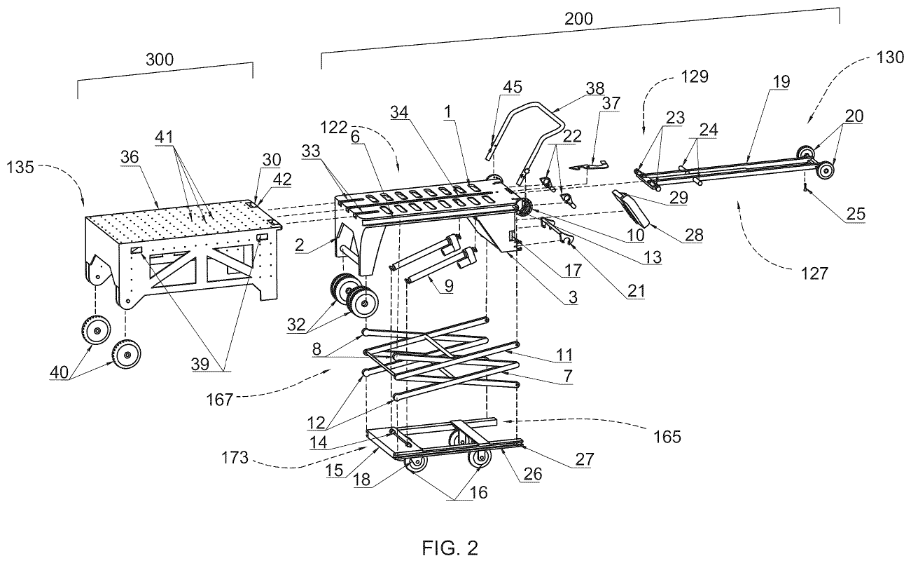

FIG. 2 is diagram illustrating exploded views of modules of a transportation system (100), showing exemplary embodiments of a transportation module (200) and a cart (300). Herein, an exemplary structural relationship between components of the transportation module (200) and components of the cart (300) is shown by projection lines. Furthermore, some horizontal projection lines between the transportation module (200) and the cart (300) show a mating direction of an exemplary transportation module-to-cart coupling mechanism.

Referring now to FIGS. 2-24, diagrams are shown illustrating various views and cross-sections of exemplary embodiments of the transportation module (200) in accordance with exemplary embodiments of a system (100).

As shown, the transportation module (200) may include a frame member (122) defining a longitudinal axis X1 and having a front end (123) and a rear opposing end (124). The front end (123) may include an overhang member (125) that may be having an overhang portion (2) protruding downwardly below the frame member (122), the overhang portion having at least one approach wheel (32). The transportation module (200) may have a base member (15) comprising a plurality of ground wheels (16), wherein the wheels configured for engaging and rolling over a supporting surface; A lifting assembly (167) may be connected between the base member (15) and the frame member (122); and configured to lift and lower the frame member (122) relative to the base member (15). The transportation module may include a leg member (127) having a leg body (19) and at least one loading wheel (20).

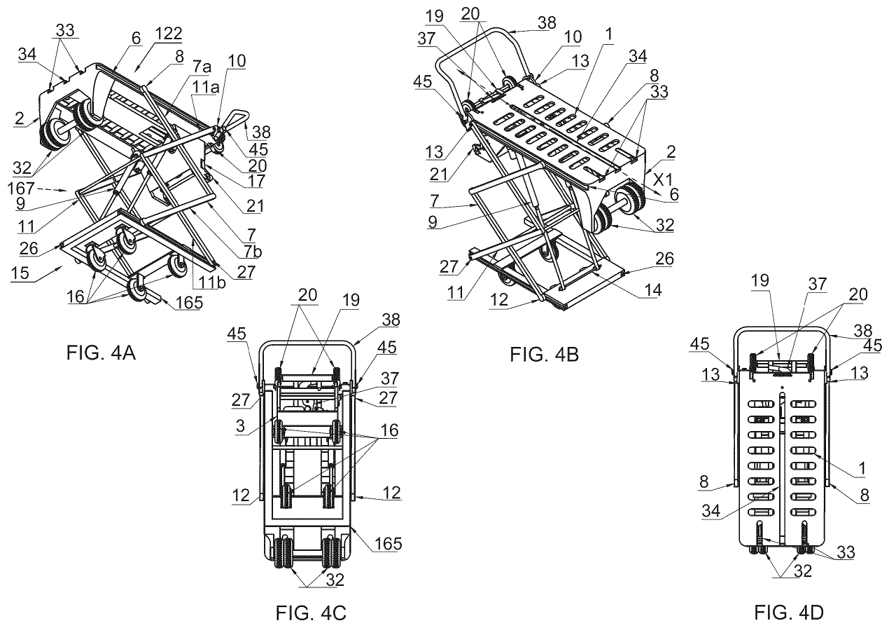

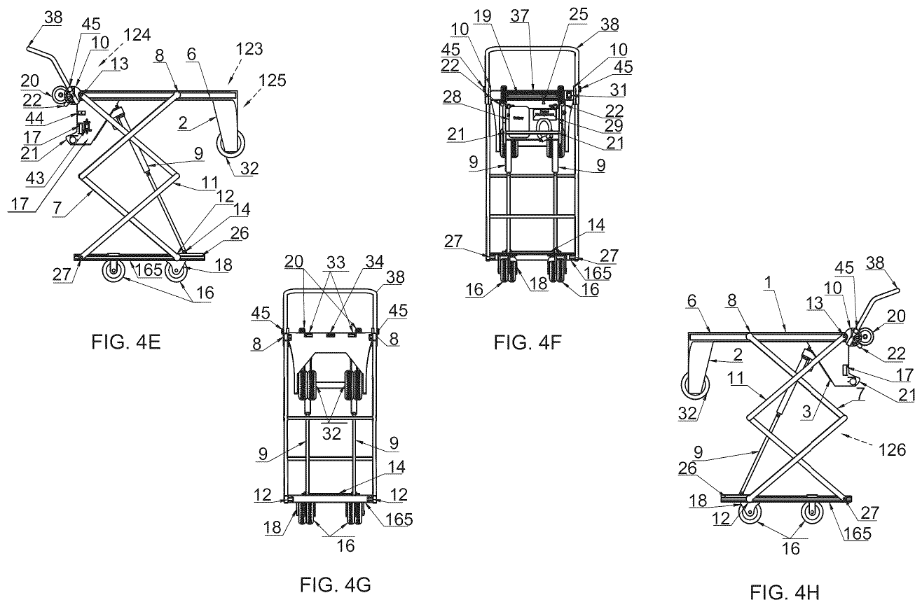

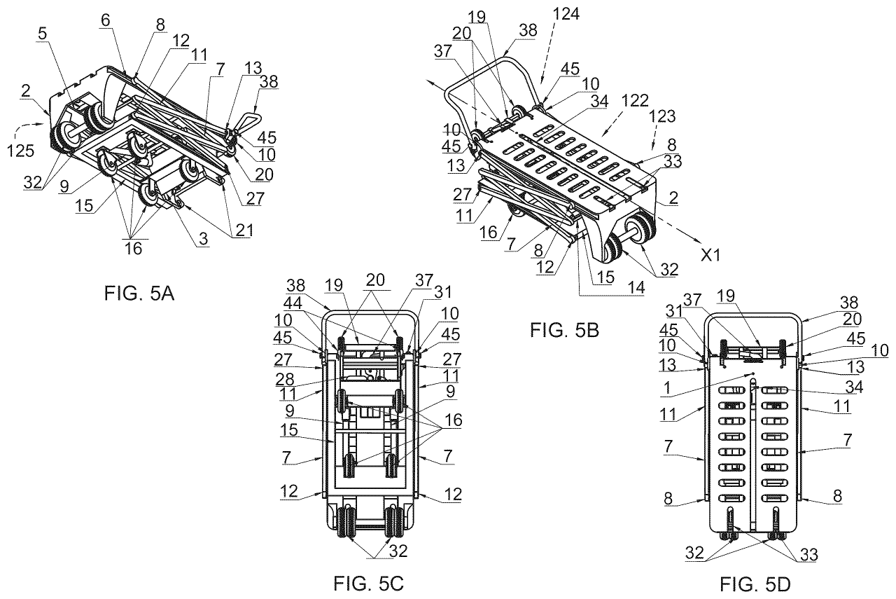

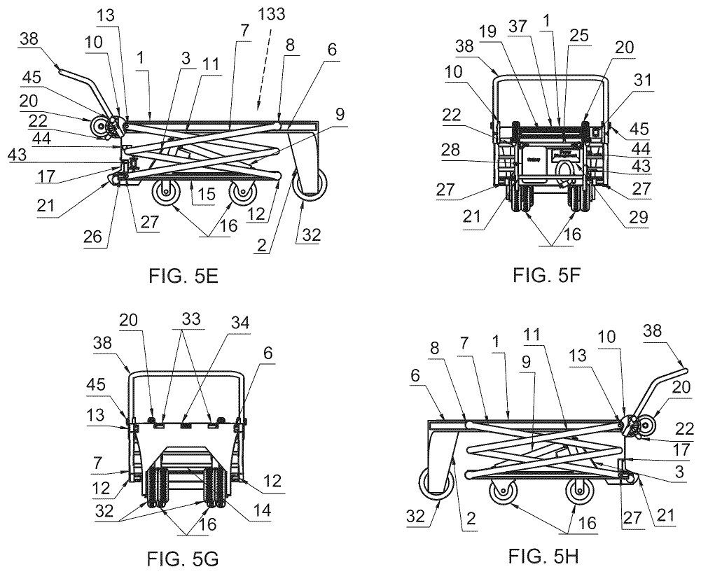

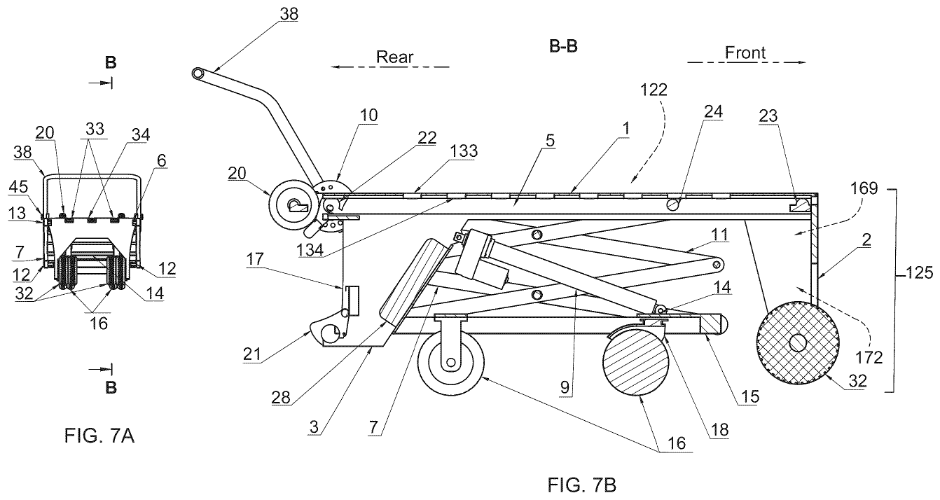

As best shown on FIGS. 4B, 4E and FIG. 5B, the frame member (122) may include a platform member (1), the platform member extending longitudinally between the front end (123) and the rear ends (124) of the frame member (122). The platform member may have a top surface (133) and a bottom surface (134), that are marked on FIG. 7B. The platform that may comprise a continuous monolithic unit or may have a dosed geometric shape which may define enclosed voids/apertures. The platform may have at least one aperture extending between top surface (133) and a bottom surface (134) therethrough. At least one of these apertures may be a part of transportation module-to cart coupling mechanism and may be configured to mate with the transportation module-to-cart mating features. For example, as best shown on FIG. 2, the platform member (1) may include grooves (33) and (34) extending therethrough, that may be used to mate to a cart.

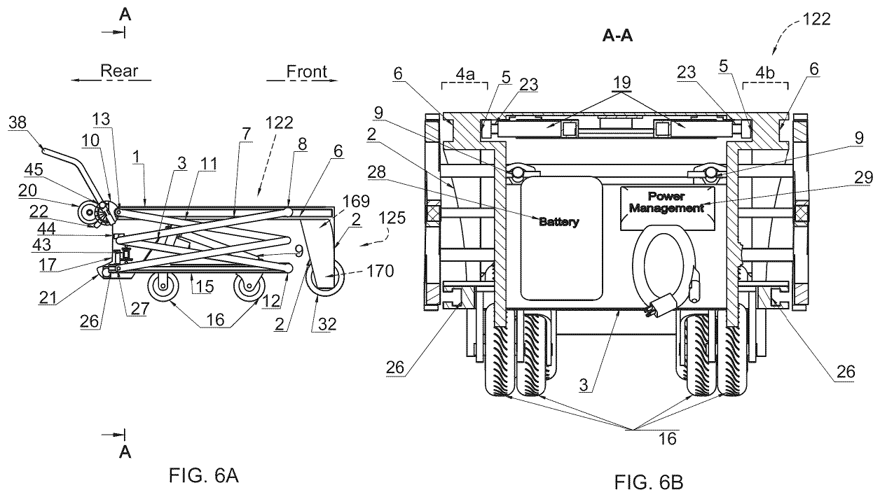

The frame member (122) may include a leg-receiving means, so that said leg member (127) operable to extend from and retract to the means. The leg-receiving means may include a leg receiving assembly. An exemplary leg receiving assembly shown on FIGS. 6B and 7B, the leg receiving assembly may include a pair of spaced apart linear slide rails (4) the slide rails mounted below the platform member (1) and extending longitudinally, each of the slide rails having a medially facing track (5); The first end (129) of the leg body (19) may be mounted to the medially facing tracks by a pair of laterally protruding pins (23) having rotational axes; wherein the tracks (5) configured to translatably receive the leg body (127), so that said leg body operable to extend and retract from the medially facing tracks (5); and pivot about the pins rotational axes when extended. The slide rails (4) each have a front and a rear opposing portions. FIG. 6B shows leg body (19) of leg member (127) retracted to the leg receiving assembly. The leg body (19) may be operable to retract from tracks (5) by sliding out until the pivoting pins (23) engage to the upper gravity latches (22), and then the leg body (19) may be swung downwards about the pivoting pins (23), as shown on FIG. 7B.

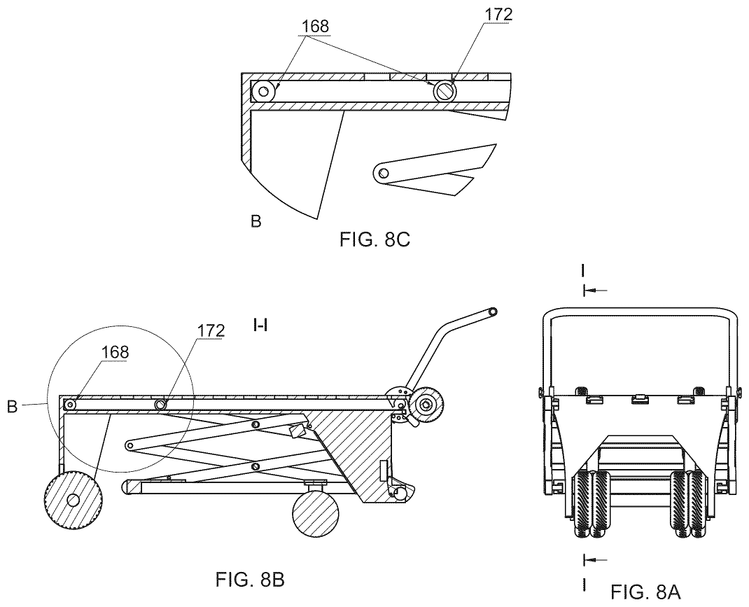

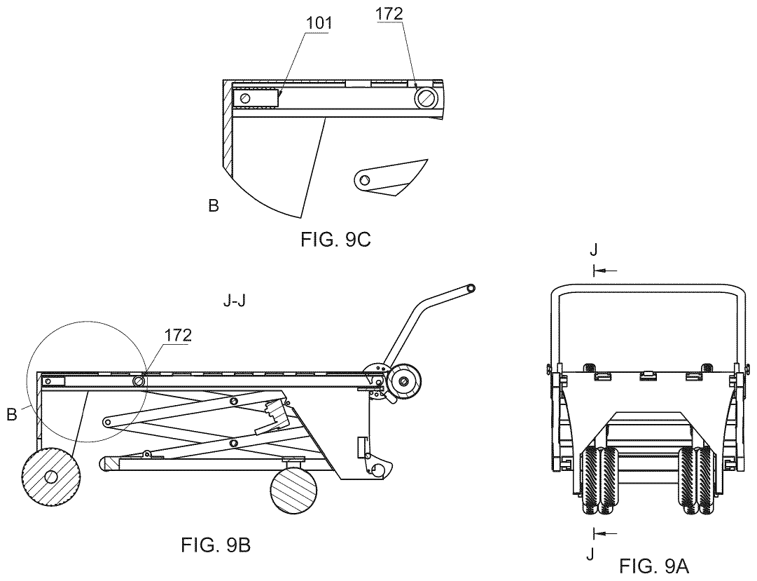

Alternatively, the first end (129) of the leg body (19) may be mounted to the medially facing tracks by other means having rotational axes, such as a pair of laterally protruding sliding wheels (168), as shown on FIGS. 8B-C, or by a pair of sliding carriages (101) as shown on FIGS. 9B-C.

Moreover, the frame member (122) may include at least one holding element (not shown) operable to prevent the leg member from extending or sliding out of the leg-receiving means while the leg member is in transit or not in use; such as a strap, a pin, a latch.

The leg member (127) may have leg body (19) having a first (129) end and a second end (130) and at least one loading wheel (20) mounted to second end (130). In some exemplary embodiments, two wheels (20) may be mounted to the second end (130), as best shown on FIG. 2. The leg member may be used to support and stabilize the system while its being loaded/unloaded into and from a vehicle/an elevated surface. The leg body (19) may be pivotally and/or slidably connected to the frame member (122), by mounting means having rotational axes, such as pins (23). The leg body (19) may be fixedly or detachably connected to the frame member. The leg member (127) may be used to support and stabilize the frame member (122) while loading/unloading the system into and from a vehicle/elevated surface. The leg member may be at least partially retractable to the platform member (122) when not in use, wherein the retraction mechanism may be manual or motorized. The loading wheels (20) may be swiveling, wherein the swiveling function may be activated on demand; for example, and without limitation, by a manual foot lock (not shown). At least one spring-loaded pin (25) may be included on the leg member (127) that may be operable lock the leg member in place to prevent it from slipping out in transit. Although, other ways for keeping the leg member in place can and will suffice, for example, by a strap or magnet, but not limited to thereof.

In some embodiments, the leg member (127) may include additional wheels or stabilizers that may be extendable outwardly from the second end of the leg body (19) to further improve stability of the system. In some embodiments, the loading wheels may be motorized. Moreover, in some embodiments the leg member extension/retraction mechanism may be powered, so that the leg member may be deployed and returned to the origin with minimum user involvement. Furthermore, in some embodiments the leg member may include a scissor lift element, that may be connected to the strut.

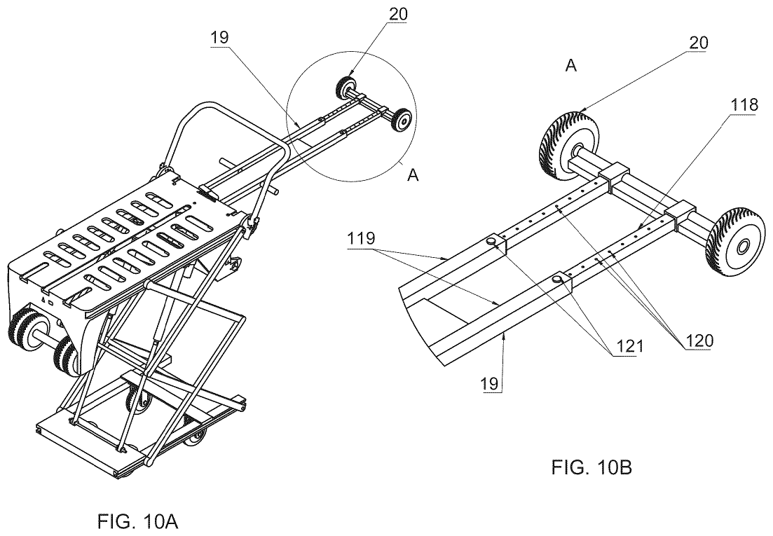

In some embodiments, the leg body (19) of the leg member (127) may be length-adjustable to accommodate for different heights of vehicles/elevate surfaces. For example, and the length of the leg body be adjusted as shown on FIGS. 10A-B, wherein the leg body (19) may include socket beams (119) with removable pins (121) and extendable beams (118) with two or more sizing holes (120) configured change the protrusion length of the extendable beam (118); so that the length of the leg body (19) may be adjusted by removing the pins, extending the extensible beams to a desired length, and them replacing the pins. However, the leg length adjusting mechanism is not particularly limiting, and the leg member length may be adjusted in different ways. For example, and without limitation, the leg body may be foldable, collapsible, telescopically extendable-retractable. Furthermore, leg body length-adjustment mechanism may be manual or motorized. For example, and without limitation, the leg body length-adjustment mechanism may and rely on electrical power, pneumatics, hydraulics, and may include mechanical linkages, screws, latches, hand/foot crank, scissor lift, a lead screw crank, balls screws, roller screws, but not limited thereto. Furthermore, in some embodiments, the rear support leg member (127), may be connectable to the frame member (122) in alternative ways, such as by bolts, latches, but not limited thereto; or may be detachable form the frame member. In some embodiments, the leg member may be detachable from the frame member when not in use and may be stored elsewhere; for example, and without limitation, it may be detachably mounted to the frame member horizontally along its lateral side when not immediately needed.

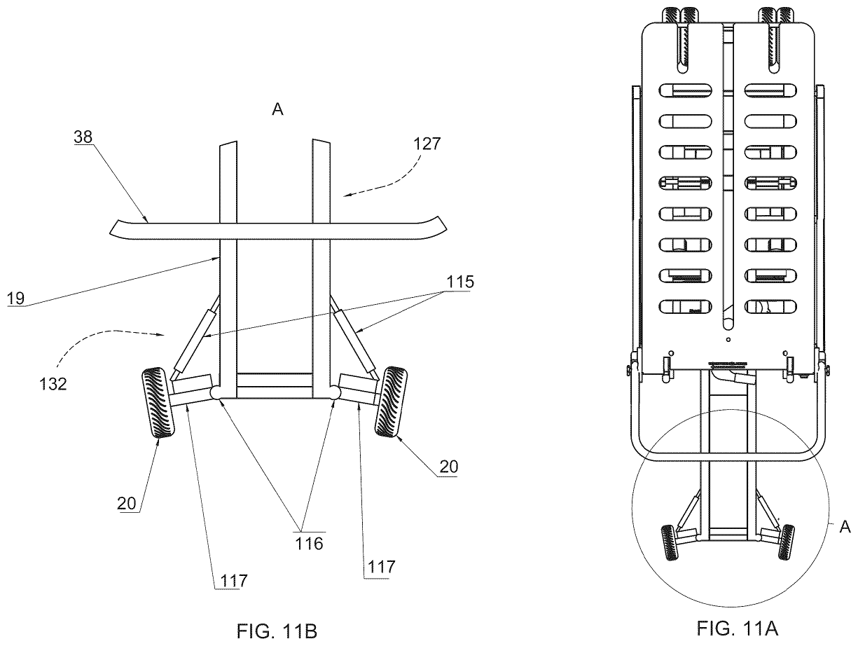

In some embodiments, the leg member (127) may include a shock absorbing assembly. The shock-absorbing assembly may be configured to stabilize the leg member, particularly on uneven supporting surface, such as rough terrain and prevent sudden terrain irregularities from damaging the leg member (127). An exemplary embodiment of the shock absorbing assembly (132) is shown on FIGS. 11A-B, wherein the loading wheels (20) may be connected to leg body (19) through arms (117) that are connected to rotating pinned pivots (116), and wherein vibrations/motions may be dampened by spring shocks (115) connected between the shock arms (117) and the leg body (19).

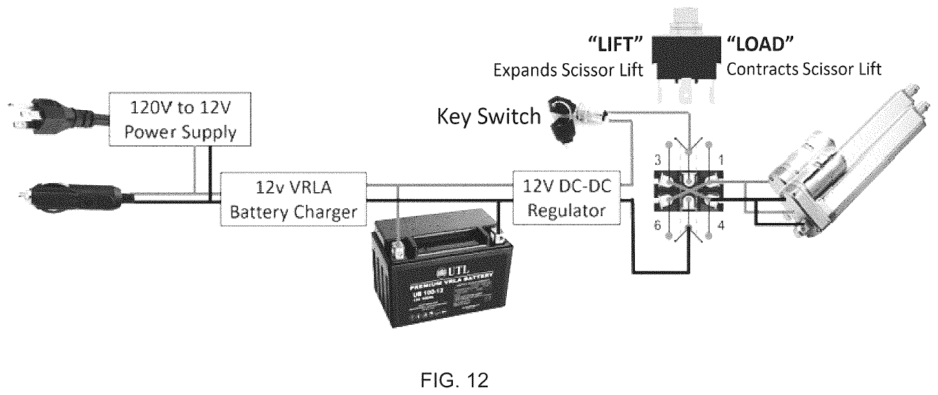

The rear end (124) of the frame member (122) may include a strut (3). The strut may be mounted to the rear portion of the slide rails (4) and may protrude downwardly. The rear end (124) of the frame member (122) may include at least one user engagement portion. The transportation module (200) may include at least one user engagement portion, that may include at least one user engagement device, such as a power control switch controlling motor(s) and/or the powered lifting assembly, switch controlling ground wheels' brakes, a key switch for accessing the system, secondary control switch, a touch screen device configured to be connected to the integrated computer, a structure operable to host a power source, but not limited to thereto; and wherein the devices may be used alone or in combination and may be grouped together located on a single feature of the transportation module or be spread among multiple features. In some embodiments, the user engagement portion may be located on the strut (3), as best shown, on FIGS. 6A-B, wherein the strut may include a user engagement portion comprising a toggle switch (43) and a key switch (44). Furthermore, the strut may host a power source, that may provide power to the lifting assembly. For instance, the power source may include at least one battery (28), that may be rechargeable; The power management system (29), may be located on the strut and may include that may include charging and discharging voltage management circuits, control panel, wires, a power regulator, but not limited thereto. FIG. 12 illustrates an exemplary diagram of a power delivery system according to an exemplary embodiment of the invention. The strut may include a pair of strut handles (17). In some embodiments, additional handles may be attached to the strut (17) to allow the user to push/pull the system while it is being in a raised position, or when the main handle (38) may be removed. At least one of the switches, such as the toggle switch (43), the key switch (44), and/or other additional switches that may be necessary to control the transportation module operation, may be located on the handle (38). Furthermore, alternatively, all switches may be located on the handle (38). The strut may include upper gravity latches (22), that are operable to lock the leg body (19) to the strut by engaging mounting pins (23).

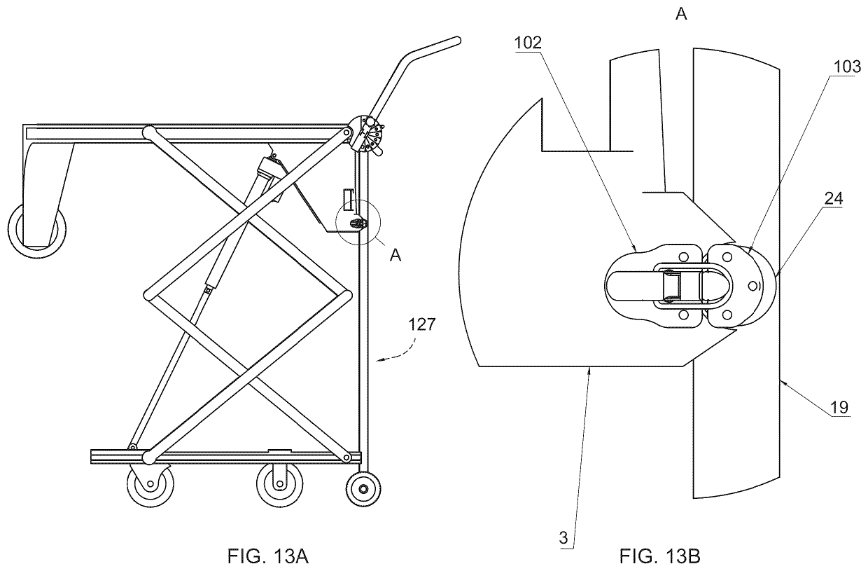

The transportation module may include leg body immobilizing means configured to secure said leg member in substantially vertical position. As best shown on FIG. 2, the immobilizing means may include two laterally protruding locking pins (24) on the leg body (19) and the strut having lower gravity latches (21) configured to releasably couple to the locking pins; and upper gravity latches (22) that are configured to releasably couple to the pivoting pins (23), of the leg member (127); so that when the leg bogy (19) is extended from the leg receiving assembly and pivoted downwardly, the pins may be locked within the latches and secure the leg member (127) in substantially vertical position. Alternatively, the leg body may be immobilized in substantially vertical position by locking the locking pins (24) by draws (103) and draw latches (102), as shown on FIGS. 13A-B. Moreover, in combination with the aforementioned leg body immobilizing means or alternatively, the means may include the leg member (127) having additional locking pins that may be located on the leg body (19), wherein the pins may be lockable within latches that may be located on a rear end of the base member (15) and/or on the lifting assembly. Although, other immobilizing means operable to secure the leg member (127) in substantially vertical position can and will suffice and are intended to be within the scope of this disclosure.

The front end (123) of the frame member (122) may include an overhang member (125); wherein the overhang member may include an overhang portion (2) that may have an upper end (169) and a lower end (170); wherein the upper end (169) may be connected to the front portions of the slide rails (4), and protruding downwardly below the rails (4), and the lower end may include two approach wheels (32), as best seen on FIGS. 6A-B. The number of the approach wheels is not limiting, and at least one approach wheel will suffice. The shape of the overhang member is not particularly limiting. The approach wheels may be operable to rest on the vehicle while loading and unloading the transportation module into and from a vehicle and may contribute to stability and mobility, while ground wheels are being retracted or semi-retracted and while advancing the system into/onto a vehicle or onto alternative elevated surface. In some embodiments, the overhang member (125) may be welded or otherwise attached to the frame member, for instance to the platform member, while in some others it may be formed to be integrally monolithic with the frame member or the platform member.

The transportation module (200) may include a base member (15) comprising a plurality of ground wheels (16), said wheels configured for engaging and rolling over a supporting surface. The design of the base member is not particularly limited; and, though for ground wheels are depicted, the base member may include two or more ground wheels. Ground wheels (16) are responsible for the overall mobility of the system and may be attached to the base frame (165) by means of, for example, bolts, screws, or weldments and/or combined into simplified packages, for example, castors (18). The transportation module may include the ground wheels immobilizing locks operable to immobilize at least two ground wheels (16) and configured to secure the position transportation module in place when not in motion; that may be particularly advantageous on a sloped terrain. The locks may be located on the ground wheels or elsewhere on the base member (15). For example, and without limitation, the ground wheels (16) may comprise lockable caster wheels having friction locks or pins operable to prevent the wheels from spinning (not shown). The ground wheels (16) may be swiveling and may allow the system to be loaded/unloaded sideways; wherein swiveling function may be activated on demand, for example, by a manual foot lock (not shown).

The transportation module (200) may include a lifting assembly, that may be connected between the base member (15) and the frame member (122); and configured to lift and lower the frame member relative to the base member. The lifting assembly may be manual, powered or comprise a combination of manual and powered components.

In some embodiments, as shown best on FIGS. 2, 3A and 4A, the lifting assembly may include an electrically powered lifting assembly comprising a scissor lift (167) and actuators (9) configured to be connected to a source of electrical power, for example to a battery hosted in the strut (3). FIG. 12 illustrates an exemplary diagram, of a power delivery system according to an exemplary embodiment of the invention, wherein a DC electrical power system may comprise a valve regulated lead acid battery or lithium-ion battery, a battery charging circuit, a DC-DC converter for regulating battery voltage, and three-position toggle switch, and a key switch. There is also an option to charge the 120V/220V AC to 12V DC power supply. The actuators (9) may be disconnected from the power when the toggle switch (43) is in “off” position; when the toggle switch (43) is set to the “expand” position, a positive power is fed into the positive rails of actuators, making them expand the scissor lift (167). When the toggle switch (43) is set to “contract”, the positive power is fed into the negative rail of actuators, making them drive backwards and contract scissor lift (167). The entire electrical system, with the exception of the toggle switch (43) and a key switch (44) may be located within the strut (3) or otherwise, and the key switch (44) and toggle switch (43) may be located on the handle (38) and/or strut (3). A secondary toggle switch may be attached to the strut (3), that may allow to control when the system is raised, and the handle is out of reach.

The frame member (122) may include two opposing lateral sides extending longitudinally between the first and the rear opposing ends, wherein each side may include a lateral slide track (6) extending longitudinally, and the base member (15) may include a base frame (165) having two opposing lateral base sides, each the base side may have a base slide track (26) extending longitudinally; wherein the slide tracks (6) and (26) of the frame member and the base frame may be configured for attachment of the scissor lift (167); for example, as best shown on FIG. 2.

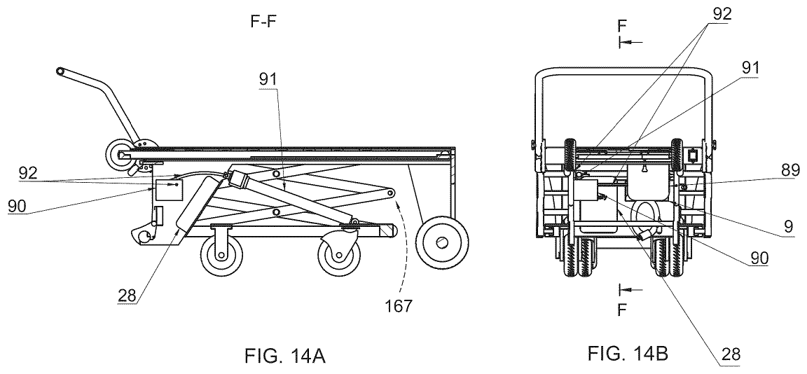

Alternatively, as shown on FIGS. 14A-B, the lifting assembly may include a hybrid lifting assembly that includes a hydraulics system in addition to an electrical system; and that may use a battery (28) and a power delivery system that is similar to the power delivery system of FIG. 12 that may be used for the electrically powered lifting assembly; but instead of using a linear actuators, the hybrid assembly may use an electrical pump (90), that may be connected by tubes (92) to one or more hydraulic pistons (91), drawing from a hydraulic fluid reservoir (89). The hydraulic fluid reservoir (89) may provide hydraulic fluid to the pump (90), which may pump it through tubes (92) into the pistons (91), transferring pressure and expanding the scissor lift (167). To contract the scissor lift (167), the pump (90) may be reversed, reversing the fluid flow direction, pumping fluid out of the piston and into the reservoir (89).

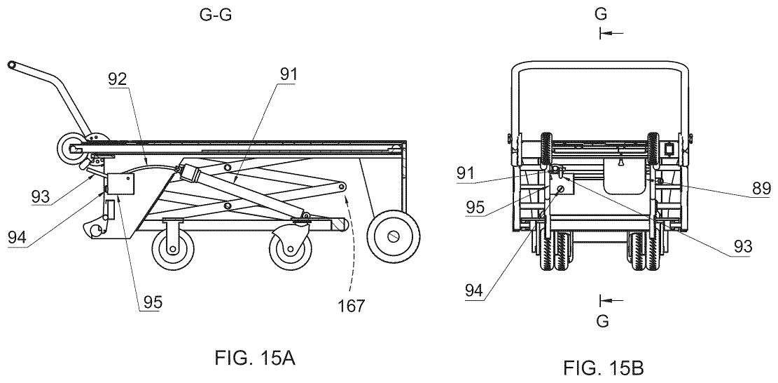

Moreover, as shown on FIGS. 15A-B, the lifting assembly may alternatively include a manually operated lifting assembly, that may include manual hydraulic lifting assembly, wherein this assembly may include a manual pump lever (93) connected to a manual hydraulic pump (95), that may be connected by tubes (92) to one or more hydraulic pistons (91), drawing from a hydraulic fluid reservoir (89), and may include a switch valve (94) operable to change to the direction of fluid flow. The hydraulic fluid reservoir (89) may provide hydraulic fluid to the pump (93), which may pump it through tubes (92) into the pistons (91), transferring pressure and expanding the scissor lift. To contract the scissor lift (167), the switch (94) may reverse the fluid flow direction allowing the manual lever (93) to force the pump (95) to pump fluid out of the piston and into the reservoir (89).

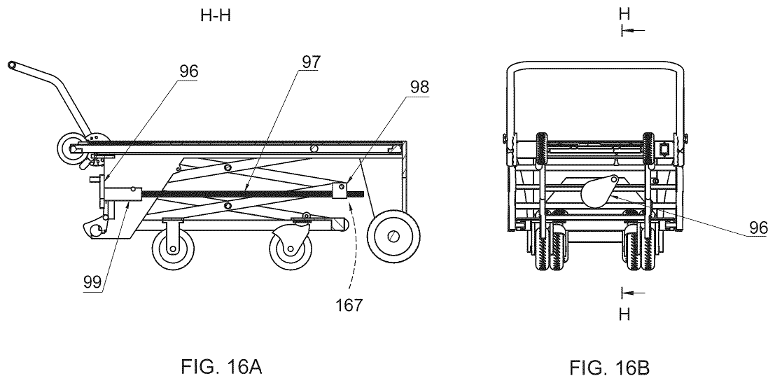

Furthermore, as shown on FIGS. 16A-B, the lifting assembly may alternatively include a manually operated lifting assembly, that may include a manual leadscrew assembly, that may include of a manual crank (96) that may be connected to a stationary pivoting mount (99), wherein the crank drives a leadscrew (97), which in turn may drive a leadscrew nut (98) connected to the far end of the scissor lift (167). When the crank (96) is turned, the leadscrew (97) may push the leadscrew nut (98), forcing the scissors together and extending the scissor lift (167). To contract the scissor lift, the direction of rotation of the crank may be reversed. The leadscrew may pivot slightly on the stationary pivot (99) as the scissor height changes.

The transportation module (200) may include a handle (38) connected to the rear end (124) of frame member (122). The handle may be used to push, pull and steer the system. The handle may be pivotally connected to said rear portion of said frame member, and include pivoting handle mount (10), so that handle may pivot to assume a substantially horizontal position, to accommodate for large/long and/or oddly shaped objects. The handle may be operable to pivot further downwardly, so that after assuming the substantially horizontal position, it may be further pivoted downwardly to assume a substantially vertical position that may be allowed by a pivoting handle mount (10). In order to pivot the handle (38), one may disengage a handle adjustment knob (45) located on the handle mount (10), readjust the handle to the desired angle, and re-engage the knob (45) to lock the handle in place. In some embodiments, the handle (38) may be removable and/or repositionable. For example, handle (38) may be removed from the rear end of the frame member, and then attached to the front end of the frame member, if so desired.

In some embodiments, the handle may be length-adjustable, so that a user may adjust its length according to his height and comfort preferences, task at hand, and/or load geometry, such as large, bulky, oddly shaped cargo, or may optionally remove the handle. The handle may include at least one user engagement portion. Moreover, the handle may be foldable. In some implementations, the handle may include a handle container. In some embodiments, the handle (38) may not be present.

The transportation module (200) may include a single motor or a combination of motors. For example, it may include: a single motor, herein referred to as a first motor to drive the ground wheels (16); a single motor, herein referred to as a second motor, to drive the approach wheels (32); both the first and the second motors each driving corresponding wheels; or a single motor to drive both the ground wheels (16) and the approach wheels (32). The first motor may also be referred to herein as a ground wheel motor, and the second motor may be referred to herein as an approach wheel motor.

A first motor may be operable to drive at least two of plurality of ground wheels, the motor configured to be connected to a source of power; and may be configured to be connected to a source of electrical power; The motor may be configured to drive at least two or all ground wheels (16).

A second motor may be operable to drive at least one approach wheel, the second the motor configured to be connected to a source of power; and may be configured to be connected to a source of electrical power. Wherein the transportation module may include more than one approach wheel, the second motor may be configured to drive at least two of them. For example, the second motor may be configured to drive two approach wheels (32).

A single motor, herein referred to as a motor, may be operable to drive at least two of the plurality of ground wheels (16) and at least one approach wheel (32).

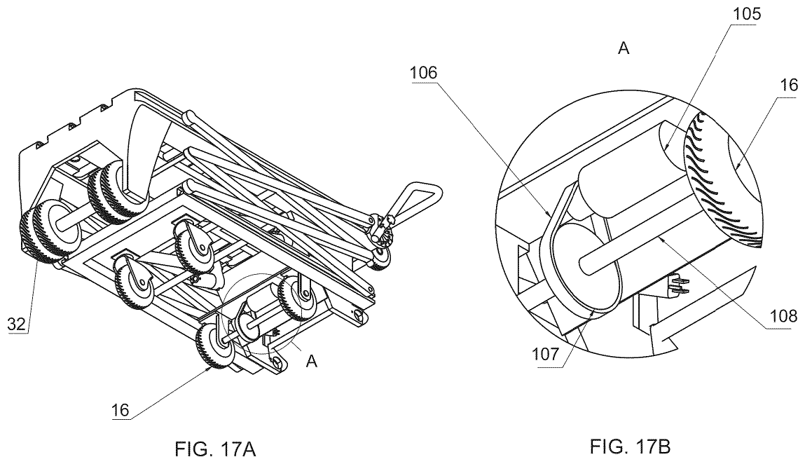

FIGS. 17A-B show an exemplary first motor, marked herein as a ground wheel motor (105) operable to drive ground wheels (16). As shown, when driving ground wheels (16), two rear ground wheels (16) may be connected together via an axle (108), and the motor (105) may be connected to a chain (106), which may provide torque to a drive gear (107), turning the axle (108) and rotating the ground wheels (16).

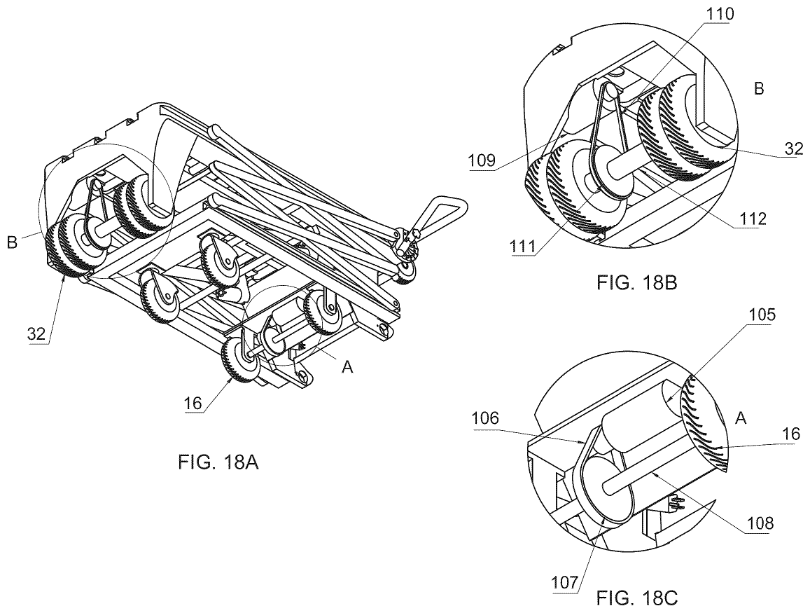

FIGS. 18A-C show an exemplary combination of motors, a first motor (ground wheel motor) and a second motor (approach wheel motor), wherein the first motor may be operable to drive ground wheels (16) and the second motor may be operable to drive approach wheels (32). As shown, when driving the ground wheels (16), the rear ground wheels may be connected together via an axle (108), and the first motor (105) may be connected to a chain (106), which provides torque to a drive gear (107), turning the axle (108) and rotating the ground wheels (16). The approach wheels (32) may be connected via an axle (112), and a second motor (109) may be connected to a chain (110), which may transfer torque to an axle (112) connected to the approach wheels (32), and the torque may rotate the wheels (32).

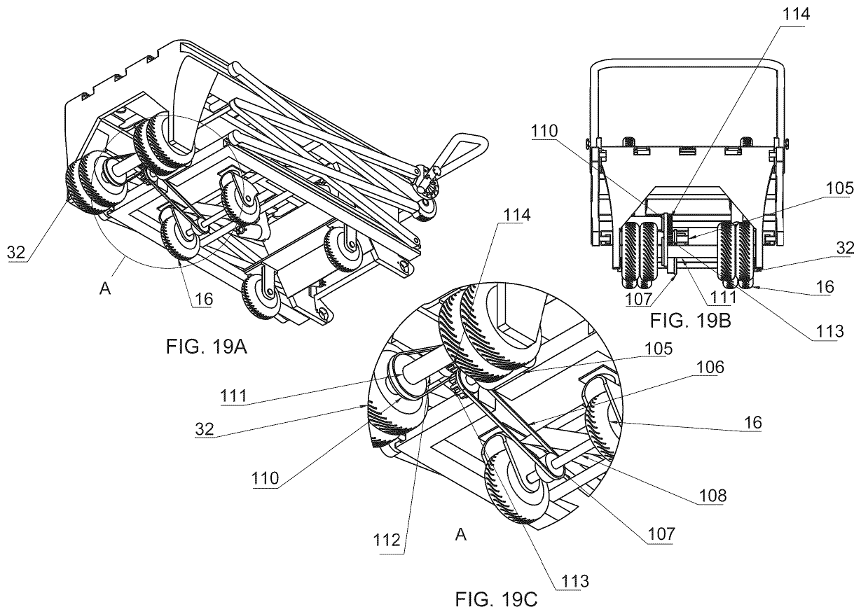

FIGS. 19A-C show an exemplary motor, that may be operable to drive at least two of the plurality of ground wheels (16) and at least one approach wheel (32). When driving the ground wheels (16) and approach wheels (32) with a single motor, the front ground wheels (16) may be connected via an axle (108), and a motor (105) may be connected to a mating gear (113) and a chain (106), which may provide a torque to a drive gear (107), turning the axle (108) and rotating the ground wheels (16). In addition, a second mating gear (114) may be connected to a chain (110), which may transfer torque to an axle (112) that is connecting the approach wheels (32). When the scissor lift of the lifting assembly is substantially or fully contracted, the two mating gears (113 and 114) may mate together, transferring torque from the ground wheel motor (105) to the approach wheels (32).

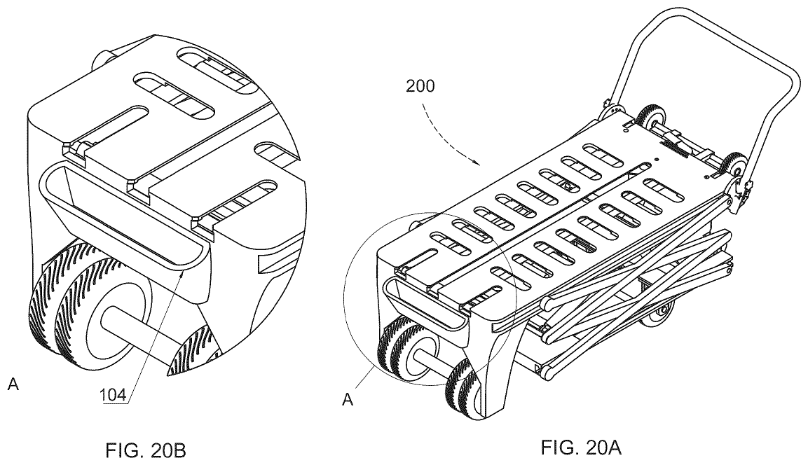

As shown on FIGS. 20A-B, the transportation module (200) may include a container for articles (104) that may be mounted to the frame member. The container may include, for example, and without limitation, a basket, an open container, a container with lid, a drawer, a tool holder, peg board, hanger, or combination thereof. The container may be fixedly or detachably mounted to the frame member.

In some embodiments, the transportation module (200) may include brakes, functionally connected to the ground wheels (16) and operable decelerate the system. This feature may be particularly practical when system may be driven on sloping terrain, and especially useful when is pushed manually.

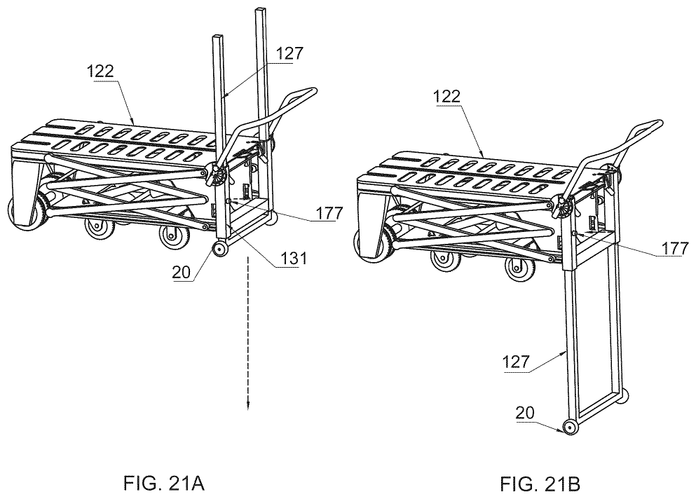

The aforementioned structures of the leg member configuration and the leg-receiving assembly are not limiting. In some embodiments, the leg-receiving means may include at least one tubular, rail shaped receiver, so that the leg body is operable to extend from and retract into and extend from the receiver. An exemplary embodiment of the tubular receiver is shown on FIGS. 21A-B. As shown, the frame member (122) may include a tubular receiver (131), that is shown mounted to the strut (3), wherein a leg member may be configured to extend and retract from the receiver. The tubular receiver may be configured to enclose a part or entirety of the leg member. The leg member may be telescopically foldable or extendable to fit into the receiver, and/or to include a length-adjustable functionality. Furthermore, leg member retraction mechanisms may be manual or motorized.

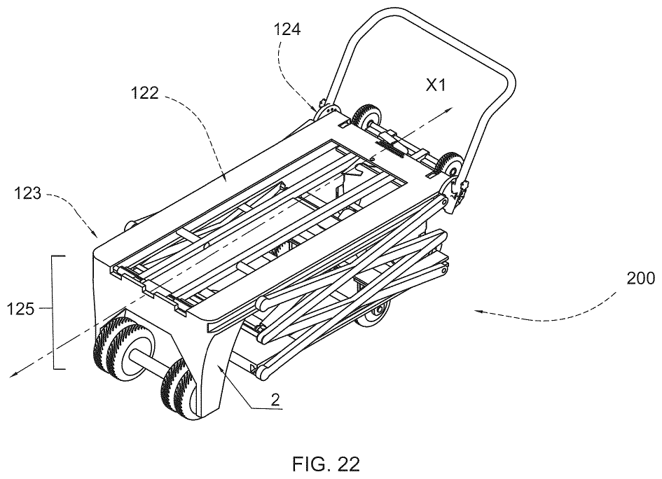

An alternative platform-less embodiment of the transportation module (200) is shown on FIG. 22, that may include some or all of the additional elements and structures disclosed herein.

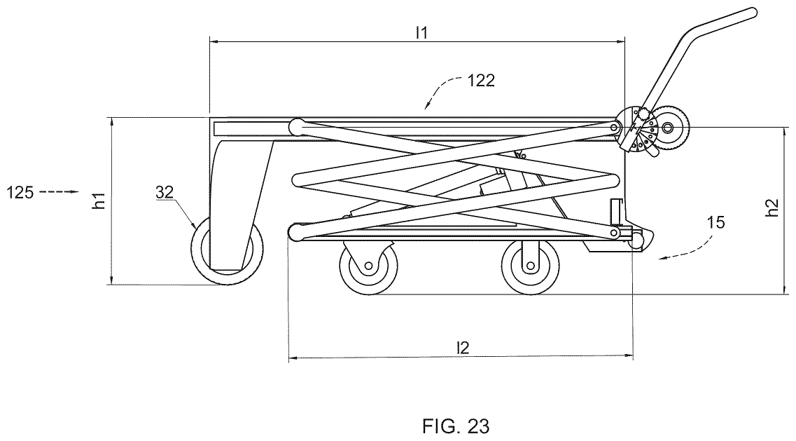

As shown on FIG. 23, the overhang member may have a height h1 and the lifting assembly in a substantially contracted state together with the base member may have a cumulative height h2, and wherein h1 is greater or equal h2 (h1≥h2); so that when the system is being loaded to an elevated surface/vehicle and the approach wheels (32) of the overhand member (125) engage that surface, the lifting assembly may contract, so that the base member (15) may be elevated enough that the ground wheels at least substantially align with or rise above the level/height of the elevated surface upon which the approach wheel is rested. The height h1 may be measured from a top surface of the frame member to the outer portion of the approach wheel that is in contact with a surface. In some embodiments, wherein the frame member may include the platform member, the h1 may be measured from a top surface of the platform member to the outer portion of the approach wheel that is in contact with a surface. The frame member may have a length l1, and the base member may have a length l2, and wherein l1 is greater than l2 (l1>l2). The l1 may be measured from the front end to the rear end of the frame member, and l2 may be measured between outermost front and rear ends of the base member.

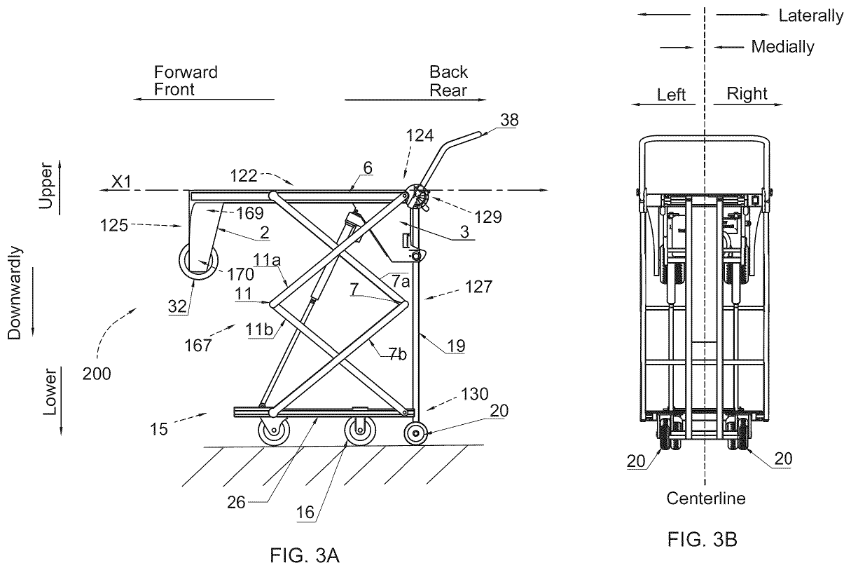

As best shown on FIG. 2 and FIGS. 3A, 4A, 5A, and 6A-B, in some embodiments, each of the linear slide rails (4) of the fame member (122) may have two tracks, the medial slide track (5) and the lateral slide track (6). The scissor lift (167) may be mounted to the frame member, wherein sliding scissors (7) may be slidably mounted to the lateral slide track (6), for example, by upper sliding wheels (8) that may enable horizontal sliding motion and rotation of the of the sliding scissors (7) within and about the lateral slide track tracks (6); and stationary scissors (11) may be mounted to the frame member (122) for example, by pivoting upper bolted connections (13), so that they may pivot about the connections. On the bottom, the sliding scissors (7) may be attached by lower sliding wheels (12) to a pair of laterally facing base slide tracks (26) located on a base frame (165) and extending along its lateral sides; and the stationary scissors (11) may be mounted to the base frame (165) by a lower bolted connection (27). The scissor lift (167) may be driven by electrical linear actuators (9), that may be mounted to a strut (3) and a lover mounting beam (14), such that when the actuators (9) push forward, the scissor lift (167) expands, and when the actuators (9) pull back, the scissor lift contracts. The lower mounting beam (14) connects the actuators (9) to the base frame (165).

In some embodiments, the transportation module (200) may include at least one tool carrier (not shown), that may include tool mounting means, that may include hooks, fasteners, Velcro-type fasteners, clamps, magnets, but not limited thereto. In some embodiment the tool carrier may comprise at least two spaced apart holders; wherein the holders may include tool mounting means, that may be attached thereto or be integrally monolithic with the holders. The tool carrier may be mounted to the frame member (122) fixedly or detachably. The tool carrier may have configuration of the tool carrier (53).

In some embodiments, wherein the leg member (127) is length adjustable, the methods may further include a step of adjusting the length of the leg body (19); for instance, as shown on FIG. 10, but should not be construed to be limited to the depicted mechanism of length adjustment.

In some embodiments, in addition the key switch (44), the transportation module (200) may include additional anti-theft devices, such as electronic wheel clamp or boot that may be attached to the ground wheel or the approach wheel, GPS imbedded systems, but not limited thereto.

In some embodiments, at least one ramp may be included that may slidable or otherwise extendable from the frame member (122), for instance from the platform member (1) and/or cart platform (36), wherein the ramp may be configured to be used for rolling heavy items on and off the system.

The transportation module may include at least one charging port operable to charge devices, such as tools, equipment, mobile devices, but not limited thereto, from the lifting assembly's power source; for instance, from a battery, such as battery (28). The charging ports may be internal and/or external. Additionally, the module (200) may include a charging port operable to recharge at least one battery, that may be included in the system, for instance battery (28), but not limited thereto, wherein the port may be operable use 120/220 VAC mains power, with or without an AC/DC converter.

The transportation module (200) may include at least two side bars that may be retractable form lateral portions of the frame member (122), for example, from lateral sides of the platform member (1), to engage the supporting surface and provide additional stability. The side bars may be particularly useful when heavy loaded system is being loaded/unloaded to high elevated surface, such as high vehicle platform. The side bars may be wheeled, and the wheels may be swiveling and/or may be lockable in position. The side bars may be extendable from the frame member at least about 10 inches. For example, and without limitation, the bars may be L-shaped, and each may include at least one wheel that may be mounted to the lower end of the L-structure, so when the bars are extended, they may be operable to rotate downwardly to, so that the wheels may engage a supporting surface. However, in some other implementations, the bars may not include the bars wheels and may be shaped alternatively.

In some embodiments, the side bars may be stored under the frame member (122), for instance under the platform member (1), when not in use. In some embodiments, the bars may be operable to extend laterally by sliding out from the storage space or extend in lateral directions otherwise.

In some embodiments, the side bars may be extendable from the lateral sides of the frame member (122), for instance from the lateral sides of the platform member (1), (or from the storage space), at least about 10-20 inches; but preferably about 12 inches from the lateral sides of the platform (1), and wherein the platform (1) may be about 20-40 inches wide, but preferably about 30 inches wide. In some embodiments, the side bars, each may include two wheels. However, in some other embodiments, the side bars, each may include at least one wheel.

In some embodiments, the transportation module (200) may include at least one ring and/or hoop, that may be connected to the frame member (122) and may be operable for securing the system to a vehicle during transit.

The ground wheels (16) may be configured according to a user request and may include custom wheels designed for a particular terrain or task. Alternatively, the ground wheels (16) may be detachable, and the system may include additional wheel sets that that may be exchangeable with the ground wheels. The wheel sets may include wheels configured for different terrains and applications, and may differ in size, material, and design. Furthermore, the approach wheel (32), may be configured in similar manner as aforementioned, according to particular needs.

The location of a power delivery system is not particularly limited. For example, and without limitation, it may be located within the strut (3) or below the frame member (122), for instance, below the platform (1).

In some embodiments, at least one bumper may be attached to the front portion of the frame member (122), to prevent accidental damage to other vehicles/objects in case of contact or collision. The bumper may comprise an elastomer.

According to some embodiments, a method provided for loading the transportation system (100) to an elevated surface; for example, and without limitation, to a vehicle, wherein the method may include: providing the system comprising a transportation module (200), wherein the transportation module (200) may include: a frame member (122) defining a longitudinal axis and having a front and a rear opposing ends, wherein the front end comprising an overhang member (125) having an overhang portion (2) protruding downwardly below the frame member; the overhang portion having at least one approach wheel (32); a base member (15) comprising a plurality of ground wheels (16), the wheels configured for engaging and rolling over a supporting surface; a lifting assembly connected between said base member (15) and said frame member (122); the lifting assembly configured to lift and lower the frame member (122) relative to the base member (15); a leg member (127) comprising a leg body (19) and at least one loading wheel (20); the leg body having a first end (129) and a second end (130); the first end mounted to the frame member (122); and the loading wheel (20) mounted to the second end (130); a leg immobilizing means configured to secure said leg member in substantially vertical position; and wherein the frame member (122) further comprising a leg-receiving means, and wherein leg member (127) is operable to extend from and retract to said receiving means. Then advancing the transportation module along a supporting surface toward an elevated surface edge via the plurality of ground wheels (16) of the base member; lifting said frame member relative to said base member via said lifting assembly, so that the approach wheel (32) is elevated to a height exceeding a height of the elevated surface; advancing the transportation module (200) via the plurality of ground wheels (16) until the base member (15) is adjacent to an edge of the elevated surface and the approach wheel (32) is positioned above the elevated surface; extending the leg member (127) from the leg-receiving means; so that the leg body (19) has achieved substantially vertical position relative to the supporting surface; securing the leg member (127) in a position substantially vertical to the supporting surface by the leg immobilizing means; lowering the frame member (122) relative to said base member (15) via the lifting assembly until the approach wheel (32) engages the elevated surface; lifting the base member (15) relative to the frame member (122) via the lifting assembly, so that the ground wheels (16) have substantially aligned with the elevated surface; advancing transportation module (200) via the approach wheel (32) and the loading wheel (20) until the ground wheels (16) engaged the elevated surface; releasing the leg member (127) from the leg immobilizing means; retracting the leg member (127) to the leg receiving means.

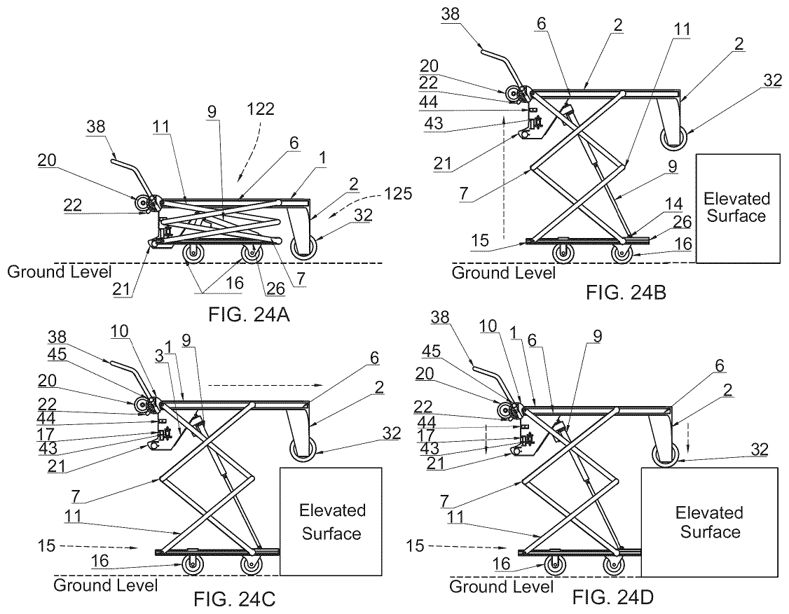

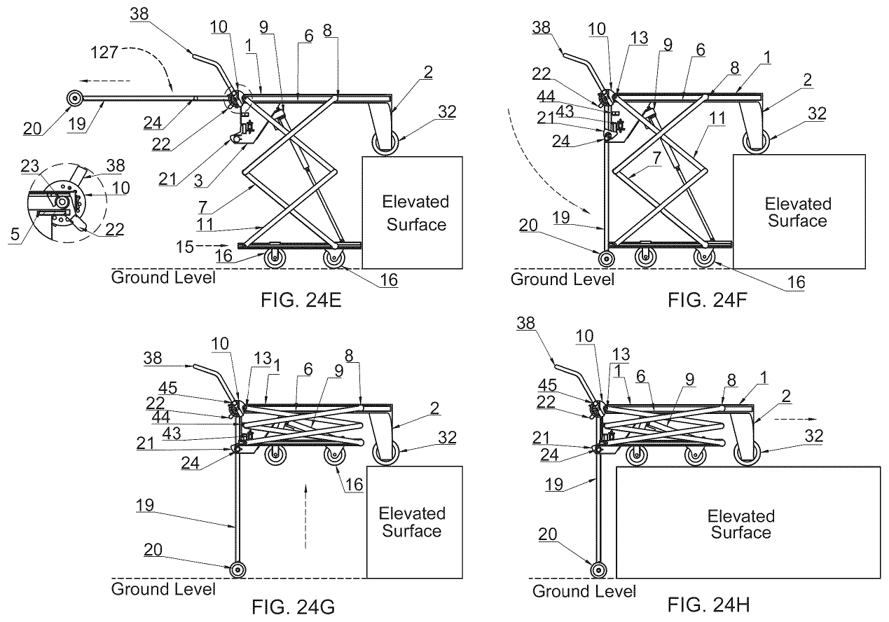

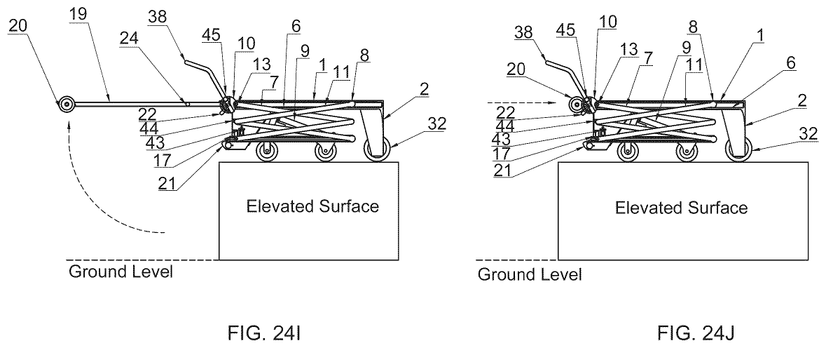

According to some embodiments, and as best seen on FIGS. 24A-J, a method provided for loading the transportation system (100) to an elevated surface; for ex ample, and without limitation, to a vehicle, wherein the method may include: providing a transportation system comprising a transportation module (200), wherein the module may include: a frame member (122), defining a longitudinal axis and having a front (123) and a rear (124) opposing ends, the frame member comprising a platform member (1), a first and a second spaced apart linear slide rails (4); an overhang member (125) and a strut (3); the platform member extending longitudinally between the front and rear ends, the platform member comprising at least one groove extending therethrough; the slide rails (4) mounted below the platform member (1) and extending longitudinally, each of the rails having a medially facing track (5); said slide rails having a front and rear opposing portions; the overhang member (125) comprising an overhang portion (2) having an upper end (169) and a lower end (170); the upper end connected to front portion of slide rails (4), the overhang portion (2) protruding downwardly below the rails (4) and a the lower end comprising at least one approach wheel (32); the strut (3) mounted to the rear portion of the rails (4) and having a user engagement portion; a base member (15) comprising a plurality of ground wheels (16), the wheels configured for engaging and rolling over a supporting surface; a powered lifting assembly connected between base member (15) and the frame member (122); the lifting assembly configured to lift and lower the frame member relative to the base member; the lifting assembly comprising a scissor lift (167) and an actuator (9) configured to be connected to a source of electrical power; a leg member (127) comprising a leg body (19) and at least one loading wheel (20); the leg body having a first end (129) and a second end (130); the loading wheel (20) mounted to the second end of the leg body; and the first end (129) of the leg body (19) mounted to the medially facing tracks (5) by a pair of laterally protruding mounting pins (23), the pins having rotational axes; the tracks (5) configured to translatably receive the leg body (19), so that leg body operable to extend and retract from the tracks (5); and pivot about the rotational axes of the pins when extended; and a first motor, operable to drive at least two of the plurality of ground wheels (16), the motor configured to be connected to a source of power; a handle (38) connected to the rear end of the frame member (122); wherein the leg member includes a laterally protruding locking pins (24) and the strut (3) includes a gravity latch (21), the latch configured to releasably couple to the locking pins; to secure the leg member (127) in substantially vertical position. Then, advancing the module (200) along a supporting surface toward an elevated surface edge via the plurality of ground wheels (16) of the base member (15), as shown on FIG. 24A; lifting the frame member (122) relative to the base member (15) via the lift assembly, so that the approach wheel (32) is elevated to a height exceeding a height of an elevated surface, as shown on FIG. 24B; advancing the module via the plurality of ground wheels (16) until the base member (15) is adjacent to an edge of an elevated surface and the approach wheel (32) is positioned above the elevated surface, as shown on FIG. 24C; extending the leg body (19) from the tracks (5); by sliding out the mounting pins (23) and the leg body (19) from said tracks, so that the leg body (19) has achieved substantially horizontal position, as shown on FIG. 24E; pivoting the leg member (127) downwardly about the rotational axes of the mounting pins (23), so said leg body has achieved substantially vertical position, as shown on FIG. 24F; securing the leg member (127) in a substantially vertical position by engaging the pair of laterally protruding locking pins (24) of the leg member to the gravity latch (21) of the strut (3), as shown on FIG. 24F; lowering the frame member (122) relative to said base member (15) via said lift assembly until said approach wheel (32) engages an elevated surface, as shown on FIG. 24D; lifting the base member (15) relative to said frame member (122) via the lift assembly, so that the ground wheels (16) have substantially aligned with an elevated surface, as shown on FIG. 24G; advancing the module via the approach wheel (32) and the loading wheel (20) until the ground wheels (16) engaged the elevated surface, as shown on FIG. 24H; releasing said locking pin (24) of the leg member (127) from the gravity latch (21) of the strut (3), as shown on FIG. 24I; pivoting the leg member upwardly about the rotational axes of the mounting pins (23), so that the leg body (19) has achieved substantially horizontal position, as shown on FIG. 24I; retracting the leg body (19) to said tracks (5) by sliding in the mounting pins (23) and the leg body (19) into the tracks (5), as shown on FIG. 24J.

Depending on a particular embodiment of the transportation module (200) the aforementioned methods may include additional steps. Also, some steps may be omitted and/or performed in different order.

For example, and without limitation, in some embodiments wherein the leg member of the transportation module is length-adjustable, the methods may include a step of adjusting the length of the leg body, so that the length of the leg member may correlate with the height of the elevated surface and the loading wheel of the leg member may engage the supporting surface.

For example, and without limitation, wherein the transportation module may include side bars, the methods may include steps necessary to engage and disengage the side bars.

For example, and without limitation, wherein the transportation module or the cart may include a ramp, the methods may include steps of extending the ramp and retracting the ramp.

It should be noted that, although the method, describes the process of loading the transportation system comprising a transportation module to an elevated surface, the process of unloading the system from that surface will easily become apparent to the ordinary skilled in the art, having the benefit of the current disclosure, and intended to be included in the scope of the current disclosure. Moreover, the steps of the methods may be reversed and/or performed in order other than aforementioned, and/or omitted.

In some embodiments, transportation system (100) may include a cart. The transportation module (200) and the cart (100) can be interlocked to connect and separate.

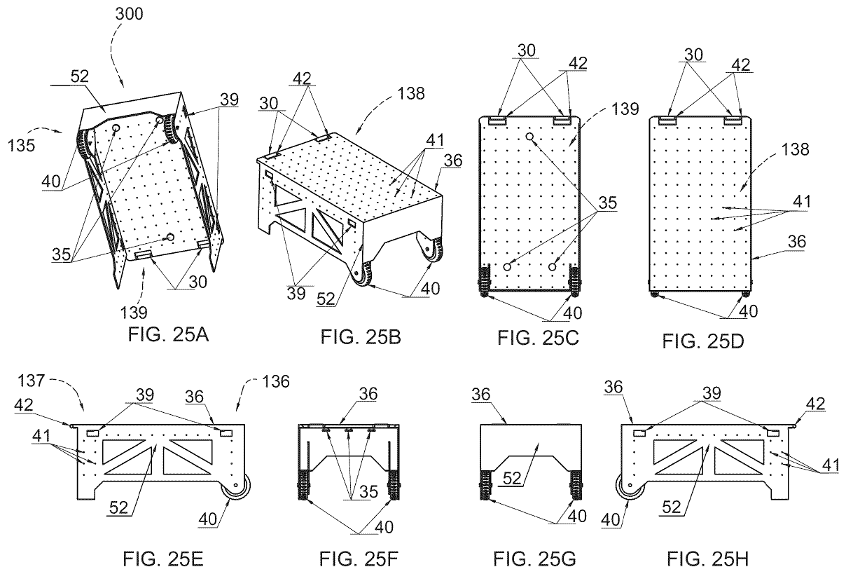

Referring now to FIGS. 25A-H, diagrams are shown illustrating various views of an exemplary cart (300), in accordance with an exemplary embodiment of a system (100). As shown, the cart (300) may include a cart body (135) and front wheels (40). The cart body has a front section (136) and a rear opposing section (137); and the front wheel (40) may be mounted to the front section of the cart body. The cart body may be (135) configured to detachably couple to the frame member (122) of the transportation module (200).

As shown, the cart (300) may have two front wheels (40), however shown number of front wheels are not limiting, and one or more wheels may suffice. The front wheels may be operable to rest on the vehicle while loading and unloading the system into and from the elevated surface/vehicle. The front wheels (40) may also enable a user to manually relocate the cart, that has been disconnected from the transportation module (200), over short distances. The front wheels (40) may be swiveling, wherein the swiveling function can be switched on/off on demand; for example, and without limitation, by a manual foot lock. In some embodiments, the front wheels (40) may be configured for different terrains and applications, and may vary in size, material, and design, and may be pre-configured according to user requests. In some embodiments, the front wheel (40) may be detachable, and a set of interchangeable front wheels configured for different applications may be included in the system.

The cart (300) may include brakes (not shown), that may be connected to front wheels (40), wherein the brakes may be advantageous when the user needs to manually relocate the cart down sloping terrain; for instance, when the transportation module (200) is detached and not immediately available.

In some embodiments, the cart (300) may additionally include at least two rear wheels (not shown) that may be mounted to the rear section of the cart body (137), wherein the wheels may be removable and/or retractable and may be swiveling.

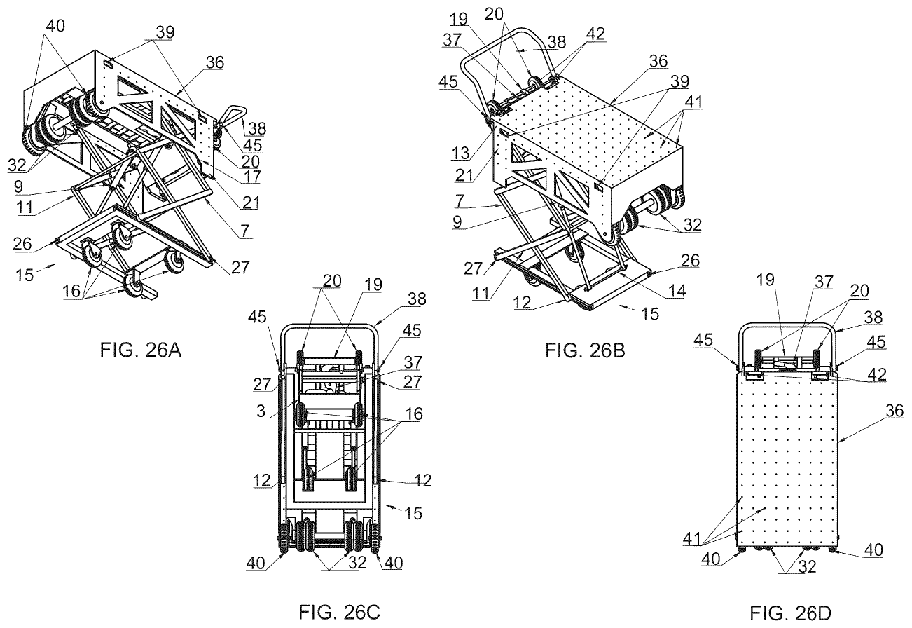

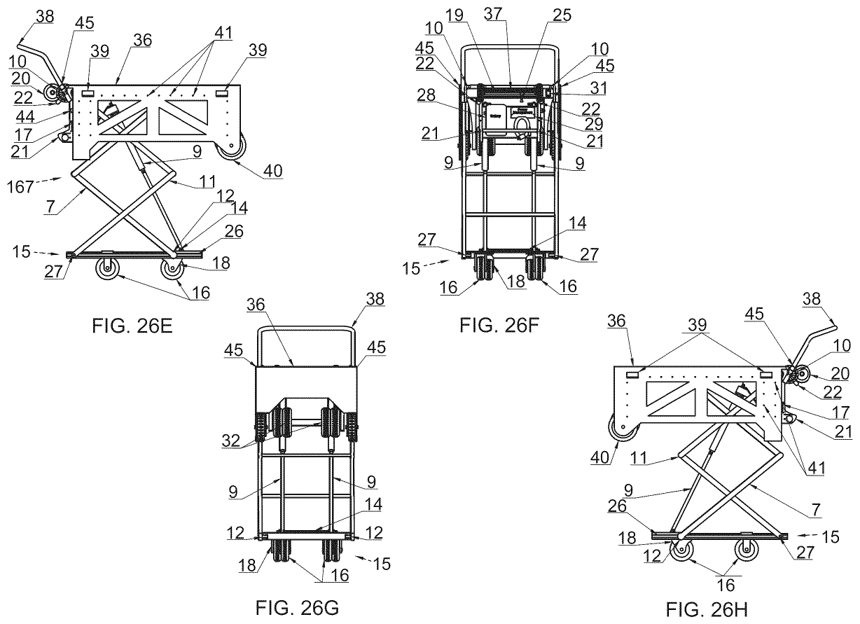

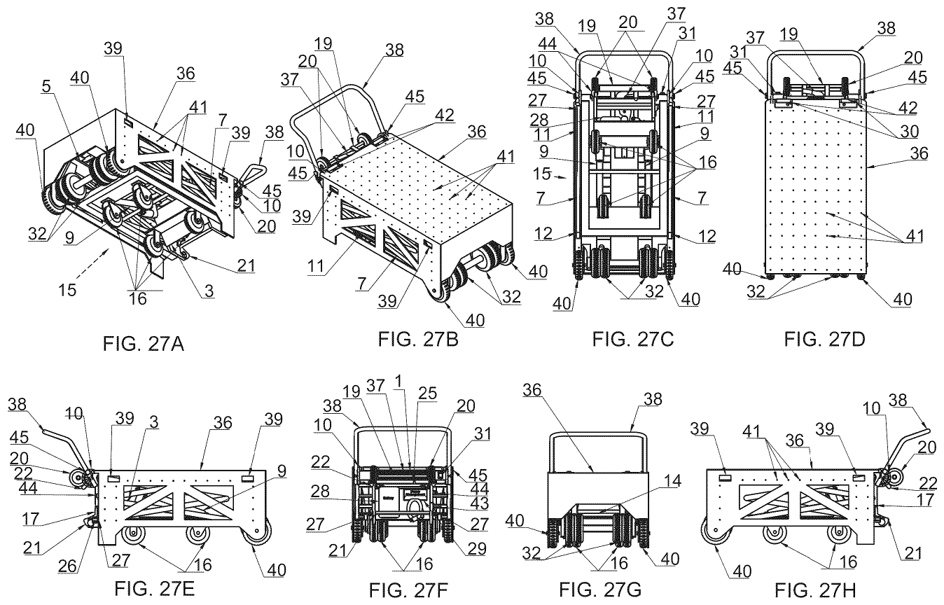

FIGS. 26A-H and FIGS. 27A-H are diagrams illustrating various views of an exemplary transportation module (200) and an exemplary cart (300), wherein the cart is shown coupled to the transportation module, in accordance with an exemplary embodiment of a system (100). On FIGS. 26 A-H, the system is shown in elevated position, wherein the scissor lift (167) is expanded, and the cart (300) shown lifted above base member (15) of the transportation module (200). On FIGS. 27A-H, the system is shown in lowered position, wherein the scissor lift is contracted, and the cart (300) is lowered.

The cart body (135) may be configured to detachably couple to the frame member (122) of the transportation module (200) by a transportation module-to-cart coupling mechanism; that may include, for example, and without limitation, bolts, screws, fasteners, Velcro-type fasteners, clamps, straps, ratchets, ratchet straps, mechanical linkages, protruding elements (such as, pegs or bars) and apertures, grooves, or any combination thereof. Although, other transportation module-to-cart coupling mechanisms and locking features can and will suffice and are intended to be within the scope of this disclosure.

As best shown on FIGS. 25A-H, the cart body (135) may include a front (136) and a rear (137) opposing sections, a cart platform (36), and a cart base (52). The front wheel (40) may be mounted to the front section of said cart body (136). The rear section (137) may include at least one rear handle (42). The cart platform (36) may have a top surface (138) and a bottom surface (139), and the cart base (52) may be connected to the bottom surface of said cart platform (139). In some embodiments, the cart platform (36) may be integrally formed as a monolithic unit with the cart base (52); while in other embodiments, the cart platform (36) may be connected to a cart base (52) and be optionally detachable. For example, and without limitation, the cart platform (36) may be comprising of materials, such as steel, aluminum, brass, fiber reinforced composite, or any combination thereof. For example, and without limitation, the rear handle (42) may be made of metal or metal alloys, such as steel, brass, aluminum, but not limited thereto. The rear handle (42) may include material for enhancing users comfort. In some embodiments, the rear handle (42) may include handle grip (30), wherein the grip may include materials, such as rubber, grip tape, foam, thermoplastic and/or thermoset polymers and their composites, but not limited thereto; wherein the materials may have intrinsic or imparted shock and/or vibration damping properties. Furthermore, the rear handle (42) may be textured for better grip or comfort. Moreover, the rear handle (42) may be integrally monolithic with the cart platform (36). Alternatively, rear handle (42) may be fixedly or detachably connected to the cart body (135) and may be and/or foldable or otherwise extendable to comfort level of the user. The number of rear handles (42) is not limited, and though two rear handles (42) are illustrated, at least one rear handle may suffice and included in the scope of the disclosure. Furthermore, in some embodiments, the handle may be omitted. The number of the front wheels (40) is, likewise, not limiting and though two front wheels (40) are illustrated, at least front wheel (40) may suffice and included in the scope of the disclosure. Moreover, while in preferred embodiments, the cart (300) includes at least one front wheel (40), in some embodiments, the front wheel may be omitted, and the system (100) may rely on the approach wheels (32) for loading to an elevated surface.

In some embodiments, the cart platform (36) may be configured to detachable couple to the to the platform member (1) of the transportation module (200). In some embodiments, the cart platform (36) may be configured to detachably couple to the platform member (1) of the transportation module (200) by the transportation module-to-cart coupling mechanism. For example, and without limitation, the transportation module-to-cart coupling mechanism may include bolting, latching, tongue and grooves, pinning, or adhering, straps, fasteners, Velcro-type fasteners.

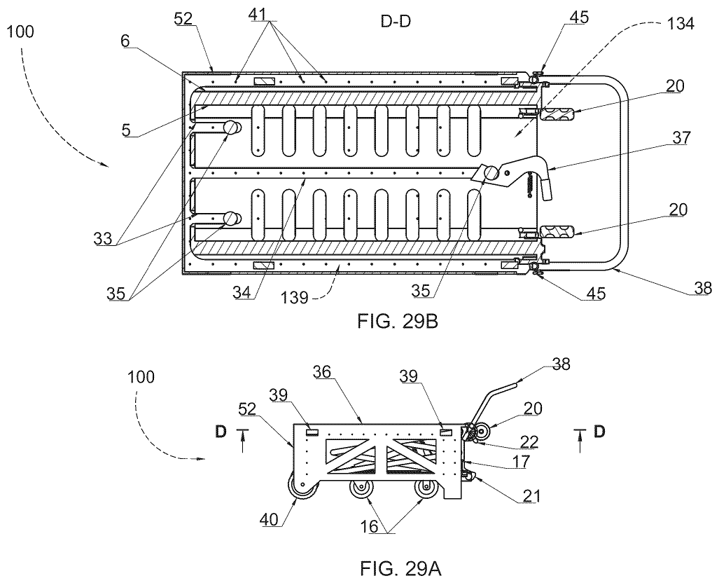

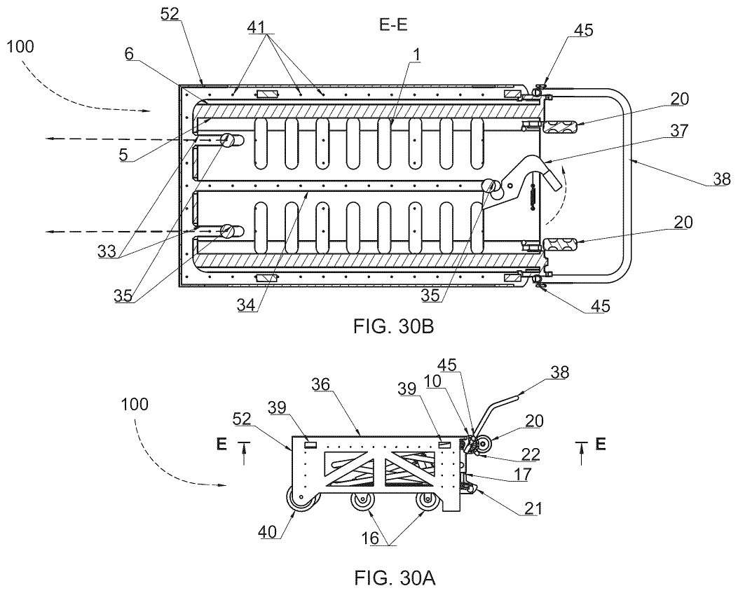

As shown on FIGS. 28A-B, 29A-B and 30A-B, in some embodiments, the transportation module-to-cart coupling mechanism may include three mating pegs (35) having a first end and a second end (not shown); wherein the first end may be connected to the bottom surface of the cart platform (139); the second end may be protruding downwardly (best seen on FIG. 25B); and the platform member (1) of the transportation module (200) may include a long coupling groove (34) and two short coupling grooves (33), the groove extending therethrough between the top surface (133) of the platform member (1) and the bottom surface (134) of the platform member (1), wherein the grooves (33) and (34) may be configured to receive the mating pegs (35); so that the cart (300) may be operable to couple to, and uncouple from the transportation module (200) by guiding the mating pegs (35) into and out of the grooves (33) and (34), as shown with dashed arrows on FIGS. 28A-B. The shape of the grooves is exemplary and not limiting. At least one mating peg (35) may additionally be secured in place by a locking feature, such as spring-assisted latch (37), as shown on FIG. 29B. The locking feature, such as latch (37) may be mounted to the bottom surface of the platform member (134) and use the force provided by a tension spring (174) for securing the mating peg (35) within the groove (34). The number of mating elements and corresponding grooves, likewise, is not limiting, and at least one groove and one corresponding mating element will suffice. The mating elements are not particularly limited to the pegs, and may include, for example, pins, or other suitable fasteners; and locking feature configuration is not limited to the latch (37), and a regular latch, a pin, a clamp, solenoid, or other conventional locking elements will suffice, and included in the scope of current disclosure. Moreover, the platform member (1) may include multiple locking features that may be mounted to the bottom surface (134) or located elsewhere within the frame member (122); so that multiple or all mating elements may be secured within the grooves. FIGS. 29A-B show the cart (300) coupled to the transportation module (200); and the mating pegs (35) are inserted to the coupling grooves (33) and (34) and one of the pegs (35) is locked securely in position within a long coupling groove (34) by latch (37). FIG. 30B shows the spring latch (37) as being released and the mating pegs (30) are being guided out of the grooves (34) and (33) to uncouple the cart (300) from the transportation module (200). The depicted exemplary mechanism may enable safe and secure attachment of the cart (300) to the transportation module (200).

In some embodiments, the location of the coupling features may be reversed. For example, and without limitation, the transportation module-to-cart coupling mechanism may include at least one mating element having a first end and a second end; wherein the first end may be connected to the top surface of the platform member (133) of the transportation module (200); the second end may be protruding upwardly; and the cart platform (36) may have at least one groove extending therethrough and configured to receive the mating element; so that the cart (300) may couple to, and uncouple from the transportation module (200) by guiding the mating element into and out of the groove. The mating element may additionally be secured in place by a locking feature.

Moreover, in some embodiments, the cart (300) may be connected to the transportation module (200) in alternative ways. For example, and without limitation, the cart (300) may be bolted to the frame member (122) or the platform member (1), may be attached by ratchet strap or hook-and-loop tape, or may rely on the rear handles (42), or the ratchet strap connections (39) for attachment.

The cart body (135) may include cart platform lifting means, said means positioned between and coupled to the cart platform (36) and the cart base (52), wherein the means may be operable to lift and lower the cart platform relative to the cart base. The cart platform lifting means may be advantageous for user comfort and/or for easing the process of coupling the cart with the transportation module. For example, and without limitation, the cart platform lifting means may include a jack, a pneumatic piston, a hydraulic piston, an actuator, a scissor lift, an electrical actuator, an electrical linear actuator, or combination thereof. In some embodiments, the platform lifting means may be manual; while in some others, they may be powered or include a combination of manual and powered components. The platform lifting means may be electrically, pneumatically, or hydraulically operated.

The rear section of the cart body (137) may include at least one rear handle (42). The handle may be integrally monolithic with the cart platform or may be fixedly or detachably connected to a rear end of the cart platform; so that a user may manually relocating the cart over short distances, if desired; or when the transportation module is not immediately available. In some embodiments, the rear handle may have alternative configuration and be collapsible, foldable and/or height adjustable.

The cart (300) may additionally include at least two side handles (not shown). The side handles may be integrally monolithic with the cart body (135), for instance, with the cart base (52) or may be fixedly or detachably connected the cart body/base.

The cart (300) may include a tool carrier that may be mounted to the cart; for instance, to the cart body (135) or the cart platform (36). The tool carrier may be fixedly or detachably mounted to the cart. The tool carrier may include tool mounting means, that may include hooks, fasteners, Velcro-type fasteners, clamps, magnets, but not limited thereto. In some embodiment the tool carrier may comprise at least two spaced apart holders; wherein the holders may include tool mounting means that may be attached thereto or be integrally monolithic with the holders. The tool carrier may be conveniently used for transporting and organizing tools and equipment, such as shovels, bars, brooms, vacuum cleaners, axes, crowbars, pry bars, but not limited thereto. The tool carrier may have configuration of the tool carrier (53).

In some embodiments, the top surface of the cart platform (138) may have at least one upwardly protruding peg.

In some embodiments, the cart (300) may include at least one headlight, that may be configured to be connected to a battery, that may include a battery operable to powering the lifting assembly.

In some embodiments, the cart (300) may include at least one external and/or internal charging port (not shown) for charging cell phones, tools and equipment; wherein, for example, and without limitation, the ports may be configured to be connected to a power source used by the lifting assembly of the transportation module, when cart is coupled to the transportation module, and/or through additional power cords when the cart is detached.

The system (100) may include at least one ramp may be extendable from the front end (123) of the frame member (122) and/or from the front section (136) of the cart body (135). The ramp may be stowable into or below the platform member (122) and/or within the cart body (136). In other embodiments, the ramp may be configured as a distinct structure that may be attached/removed as needed and may be stored in the system (100) when not in use.

The system (100) may include at least one bumper for preventing/minimizing accidental damage in case of contact or collision with other vehicles or objects. The bumpers may be mounted to the transportation module frame member (122) and/or the cart body (135).

The system (100) may also include at least one lock ring or hoop that may be connected to the transportation module frame member (122) and/or to the cart body (135) for securing the system on a vehicle during transit.

The system (100) may include at least one detachable gap-filling wedge that may be stored within transportation frame member (122) and/or the cart body (135), and may be available to bridge gaps between, for example, an open tailgate and a truck bed, and prevent wheels of the system (100) from being trapped in the gaps and allow the wheels to roll over smoothly.

The system (100) may include at least one load fastening assembly, that may include, for example, and without limitation, a built-in ratchet strap, a ratchet strap handle, a ratchet strap connection, but not limited thereto that may be connected to the transportation module frame member (122) and/or the cart body (135) and may be operable for securing items thereto. Further, the fastening assembly may be used for securing the cart and/or transportation module to a vehicle. As best shown on FIGS. 25A-H, the cart body (135) may include ratchet strap connections (39), that may be configured for attachment of ratchet straps, and may be further conveniently used as handles to manually lift cart, if desired. The ratchet straps connections (39) may be integrally monolithic with the cart body (135). Moreover, in some embodiments, the ratchet straps (not shown) may be built-in within ratchet strap connections (39).

In some embodiments, the transportation module (200) and/or the cart (300) may include at least one permanently mounted or detachable container, such as basket; so that non-commercial consumers may also advantageously use the system for shopping and other light hauling needs; and may be particularly advantageous for a reduced size version of the system (100), but not limited thereto. The transportation module may also be used be used for transporting humans, and may have a structure configured attachment of baby carriage, car seat or medical gurney.

In some embodiments, wherein the transportation module does not include a platform member, for instance, as depicted on FIG. 22, the cart (300) may be attached directly or indirectly to the frame member (122) of the transportation module. For example, and without limitation, the cart may be secured to the linear slide rails (4) by ratchet straps or other fastening means.

The transportation system (100) may be configured as standard, reduced or oversized versions, that would comprise a transportation module and a cart in standard, reduced or oversized versions accordingly. The system may also include the work cell in matching configuration.

The following dimensions, as well as any other dimensions disclosed herein, of the transportation system, its modules and parts are exemplary and shall not be construed as limiting. In some embodiments, the platform member (1) and/or cart platform (36) may be about 24 inches or less from a supporting surface, when the lifting assembly may be substantially fully contracted. In some embodiments, the frame member (122) and/or cart platform (36) may be about 24 inches or less from the supporting surface, when the lifting assembly may be substantially fully contracted.

In some embodiments, wherein the lifting assembly may be substantially fully contracted, and the cart (300) is coupled to the transportation module (200), the height from the supporting surface to the top surface (138) of the cart platform (36) may be about between 16 and 30 inches, but preferably about 24 inches; the height from the supporting surface to the uppermost gripping part of the handle (38), wherein the handle may be in substantially fully elevated/substantially pivoted-up position, may be about 42 inches; width of cart platform (36) may be about 30 inches; the length of cart platform (36) may be about 60 inches; the loading wheels (20) may protrude beyond cart platform (36) may be about 10 inches, so that the system may have a total length about 70 inches.

In some embodiments, wherein the lifting assembly may be substantially fully expanded, and the cart (300) is coupled to the transportation module (200), the height from the supporting surface to the top surface (138) of the cart platform (36) may be about 68 inches; the height from the supporting surface to the lowest point of approach wheels (32) may be adjusted according to a height of the elevated surface, up to about 50 inches, but preferably up to about 44 inches; the height from the supporting surface to the uppermost gripping part of the handle (38), wherein the handle may be in substantially fully elevated/substantially pivoted-up position, may be about 85 inches; however the handle may pivoted downwardly to remains within reach of a user.

In some embodiments the cart platform (36) may be about 6 inches wider than the frame member (122). In some embodiments the cart platform (36) may be about 6 inches wider than the or the platform member (1).

In some embodiments, a width of the system may be defined by a width of the cart platform (36), wherein the width may be about 20-40 inches, preferably may be about 20-30 inches, and most preferably may be about 25-29.5 inches. Wider embodiments of the system may be preferable, for example, for wider vehicles.

In some embodiments, wherein the lifting assembly may be substantially fully expanded, and the cart (300) is coupled to the transportation module (200), a height from the supporting surface to the lowest point of approach wheels (32) may be about 44 inches; and may be beneficial for system used with higher vehicles.

In some embodiments, dimensions of a reduced size system may be about 30-65 inches long and may be about 12-30 inches wide; and preferably, may be about 30-32 inches long, and may be about 20-24 inches wide.

In some embodiments, dimensions of a standard size system may be about 50-80 inches long and may be about 20-40 inches wide; and preferably, may be about 60-70 inches long, and may be 25-30 inches wide.

In some embodiments, dimensions of an oversized system may be about 70-100 inches long and may be about 25-50 inches wide; and preferably, may be about 70-80 inches long, and may be about 25-40 inches wide.

According to some embodiments, a method provided for loading the transportation system (100) to an elevated surface; for example, and without limitation, to a vehicle, wherein the method may include: providing the system comprising a transportation module (200) and a cart (300); wherein the transportation module may include: a frame member (122) defining a longitudinal axis and having a front (123) and a rear (124) opposing ends, wherein the front end comprising an overhang member (125) having an overhang portion (2) protruding downwardly below the frame member (122); the overhang portion (2) having at least one approach wheel (32); a base member (15) comprising a plurality of ground wheels (16), the wheels configured for engaging and rolling over a supporting surface; a lifting assembly connected between the base member (15) and the frame member (122); the lifting assembly configured to lift and lower the frame member (122) relative to said base member (15); a leg member (127) comprising a leg body (19) and at least one loading wheel (20); the leg body (19) having a first end (129) and a second end (130); the first end mounted to the frame member (122); and the loading wheel (20) mounted to the second end (130); leg immobilizing means configured to secure the leg member (127) in substantially vertical position; and wherein the frame member (122) further comprising a leg-receiving means, wherein the leg member (127) is operable to extend from and retract to the receiving means. The cart may include: a cart body (135) and at least one front wheel (40); the cart body (135) having a front (136) and a rear (137) opposing sections; the front wheel (40) mounted to the front section (136) of the body; the cart body (135) configured to detachably couple to the frame member (122) of the transportation module (200). Then coupling the cart body (135) of the cart to the frame member (122) of the transportation module; advancing the system (100) along a supporting surface toward an elevated surface edge via said plurality of ground wheels (16) of said base member (15); lifting the frame member (122) relative to the base member (15) via the lifting assembly, so that the front wheel (40) is elevated to a height exceeding a height of the elevated surface; advancing the system via said plurality of ground wheels until said base member is adjacent to an edge of the elevated surface and the front wheel (40) is positioned above the elevated surface; extending the leg member (127) from the leg receiving means, so that the leg body (19) has achieved substantially vertical position relative to the supporting surface; securing the leg member (127) in a position substantially vertical to the supporting surface by the leg immobilizing means; lowering the frame member (122) relative to the base member (15) via the lifting assembly until the front wheel (40) engages the elevated surface; lifting the base member (15) relative to the frame member (122) via the lift assembly, so that the ground wheels (16) have substantially aligned with the elevated surface; advancing the system (100) via the front wheel (40) and the loading wheel (20) until the ground wheels (16) engaged the elevated surface; releasing said leg member (127) from the leg immobilizing means; retracting said leg member to said leg receiving means.

The aforementioned step of coupling the cart body of the cart to the frame member of the transportation module, may further include particular elements and steps, that may depend on a particular transportation module-to-cart coupling mechanism involved. For example, and without limitation, as shown on FIGS. 28A-B and 29A-B; the cart (300) may be operable to couple to and uncouple from the transportation module (200) by guiding the mating pegs (35) (also shown on FIG. 25A) into and out of the grooves (33) and (34). However, any other ways to detachably couple to the frame member (122) of the transportation module to the cart body (135) as well as any of aforementioned transportation module-to-cart coupling mechanisms may suffice and included in the scope of the current disclosure.

Moreover, the transportation module may include any aforementioned leg receiving means and leg immobilizing means. Thus, the steps of extending said leg member from said leg receiving means, and retracting said leg member to said leg receiving means; as well as the steps of securing said leg member in a position substantially vertical to the supporting surface by said leg immobilizing means, and releasing said leg member from said leg immobilizing means; may further include particular elements and steps, that may depend on a particular leg receiving means and leg immobilizing means involved.

In some embodiments, the methods may include a step of adjusting the length of the leg body, wherein the leg member of the transportation module is length-adjustable. So that the length of the leg member may correlate with the height of the elevated surface; and the loading wheel of the leg member may engage the supporting surface.

It should be noted that, although the methods, describes the process of loading the transportation system comprising a transportation module and a cart to an elevated surface, the process of unloading the system from that surface will easily become apparent to the ordinary skilled in the art, having the benefit of the current disclosure, and intended to be included in the scope of the current disclosure. Moreover, the steps of the methods may be reversed and/or performed in order other than aforementioned, and/or omitted. Other methods may become apparent to an ordinary skilled in the art having a benefit of the current disclosure; these methods are intended to be included in the scope of the current disclosure.

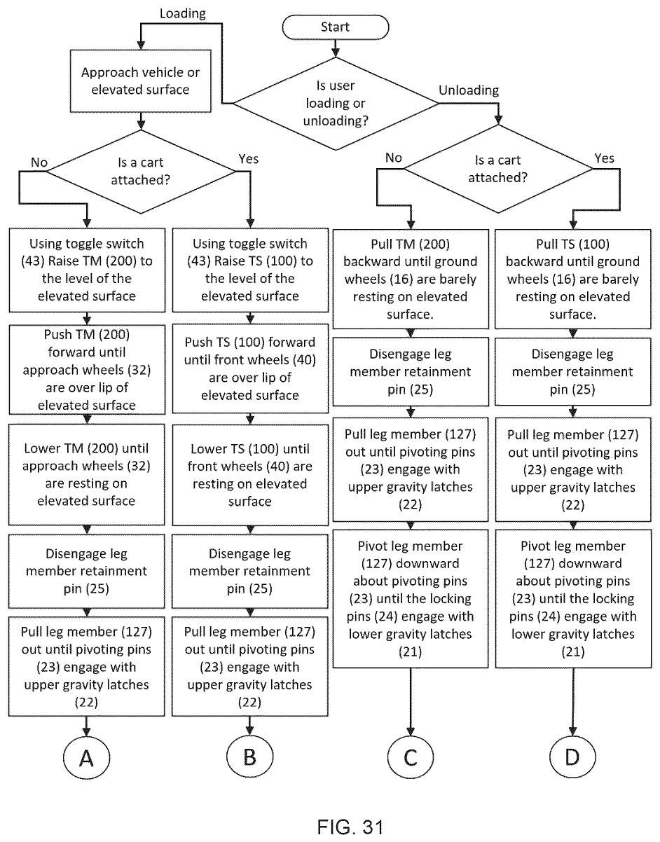

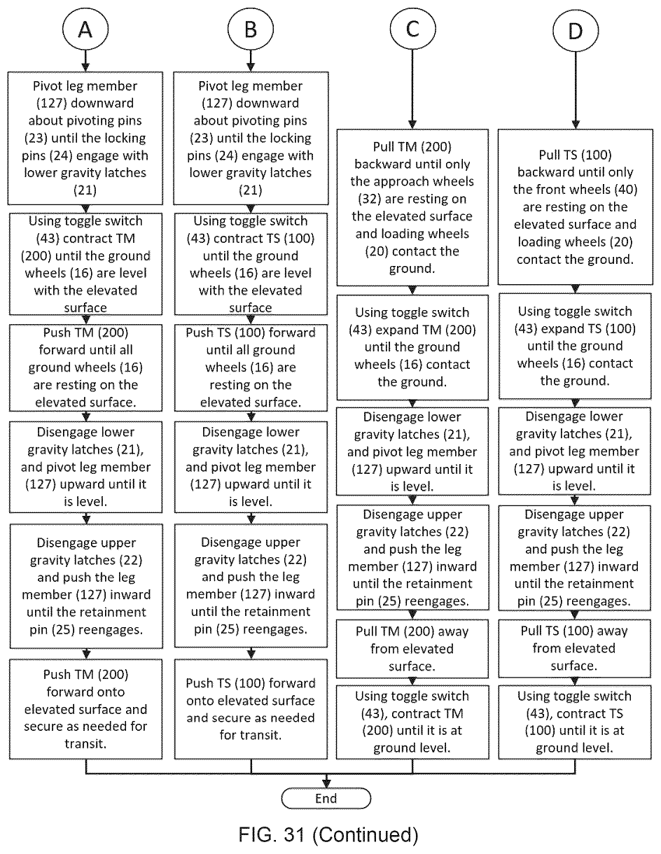

FIG. 31 shows a block diagram of some exemplary methods of loading and unloading the transportation system (100), according to some exemplary embodiments.

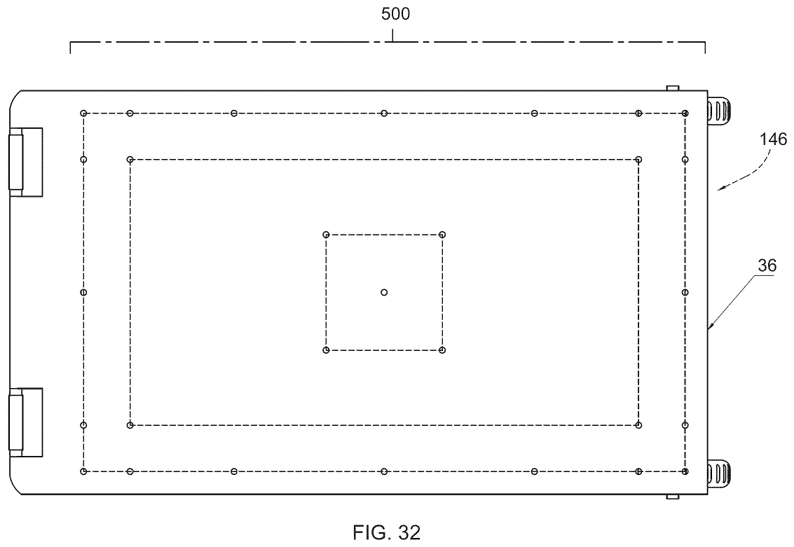

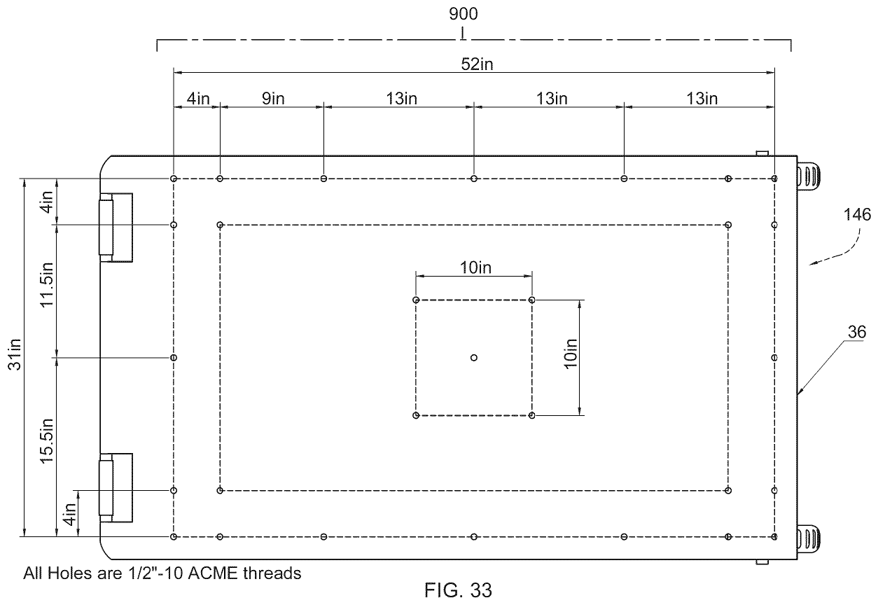

The cart platform (36) may have a plurality of apertures extending therethrough between the top surface of the cart platform (138) and the bottom surface of the cart platform (139); herein referred to as a first plurality of apertures. Exemplary, non-limiting embodiments of first plurality of apertures (41) and (146) are shown on FIGS. 25A-D and FIGS. 32-33. The first plurality of apertures may include a plurality of openings arranged in a pattern/array, wherein the openings may be threaded. The openings may be used to secure, for example, and without limitation, other modules, such as one of the work cells (400), or other objects to the cart platform (36) by bolts, pins, screws, mechanical linkages, or other fasteners.

In some embodiments, the first plurality of apertures may include strategically located openings that may be threaded, wherein the openings may be arranged in one of the specific patterns, herein disclosed and further referred to as connecting bolt opening patterns (CBOPs), wherein the openings may be used to secure other modules, such as a work cell (400) or a connecting module (800), that are described in greater detail thereafter, to the cart platform (36); for instance, by fasteners. The openings of the connecting bolt opening patterns may be strategically positioned to uniformly distribute static and dynamic loads experienced by system's moving and stationary parts and to reduce tensile, torsional shear, shear, compression, and bending stresses experiences by each individual fastener, hence dramatically reducing chances of fastener failure while the cart is involved in supporting, transporting and/or loading the work cell; and thus, contributing to safer user experience. Moreover, some of the openings of the COBP may be strategically positioned to serve as fail-safe features in the event of disengagement or failure a single or multiple fasteners; thus, further contributing to safety, confidence, and satisfaction of the user. Furthermore, several or all openings of the cart's platform CBOP may be simultaneously utilized, depending on applied loads and/or on a particular configuration of the work cell coupled thereto. The cart platform (36) may have a single CBOP that is strategically designed to couple to any work cell (400) or a connecting module (800) disclosed herein; while a particular work cell or connecting module may have the same CBOP as the CBOP of the cart platform (36), or have a different CBOP that may have a reduced number of the matching openings. Exemplary non-limiting embodiments of the cart platform CBOP (500) and (900) are depicted on FIG. 32 and FIG. 33. The apertures/openings may be considered matching when they could be superimposed, and a fastener may be inserted through. It should be noted that the number of depicted apertures, arrangement pattern, nominal diameters, threads, as well as dimensions related to relative positions of the apertures of the platform (36), are exemplary and non-limiting embodiments of CBOPs of the cart platform (36). Other CBOPs of the cart platform (36) will suffice and included in the scope of the current disclosure.

In some embodiments, wherein a work cell (400) may be included in the transportation system (100), the work cell (400) may directly or indirectly (e.g., through a single or multiple interconnecting features) be secured to the cart platform (36) through the matching openings. Although, other cart-to-work cell coupling mechanisms and locking features can and will suffice and are intended to be within the scope of this disclosure.

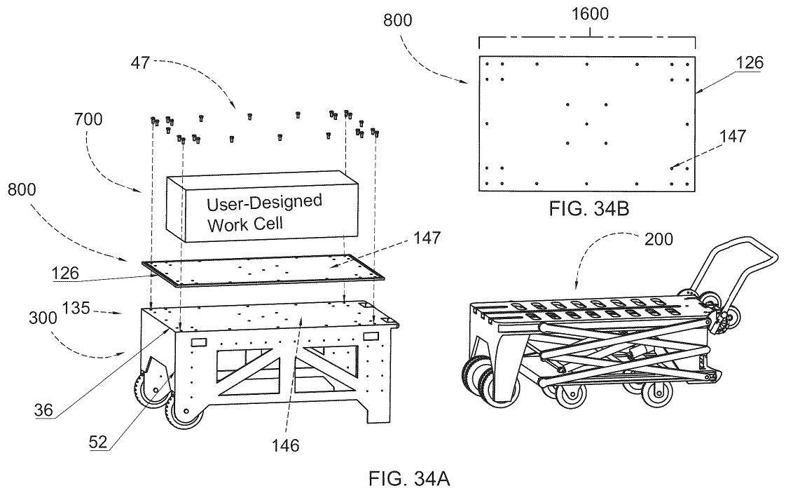

As shown on FIGS. 34A-B, in some embodiments, the transportation system may include a connecting module (CM) (800), wherein the connecting module includes a plate (126) configured to detachably mount to the cart body (135), for instance, to the cart platform (36). The plate may have a plurality of apertures extending therethrough between its top and bottom surfaces, herein referred to as second plurality of apertures. Exemplary, non-limiting embodiment of the second plurality of apertures (147) is shown on FIGS. 34A-B. The apertures may be threaded. The plate (126) may be configured to detachably mount to the cart body, for instance to the cart platform; for example, by fasteners inserted though matching apertures of the second and the first pluralities.

The second plurality of apertures may include a plurality of openings arranged in a pattern/array, that may be threaded. In some embodiments, the second plurality of apertures may include strategically located openings that may be threaded, wherein the openings may be arranged in one of the connecting bolt opening patterns (CBOPs), wherein the openings may be used to secure the connecting module (800) to the cart platform (36). The connecting module (800) may have CBOP that may be identical to a CBOP of the cart platform (36) or may have a reduced number of openings. An exemplary non-limiting embodiment of the connecting module CBOP (1600) is disclosed herein and shown on FIG. 34. The plate (126) may be configured to detachably connect to the cart platform (36). Though, cart platform may be used to directly mount materials, equipment, and tools thereto; due to potentially heavy loads involved (up to 1,000 lbs.), the connecting module may be necessary; so that the user-built structures/work cells (700) may be mounted to the connecting module, and the connecting module then be mounted to the cart platform. The connecting module may serve as a coupling and interfacing device between the cart and the user-built work cell. In some embodiments at least a single aperture of the second and the first pluralities may be matching. The apertures of the first and second pluralities may be matching when they could be superimposed, and a fastener may be inserted through. In some non-limiting embodiments, the COBPs of both, the cart platform (36) and the plate (126), may include CBOP (500) or (900), shown on FIGS. 32-33.

In some embodiments, the connecting module may include at a plurality of handles (not shown) mounted to the lateral sides of the plate, that may enable two or more people to manually lift the connecting module, that may have the custom-built or user-built work cell coupled thereto, by conveniently gripping by the handles from opposing lateral sides of the plate.

In some embodiments, wherein the system (100) comprising a transportation module (200), a cart (300) and a connecting module (800), methods for loading the system to an elevated surface; for example, and without a limitation, to a vehicle, would include the steps of the aforementioned methods for loading the transportation system (100) including a transportation module (200) and a cart (300) to elevated surface; and may further include a steps of providing the connecting module (800), wherein the connecting module may include a plate (126) configured to detachably mount to the cart body (135); and mounting the connecting module (800) to the cart body (135).

The step of mounting the connecting module (800) to the cart body (135) may include mounting the plate (126) the cart body (135); or mounting the plate (126) to the cart platform (36) though matching apertures of the second and the first pluralities.

According to some embodiments, the transportation system may include interchangeable task-specific modules, herein referred to as work cells (400), that allow further customize the system for particular hauling and performance needs. The work cells may be pre-configured for a specific task or be made-to-order according to user requests, and may be detachably connected to the cart; for example, by a coupling mechanism, herein referred to as a cart-to-work cell coupling mechanism, that may include, for example, and without limitation, bolts, straps, pins, groves, apertures, adhering elements, welding, hook-and-loop, tape, magnets or any combination thereof. A cart may host a single work cell at a time; however, once one work cell is disconnected from the cart, it may be replaced by another work cell; so that a user may customize the system by choosing between task-specific work cells according to imminent needs. A materials transport work cell, a workstation work cell, a heavy construction tools work cell, and a custom toolbox work cell are the task-specific work cells disclosed herein and the following details attributed to “a/the work cell” may be applicable to all, some, or one of them.

As shown on FIG. 35A, in some embodiments, the work cell (400) may include a plate member (46), wherein other components that are specific to the particular work cell may be connected to fixedly or detachably. The plate member (46) defines a longitudinal axis X2 (shown on FIG. 35B) and comprising a first end (142), an opposite second end (143), and a first lateral side (144) and an opposite second lateral side (145), wherein the plate member has a top surface (140), a bottom surface (141), and a width defined by the first and second lateral sides (144) and (145). The plate member (46) extends longitudinally between the first and second ends (142) and (143); and a perimeter defined by the first and second ends and the first and second lateral sides. The plate member (46) may be configured to detachable couple to the cart body (135).

The plate member (46) may be configured to detachable couple to the cart body (135); for example, and without limitation, to the cart platform (36). The shapes of the plate member (46), as well as the shape of the cart platform (36) are not limiting; for example, and without limitation, may be table-shaped, box-shaped, plate-shaped, rectangular, square, trapezoidal, or oval.

The plate member (46) may be configured to detachably couple to the cart platform (36) by the cart-to-work cell coupling mechanism. For example, and without limitation, the cart-to-work cell coupling mechanism may include bolting, latching, tongue and grooves, pinning, or adhering, straps, fasteners, screws, mechanical linkages, Velcro-type fasteners.

In some embodiments, the cart-to-work cell coupling mechanism may include the plate member (46) including a plurality of apertures extending therethrough, referred herein as a third plurality of apertures (148), wherein the openings may be threaded. The plate member (46) may be mounted to the cart platform (36); for example, by fasteners inserted though matching apertures of the third plurality (148) and the first plurality of the cart platform (36). Exemplary, non-limiting embodiments of first plurality of apertures (41) and (146) are shown on FIGS. 25A-H and FIGS. 32-33, respectively. The third plurality of apertures (148) may include a plurality of openings arranged in a pattern/array, that may be threaded. In some embodiments, the third plurality of apertures (148) may include strategically located openings that may be threaded, wherein the openings may be arranged in one of the connecting bolt opening patterns (CBOPs), wherein the openings may be used to secure the work cell (400) to the cart platform (36). The work cell (400) may have an identical CBOP to that of the cart platform (36) or have a different CBOP that may have a reduced number of the matching openings, depending on the load distribution requirements for a particular work cell configuration. For example, and without limitation, one of the work cells (400) may preferably be fastened to the cart (300) along a perimeter of cart platform (36), while another work cell (400) may preferably be fastened through the center and the corners of the cart platform (36), and so on; so that the work cell plate member (46) may use only some of the openings of the cart platform's CBOP for coupling, while other may other openings may be left unused. Exemplary, non-limiting, embodiments of CBOPs that may be advantageous for various work cells are disclosed herein and shown on FIGS. 35B-35F.

In some embodiments at least a single aperture of the third and the first pluralities, may be matching; so that the work cell (400) may be connected to the cart platform (36) through matching apertures of the third and the first pluralities; for instance, by fasteners. The apertures may be matching when they could be superimposed, and a fastener may be inserted through. It should be noted, that the shown first plurality of apertures (41) and (146), as well as the shown third plurality (148) are exemplary and non-limiting; and other arrangements will suffice and included in the scope of the current disclosure.

FIG. 35A shows a diagram illustrating an exemplary embodiment of the system (100), and FIG. 35B shows a bottom view of a work cell (400). The work cell (400) may include any one of the following: materials transport work cell (600), workstation work cell (1000), heavy construction tools work cell (1700), custom toolbox work cell (1800) that are disclosed herein, or made-to-order custom task-specific work cell including the plate member (46).

As shown, in some embodiments, the cart (300) may couple to the work cell (400) by the cart-to-work cell coupling mechanism that may include the cart platform (36) having the first plurality of apertures (146) arranged in COBP (500), and the plate member (46) having the third plurality of apertures (148), arranged, for instance, in a COBP (1100) that may be identical CBOP (500) of the cart platform (36), and wherein all apertures of the first and the third pluralities may be matching, as shown on FIGS. 35A-35B; so that the work cell (400) may couple to the cart (300) through the matching apertures of the first plurality (146) and the third plurality (148), for instance by fasteners, such as bolts (47).

FIGS. 35B-35F show diagrams of exemplary, non-limiting, bottom views of the work cell (400), according to some embodiments. For example, and without limitation, the workstation work cell (1000) may advantageously to be coupled to the cart platform (36) along its perimeter, and the plate member (46) of the workstation work cell (1000) may have CBOP (1300) depicted on FIG. 35D. While, for example, and without limitation, the materials transport work cell (600) may advantageously be coupled to a center part and corners of the cart platform (36), and the plate member (46) of the materials transport work cell may have CBOPs (1100) and (1200) depicted on FIGS. 35B-35C. For example, and without limitation, the heavy construction tools work cell (1700) and the custom toolbox work cell (1800) may advantageously be coupled to the cart platform (36) at the center part and ends; thus, the plate members (46) of the heavy construction tools work cell (1700) and the custom toolbox work cell (1800) may have CBOPs (1400) and (1500) depicted on FIGS. 35E-35F. As shown, the CBOPs (1200), (1300), (1400) and (1500), that may be advantageous for the particular work cell coupling, may not have a CBOP that is identical to the CBOP (500) of the cart platform (36); so that and the CBOPs (1200), (1300), (1400) and (1500) may utilize only some of the apertures of CBOP (500), only matching ones, for coupling; while the CBOP (500) of the cart platform (36) may accommodate any of CBOPs (1100), (1200), (1300), (1400) and (1500), and thus, may be universal. However, it shall be noted that the CBOPs depicted on FIGS. 35B-F are only exemplary and non-limiting, and further shall not be viewed as limited to the plate member (46) of the particular work cell. The depicted CBOP (500) of the car platform (36), is likewise, exemplary, and non-limiting. Other CBOPs of the first and the third pluralities, that each may vary in number, location and arrangement of the matching apertures can and will suffice and included in the scope of the current disclosure. In some non-limiting embodiments, the COBPs of both, the cart platform (36) and the plate member (46), may include CBOP (500) or (900), shown on FIGS. 32-33. FIG. 35G shows perspective view of another exemplary embodiment of the invention, wherein a transportation system includes a transportation module, a cart, and a work cell (shown schematically), and wherein the work cell includes a work cell frame and a table.

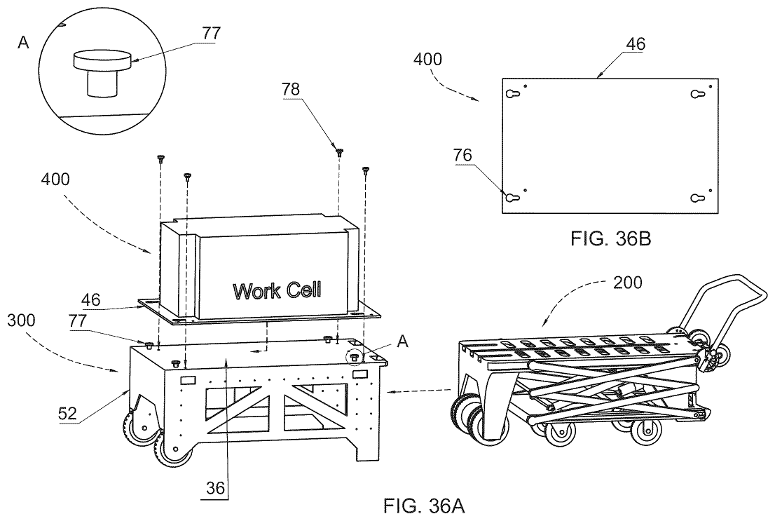

In some other embodiments, for example, as shown on FIGS. 36A-B, the cart-to-work cell coupling mechanism may rely on the cart platform (36) having pins/pegs or rails protruding upwardly from its top surface, and the work cell plate member (46) having grooves, slots or tracks wherein the pins/pegs or rails may be configured to slide into the groves, slots or tracks, and may further be locked in position. The pegs/pins may be locked in position, for instance, by a latch, such as spring latch. As shown on FIGS. 36A-B, the cart platform (36), may have a plurality of mating pegs (77) that may be configured to couple to mating slots (76) of the plate member (46), and may be locked in position within the slots.

In some embodiments, least one, but preferably at least four, pegs (77), may be included, wherein the pegs (77) may be thinner wherein they are connected to the cart platform (36), and thicken as they are protruding upwardly. The slots (76) may have portions of varying width; so that the pegs (77) may be inserted to the slots (76) at their wider portion, and then slide in and lock in position within narrower portion. This design of the pegs (77) and slots (76) prevents plate member (46) of the work cell from disengaging from the cart platform (36); and allows to couple the cart (300) to the work cell (400) without tools. Moreover, the plurality of thumbscrew (78) may be used to further secure that platform member (46) in place.

Alternatively, the cart-to-work cell coupling mechanism may include the cart platform (36) having grooves, slots or tracks, and the work cell plate member (46) having pins/pegs or rails protruding from its bottom surface, wherein the pins/pegs or rails may be configured to slide into the groves, slots or tracks, and may further be locked in position.

Although, other cart-to-work cell coupling mechanisms can and will suffice and are intended to be within the scope of this disclosure. In some embodiments, the work cell (400) may be configured to couple to the cart base (52).

In some embodiments, the work cell (400) may include a table, configured to fixedly or detachably mount to the plate member (46). In some embodiments, the work cell may include a work cell frame (64), that may be configured to connect to the plate member (46); for instance, to the top surface (140) of the plate member (46). The table may be mounted atop of the work cell frame. The work cell frame may include at least one storage compartment, such as at least one drawer, but not limited thereto. The table and/or the work cell frame may include at least one extendable platform, that may provide additional working area. In some embodiments, the drawer(s) may be removable to provide access to the plate member (46) for coupling to the cart platform (36).

In some embodiments, the work cell (400) may include lifting means operable to adjust the height of the table relative to a supporting surface, such as ground; and that would allow to adjust the height of the table (63) according to preferences of the user. The lifting means may be manual or powered; and may be positioned between the work cell frame (64) and the table (63); or alternatively, between the plate member (46) and the work cell frame (64). The lifting means may include jacks, cranks, leadscrews, but not limited thereto.

In some embodiments, the plate member (46) may be omitted, and the work cell (400) may be mounted atop the cart platform (36) by the work cell frame (64).

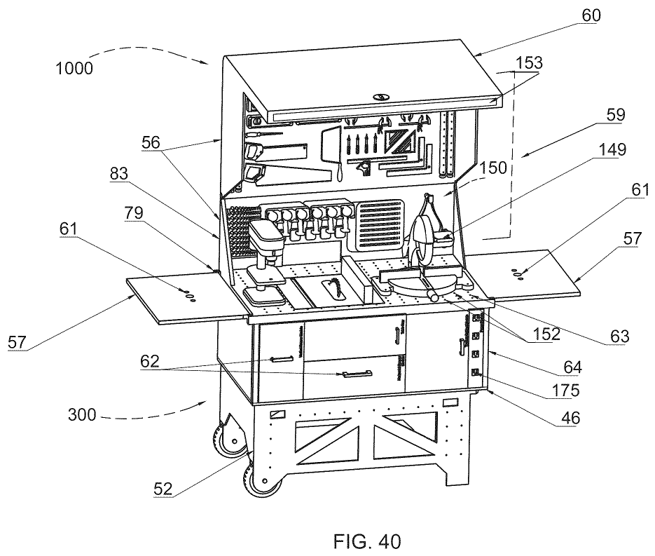

The exemplary embodiments of the table (63), the work cell frame (64) and the extendable platform (57) are depicted on FIG. 40, that shows an exemplary embodiment of the system (100) including the workstation work cell (1000), however, any other work cell (400) disclosed herein may include similar structures.

In some embodiments the work cell (400) may include a hood. The hood may be configured to enclose at least a part of the work cell (400). For example, and without limitation, the hood may be connected to a work cell frame, such as the work cell frame (64); a table, such as table (63); or the plate member (46). For example, and without limitation, wherein the hood may be mounted to the plate member (46), the hood may encase at least one element that may be mounted to the plate member (46); while wherein the hood may be mounted to the work cell frame, the hood may incase at least one element that may be mounted to the work cell frame; and wherein the hood may be mounted to the table, the hood may incase at least one elements that may be mounted to the table. Alternatively, the hood may be connected to the cart body (135), so that it may be operable to enclose totality of any work cell (400) coupled thereto; and wherein the work cells (400) may be interchangeable. The hood may include a lock to restrict access to the enclosed elements and contents. Some exemplary hood configurations that may be advantageous for a particular work cell are disclosed herein and referred to as a workstation hood (56), heavy construction hood (65), and a custom toolbox hood (161). However, the aforementioned hood designations do not necessarily limit a particular hood configuration to the designated work cell. For example, and without limitation, the heavy construction hood (65) configuration may be used with the custom toolbox work cell (1800), the materials transport work cell (600), or the workstation work cell (1000); the workstation hood (56) configuration may be used with the heavy construction tools work cell (1700) or custom toolbox work cell (1800). Therefore, wherein a particular work cell is claimed to comprising “a hood”, all disclosed hoods configurations are intended to be included in the claim scope, unless explicitly stated otherwise. In some embodiments, the work cell (400) and/or the cart (300) may not include the hood.

In some embodiments, the work cell (400) may include at a plurality of handles mounted to the lateral sides of the plate member (46), that may enable two or more people to manually lift the work cell by gripping by the handles from opposing lateral sides.

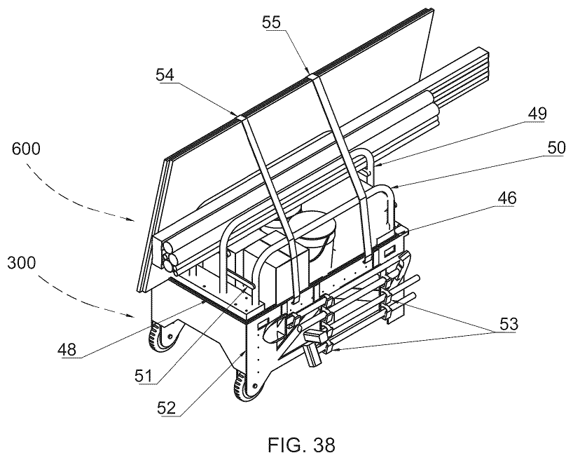

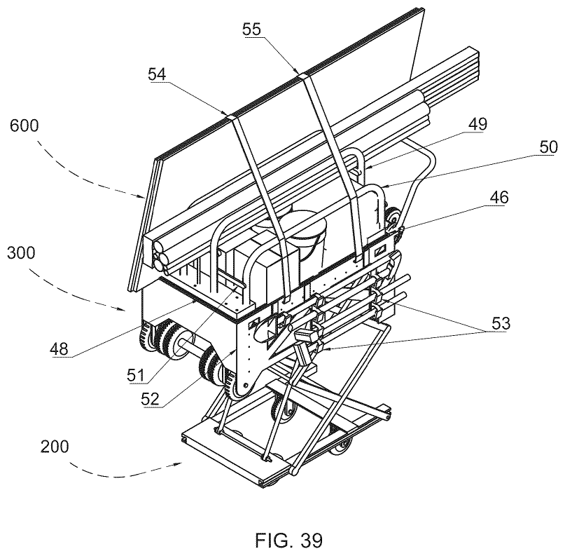

The work cell (400) may include a tool carrier that may be mounted to the plate member (46). The tool carrier may be fixedly or detachably mounted to the plate member (46). The toll carrier may include tool mounting means, that may include hooks, fasteners, Velcro-type fasteners, clamps, magnets, but not limited thereto. An exemplary configuration of the tool carrier (53) is shown mounted to the plate member (46) with reference to the materials transport work cell (600) and shown on FIGS. 38-39. However, the depicted configuration of the tool carrier (53) is not limited to the materials transport work cell (600), and the tool carrier (53) may be used in accord with any work cell (400) disclosed herein. In some embodiments, the tool carrier (53) may comprise at least two spaced apart holders; wherein the holders may include tool mounting means, that may attached thereto or be integrally monolithic with the holders. The tool carrier may be conveniently used for transporting and organizing tools and equipment, such as shovels, bars, brooms, vacuum cleaners, axes, crowbars, pry bars, but not limited thereto. The tool carrier may be alternatively mounted to the work cell frame (64) or table (63). In some embodiments there may be at least one additional tool carrier that may be attached to the work cell frame and/or the table. In some embodiments, the tool carrier (53) may be mounted to the cart body (135) or the frame member (122) of the transportation module. The shown exemplary configuration of the tool carrier (53) is non-limiting, and tool carriers having alternative configurations will suffice and included in the scope of the current disclosure.

In some embodiments, the work cell (400) may include at least one lighting feature, that may include a light-reflective feature, allowing a user to use the work cell (400) and the system (100) in low-light conditions. The lighting feature may be mounted, for example, and without limitation, to the hood, and/or the plate member (46). For example, and without limitation, the lighting features may include a headlight, plate member-imbedded lights, light panel, chemiluminescent element, light emitting diodes, incandescent light fixtures, or any combination thereof.

In some alternative embodiments a work cell (400) may not include the plate member (46) and its features and structures may be directly, fixedly or detachably, connected to the cart (300); for example, to the cat platform (36), but not limited to thereto. Alternatively, the work cell features/structures may be connected to the cart (300) through an additional interconnecting assembly; that may have a frame-like structure or include several supporting elements, that that may be fixedly or detachably connected to the cart platform (36) or cart base (52), and wherein the work cell features/structures may be mounted to the interconnecting assembly. The interconnecting assembly may include the work cell frame (64). For example, in some embodiments, wherein the plate member (46) may be lacking, the work cell frame (64) may be mounted atop of the cart platform (36), and the hood may be connected to the work cell frame (64). The supporting elements may include beds, bridges, but not limited thereto. In some embodiments, the work cell frame (64), or the table (63) may be further omitted and the hood, when included, and some of remaining work cell elements may be configured to be detachably mounted to the platform member (1) of the transportation module or the cart platform (36).

The user-designed work cell (700) may be coupled to the cart (300) through the connecting module (800), for instance, as aforementioned.

In some embodiments the work cell (400) may include means for charging cellular phones, tablets, laptops and other portable electronic devices, such as USB hubs, charging pads.

According to some embodiments, a method provided for loading a transportation system (100) to an elevated surface; for example, and without limitation, to a vehicle, wherein the method may include: providing the system (100) comprising a transportation module (200), a cart (300), and a work cell (400); wherein the transportation module may include: a frame member (122) defining a longitudinal axis and having a front (123) and a rear (124) opposing ends, wherein the front end comprising an overhang member (15) having an overhang portion (2) protruding downwardly below frame member (122); the overhang portion having at least one approach wheel (32); a base member (15) comprising a plurality of ground wheels (16), the wheels configured for engaging and rolling over a supporting surface; a lifting assembly connected between the base member (15) and the frame member (122); the lifting assembly configured to lift and lower the frame member relative to the base member; a leg member (127) comprising a leg body (19) and at least one loading wheel (20); the leg body having a first end (129) and a second end (130); the first end mounted to the frame member (122); and the loading wheel (20) mounted to the second end (130); leg immobilizing means configured to secure said leg member (127) in substantially vertical position; and wherein the frame member (122) further comprising leg-receiving means, wherein the leg member (127) is operable to extend from and retract to the receiving means. The cart (300) may include: a cart body (135) and at least one front wheel (40); the cart body having a front (136) and a rear (137) opposing sections; the front wheel (40) mounted to the front section of the cart body; the cart body (135) configured to detachably couple to the frame member (122) of the transportation module (200). The work cell (400) may include a plate member (46), the plate member comprising a first end (142), an opposite second end (143), and a first lateral side (144) and an opposite second lateral side (145), wherein the plate member (46) having a top surface (140), a bottom surface (141), and a width defined by the first and the second lateral sides, the plate member (46) extending longitudinally between the first and second ends; and a perimeter defined by the first and second ends and the first and second lateral sides, wherein the plate member (46) configured to detachably couple to the cart body (135). Then coupling the plate member (46) of the work cell (400) to the cart body (135) of the cart (300); coupling the cart body (135) of the cart (300) to the frame member (122) of the transportation module (200); advancing the system (100) along a supporting surface toward an elevated surface edge via the plurality of ground wheels (16) of the base member (15); lifting the frame member (122) relative to the base member (15) via the lifting assembly, so that the front wheel (40) is elevated to a height exceeding a height of the elevated surface; advancing the system (100) via said plurality of ground wheels (16) until the base member (15) is adjacent to an edge of the elevated surface and the front wheel (40) is positioned above the elevated surface; extending the leg member (127) from said leg receiving means; so that the leg body (19) has achieved substantially vertical position relative to the supporting surface; securing the leg member (127) in a position substantially vertical to the supporting surface by said leg immobilizing means; lowering the frame member (122) relative to the base member (15) via said lift assembly until said front wheel (40) engages the elevated surface; lifting the base member (15) relative to the frame member (122) via the lifting assembly, so that the ground wheels (16) have substantially aligned with the elevated surface; advancing the system (100) via the front wheel (40) and the loading wheel (20) until the ground wheels (16) engaged the elevated surface; releasing the leg member (127) from the leg immobilizing means; retracting the leg member (127) to the leg receiving means.

It should be noted that according to the aforementioned method, the work cell (400) may include any one of the work cells disclosed herein having the plate member (46), such as materials transport work cell (600), workstation work cell (1000), heavy construction tools work cell (1700), custom toolbox work cell (1800) or a built-to-order work cell having the plate member (46). And the step of coupling the plate member (46) of the work cell (400) to the cart body (135) of the cart (300), may include coupling the plate member (46) of any one of the aforementioned work cells to the cart body (135).

In some embodiments, the method may include a step of adjusting the length of the leg body (19), wherein the leg member of the transportation module is length-adjustable. So that the length of the leg member may correlate with the height of the elevated surface; and the loading wheel of the leg member may engage the supporting surface.

Moreover, the transportation module may include any aforementioned leg receiving means and leg immobilizing means. Thus, the steps of extending said leg member from said leg receiving means, and retracting said leg member to said leg receiving means; as well as the steps of securing said leg member in a position substantially vertical to the supporting surface by said leg immobilizing means, and releasing said leg member from said leg immobilizing means; may further include particular elements and steps, that may depend on a particular leg receiving means and leg immobilizing means involved.

It should be noted that, although the methods, describe the process of loading the transportation system to an elevated surface, the process of unloading the system from that surface will easily become apparent to the ordinary skilled in the art, having the benefit of the current disclosure, and intended to be included in the scope of the current disclosure. Moreover, the steps of the methods may be reversed and/or performed in order other than aforementioned, and/or be omitted.

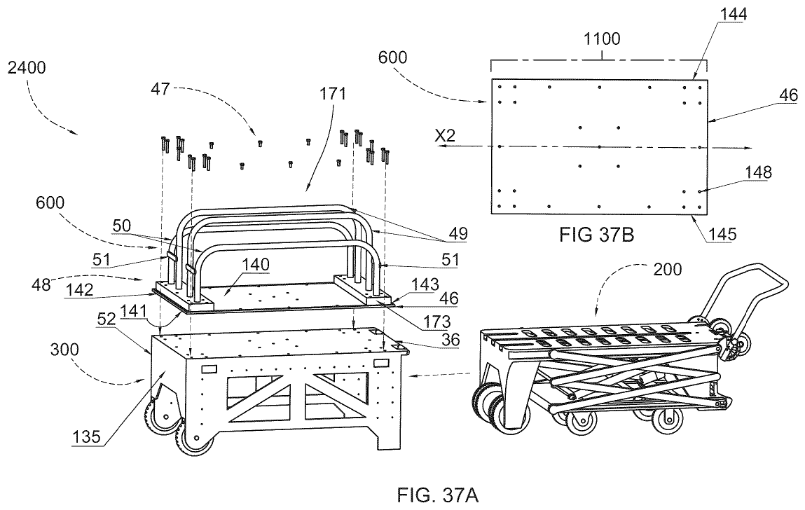

As shown on FIGS. 37A-B and FIGS. 38-39, according to some embodiments, the transportation system (100) may include a materials transport work cell (600), wherein the system referred herein as a materials transportation system (2400). The material transportation system (2400) may include the transportation module (200), the cart (300), and the materials transport work cell (600).

As best shown on FIG. 3A and FIGS. 37A-B, the transportation module (200) may include a frame member (122) defining a longitudinal axis X1 and having a front (123) and a rear (124) opposing ends, wherein the front end includes an overhang member (125) having an overhang portion (2) protruding downwardly below the frame member (122), the overhang portion having at least one approach wheel (32); a base member (15) comprising a plurality of ground wheels (16), the wheels configured for engaging and rolling over a supporting surface; a lifting assembly connected between the base member (15) and the frame member (122), the lifting assembly configured to lift and lower the frame member (122) relative to the base member (15); and a leg member (127), having a leg body (19) and at least one loading wheel (20), the leg body having a first end (129) and a second end (130), the first end connected to the frame member (122); and the loading wheel (20) connected to the second end.

As best shown on FIGS. 25A-H and FIG. 37A, the cart (300) may include a cart body (135); and at least one front wheel (40); the cart body having a front (136) and a rear (137) opposing sections, the front wheel (40) mounted to the front section of the cart body; wherein the cart body (135) may be configured to detachably couple to the frame member (122) of the transportation module (200).

As best shown on FIGS. 37A-B and FIGS. 35A-G, the materials transport work cell (600) may include a plate member (46) that defines a longitudinal axis X2, and comprising a first end (142), an opposite second end (143), a first lateral side (144) and an opposite second lateral side (145), wherein the plate member (46) may have a top surface (140), a bottom surface (141), and a width defined by the first and second lateral sides; the plate member extends longitudinally between the first and second ends; and a perimeter defined by the first and second ends and the first and second lateral sides, and wherein the plate member (46) may be configured to detachably couple to the cart body (136). The materials transport work cell (600) may include a plurality of rails (171).

The plurality of rails (171) may be fixedly or detachably mounted to the top surface (140) of the plate member (46); so that the user may customize the load supporting surface based on the immediate transporting needs; for instance, from substantially flat to having different combinations of upright rails. The plurality of rails may include at least two rails that may be configured as discrete elements and/or at least two rails that may be interconnected to form a rails assembly. The plurality of rails may be mounted to the plate member (46), for instance, by a flange, bolts, magnets, screws, or pins. For example, and without limitation, the plurality of rails may be positioned on the plate member (46) longitudinally or transversely relative to the longitudinal axis X2 of the plate member (46). Although, other arrangements of rails of the plurality (171) may and will suffice and included in the scope of the current disclosure.

For example, and without limitation, the plurality of rails (171) may include rails that may substantially U-shaped rails, wherein each rail may have a first end, first curved portion, substantially straight and horizontal portion, second curved portion and a second end; wherein the first and second ends of each rail may individually be affixed to the plate member (46) or a supporting structure. In some embodiments, the U-shaped rails may lack the substantially straight and horizontal portion in the middle. The rails may be alternatively shaped; for example, and without limitation, the rails may be shaped substantially as one or more of the following: straight upright posts, T-shaped, square-shaped, rectangular-shaped, or trapezoid. The shapes of rails of the plurality are not limiting, and other shapes may suffice and included in the scope of this disclosure. The rails may additionally include some means for additional elements for securing transported materials; for instance, straps, locks, Velcro-type fasteners, but not limited thereto. In some embodiments, the rails of the plurality (171) may be may further be configured to be disassembled to multiple shorter discrete sections.

In some embodiments, the plurality of rails (171) may be directly mounted to the plate member (46). In some alternative embodiments, the plurality of rails (171) may be mounted to the plate member (46), through at least one interconnecting structure, for example, and without limitation, such as a rail bed assembly (48), as shown on FIG. 37A. The rail bed assembly (48) may be fixedly or detachably mounted to the top surface (140) of the plate member (46), and the plurality of rails (171) may be mounted atop of the rails bed assembly (48). The plurality of rails (171) may be mounted to the plate member (46) or the rail bed assembly (48), for instance, by bolts, screws, pins, adhering means, welding, magnetic flanges, but not limited thereto.

In some embodiments, the rail bed assembly (48) may include a single continuous or interconnected structure mounted along the perimeter of the plate member (46). Alternatively, the rail bed assembly (48) may include several discrete rail beds mounted along the first and the second ends (142) and (143), and/or along the first and the second lateral sides (144) and (145) of the plate member (46).

As shown on FIG. 37A, in some embodiments, the rail bed assembly (48) may include a pair of rail beds (173) mounted along the first and the second ends (142) and (143) of the plate member (46), and the plurality of rails (171) may include medial rails (49) and lateral rails (50) mounted atop to the rail beds (173).

The rail bed assembly (48) may include, for example, and without limitation, metal, metal alloy, polymer, polymer composite, or any combination thereof. In some embodiments, the rail bed assembly (48) may include at least one shock-absorbing and/or vibration damping material to enhance user comfort and load safety in transit; wherein materials may include a polyether-based polyurethane material, acrylic-based resin, silicon based resin, thermoplastic polymer, thermoset polymer, polymer composites, polymer nanocomposites, but not limited thereto. The rail bed assembly (48) may include at least one storage assembly (not shown). The storage assembly may include, for example, and without limitation, at least one of the following: a drawer, a container, a basket.

The materials transport work cell (600) may include at least one rails junction (51) that may extend between and be connected to at least two rails of the plurality (171). In some embodiments, at least one of the included rails junctions (51) may be height-adjustable; so that it may be elevated and lowered relative to the plate member (46). In some embodiments, at least one of the included rails junctions (51) may be detachably connected to the rails of the plurality (171), so that it may be disconnected and removed; so that the user may organize the load according to immediate preferences.

In some embodiments, the plurality of rails (171) may include a plurality of rails junction connectors, that allow the rails junctions (51) be relocated, lowered, elevated, and/or removed at will; wherein the connecting elements may include, for example, openings, pins, loops, hooks, clasps, but not limited thereto.

The plate member (46) of the materials transport work cell (600) may be configured to detachably couple to the cart body (135); for example, and without limitation, to the cart platform (36).

The plate member (46) of the materials transport work cell (600) may be configured to detachably couple to the cart platform (36) by the cart-to-work cell coupling mechanism. For example, and without limitation, the cart-to-work cell coupling mechanism may include bolting, latching, tongue and grooves, pinning, or adhering, straps, fasteners, screws, mechanical linkages, Velcro-type fasteners. In some embodiments, the cart-to-work cell coupling mechanism may include the plate member (46) of the materials transport work cell (600) including the third plurality of apertures (148) extending there through; so that the materials transport work cell (600) may be connected to the cart platform (36) through matching apertures the third and the first pluralities, (148) and (146); for instance, by fasteners. The third plurality of apertures (148) may include a plurality of openings arranged in a pattern/array, that may be threaded. In some embodiments, the third plurality of apertures may include strategically located openings that may be threaded, wherein the openings may be arranged in one of the connecting bolt opening patterns (CBOPs), wherein the openings may be used to secure the materials transport work cell (600) to the cart platform (36). Exemplary embodiments of CBOPs that may be advantageous for the materials transport work cell (600) are disclosed herein and shown as CBOPs (1100) and (1200) on FIGS. 35B-35C. The fasteners may include bolts (47), but not limited thereto. In some embodiments other cart-to-work cell coupling mechanisms may be used, as aforementioned.

In some embodiments, the plate member (46) may include at least one extendable platform, that may be foldable and may be pivotally/hingedly connected to the plate member (46) or be retractable from the plate member (46); and that may provide an additional working area. In some embodiments, the extendable platform may be configured as the extendable platform (57).

In some embodiments, the materials transport work cell (600) may include a table (63), configured to fixedly or detachably mount to the plate member (46). In some embodiments, the materials transport work cell (600) may include a work cell frame (64), that may be configured to connect to the plate member (46); for instance, to the top surface (140) of the plate member (46) and the table (63) may be mounted atop of the work cell frame. The work cell frame (64) may be configured to bring the top surface of the table (63) up to the level of a standing desk/table, making it more comfortable for the user to interact with, and providing extra space to host drawers, storage, or power tools.

The exemplary embodiments of the table (63), the work cell frame (64) and the extendable platform (57) are depicted on FIG. 40, that shows an exemplary embodiment of the system (100) including the workstation work cell (1000), however, any other work cell (400) disclosed herein, including the materials transport work cell (600), may include similar structures.

In some embodiments, the table (63) may be mounted atop of the work cell frame (64). The work cell frame (64) may include at least one storage compartment, such as a drawer (62). In some embodiments, the materials transport work cell (600) may include lifting means operable to adjust the high of the table (63) relative to a supporting surface, such as ground. The lifting means may be manual or powered; and may be positioned between the work cell frame (64) and the table (63); or alternatively, between the plate member (46) and the work cell frame (64). The lifting means may include jacks, cranks, leadscrews, but not limited thereto.

The plurality of rails (171) may be mounted to the table (63) directly, or through other intermediate/interconnecting structure(s). In some embodiments, the plurality of rails (171) may be mounted to the rail bed assembly (48), that may be mounted to the table (63).

The table (63) and/or the work cell frame (64) may include at least one extendable platform (57), that may provide additional working area. The extendable platform (57) may contain mounting hardware, single or multiple mounting holes, mechanical connectors for power tools, but not limited thereto. For example, and without limitation, the extensible platforms (57) may include mounting hole(s) for mounting a table router, that may allow a routing bit to be leveled with the extendable platform. The extendable platform (57) may be pivotally mounted to the table and may be foldable. At least one storage compartment, such as drawers (62) may be located within the work cell frame (64) and may include a compartment sized to store detached rails of the plurality (171).

As shown on FIGS. 38-39, the materials transport work cell (600) may include at least one of load securing means that may be, fixedly or detachably, connected to the plate member (46), and may include at a strap, a brace, a mechanical linkage, a net, but not limited thereto. The load securing means may be operable to safeguard integrity of the load and contribute to user safety. The load securing means may be configured to extend between the first and the second end and/or between the lateral sides of the plate member (46). For example, and without limitation, the load securing means may include at least two straps (54) and (55), that may be connected to the plate member (46); wherein the straps may be extendable between the first (144) and the second (145) lateral sides of the plate member (46); and, moreover, may be retractable into the plate member (46) when not in use, or detachable. The depicted location of straps (54) and (55) is exemplary and non-limiting. In some embodiments, the plate member (46) may include at least two load securing means, wherein at least one extends longitudinally, and at least one another extends transversally. In some embodiments, at least one strap may be connected to the cart body (135). For example, and without limitation, straps (54) and (55) may be alternatively connected to the cart body (135).

The materials transport work cell (600) may include a tool carrier. As shown on FIGS. 38-39, the materials transport work cell (600) may include a tool carrier (53) that may be mounted to the plate member (46). The tool carrier (53) may be fixedly or detachably mounted to the plate member (46). The tool carrier may include tool mounting means, that may include hooks, fasteners, Velcro-type fasteners, clamps, magnets, but not limited thereto. Shown configuration of the tool carrier (53) is not limiting. In some embodiments, the tool carrier (53) may comprise at least two spaced apart holders; wherein the holders may include tool mounting means, that may be attached thereto or be integrally monolithic with the holders. The tool carrier may be conveniently used for transporting and organizing tools and equipment, such as shovels, bars, brooms, vacuum cleaners, axes, crowbars, pry bars, but not limited thereto. In some embodiments, there may be at least one additional tool carrier that may be mounted to the plate member (46). In some embodiments, at least one tool carrier (53) may be alternatively mounted to the workstation frame (64) or the table (63). In some embodiments, there may be at least one additional tool carrier that may be attached to the work cell frame (64) and/or the table (63). In some embodiments, at least one tool carrier (53) may be mounted to the cart body (135), for example, to the cart platform (36). Moreover, tool carrier (53) is not limited to the materials transport work cell (600), and any other work cell, as well as the cart (300) and/or the transportation module (200), that are disclosed herein may have a tool carrier, for example the tool carrier (53).

In some embodiments, the materials work cell (600) may include at least one rails storage compartment (not shown) that may be configured to store the rails of the plurality (171), such as detached rails, detached and disassembled rails and/or additional rails. For example, and without limitation, the rails storage compartment may be located within the work cell frame (64) or included as a part of the rail bed assembly (48). The rail storage compartment may also be mounted to or be an integral part of the plate member (46). In some embodiments the rails storage compartment may be mounted to the cart (300), fixedly or detachably.

In some embodiments, the material transport work cell (600) may include additional compartments that may be fixedly or detachably connected to the plate member (46).

In some implementations, the plate member (46) may additionally include at least one extendable platform for expanding working and supporting surfaces.

In some embodiments, the materials transport work cell (600) may include organizing means that may include, labeling, color-coding or other sorting systems for loads and items.

In some embodiments, the workstation work cell (600) may include at least one lighting feature, that may include light-reflective feature, allowing a user to safely operate the system and use the work cell in low-light conditions. For example, and without limitation, the lighting feature may include a headlight, a light bulb, a linear light bulb, light panel, chemiluminescent element, light emitting diodes, incandescent lights, or any combination thereof. The lighting feature may be mounted, for example, and without limitation, to the plate member (46), the work cell frame (64), or the table (63).

In some embodiments, one or more of the elements, such as the plate member (46), the work cell frame (64), or the table (63) may be omitted and some of the remaining the elements may be configured to be detachably mounted to the platform member (1) of the transportation module (200) or the cart platform (36). For example, in some embodiments, the plurality of rails (171) may be configured to be mounted to the platform member (1) of the transportation module (200) or the cart platform (36), wherein the plurality of rails (171) may be mounted detachably; and the plurality of rails (171) may be mounted directly or through an interconnecting structure, such as the rail bed assembly (48), but not limited thereto; and may be mounted by bolts, screws, adhering means, welding, magnetic flanges, but not limited thereto. In some embodiments, the plate member (46) may be omitted, and the materials transport work cell may be mounted atop the cart platform (36) by the work cell frame (64).

The materials transport work cell (600) may additionally include at least one of the elements that are described herein in reference to the work cell (400). Moreover, it should be noted, the transportation module (200) included in the materials transportation system (2400) may further include any of the elements and their variations disclosed herein for the transportation module (200); and the cart (300) included in the materials transportation system (2400) may include any of the elements and their variations disclosed herein for the cart (300).

The aforementioned methods provided for loading a transportation system (100) to an elevated surface, wherein the methods may include providing the system (100) comprising a transportation module (200), a cart (300), and a work cell (400); as well as exemplary aforementioned modifications of the methods, may be applicable for loading the materials transportation system (2400), wherein the work cell (400) in the methods comprising a material transport work cell (600).

According to some embodiments, the transportation system (100) may include a workstation work cell (1000), wherein the system referred herein as a workstation transportation system (2500). The workstation transportation system (2500) may include the transportation module (200), the cart (300), and the workstation work cell (1000). FIGS. 40-42, show the workstation work cell (1000) coupled to the cart (300), the transportation module (200) is disengaged and not shown.

As best shown on FIG. 3A, the transportation module (200) may include a frame member (122) defining a longitudinal axis X1 and having a front (123) and a rear (124) opposing ends, wherein the front end includes an overhang member (125) having an overhang portion (2) protruding downwardly below the frame member (122), the overhang portion having at least one approach wheel (32); a base member (15) comprising a plurality of ground wheels (16), the wheels configured for engaging and rolling over a supporting surface; a lifting assembly connected between the base member (15) and the frame member (122), the lifting assembly configured to lift and lower the frame member (122) relative to the base member (15); and a leg member (127), having a leg body (19) and at least one loading wheel (20), the leg body having a first end (129) and a second end (130), the first end connected to the frame member (122); and the loading wheel (20) connected to the second end.

As best shown on FIGS. 40-42 and FIGS. 25A-H, the cart (300) may include a cart body (135); and at least one front wheel (40); the cart body having a front (136) and a rear (137) opposing sections, the front wheel (40) mounted to the front section of the cart body; wherein the cart body (135) may be configured to detachably couple to the frame member (122) of the transportation module (200).

As best shown on FIGS. 40-41, and FIGS. 35A-G, the workstation work cell (1000) may include a plate member (46) that defines a longitudinal axis X2, and comprising a first end (142), an opposite second end (143), a first lateral side (144) and an opposite second lateral side (145), wherein the plate member (46) may have a top surface (140), a bottom surface (141), and a width defined by the first and second lateral sides; the plate member extends longitudinally between the first and second ends; and a perimeter defined by the first and second ends and the first and second lateral sides, and wherein the plate member (46) may be configured to detachably couple to the cart body (136). The workstation work cell (1000) may include a table (63).

In some embodiments, the table (63) may be mounted to the plate member (46) fixedly or detachably.

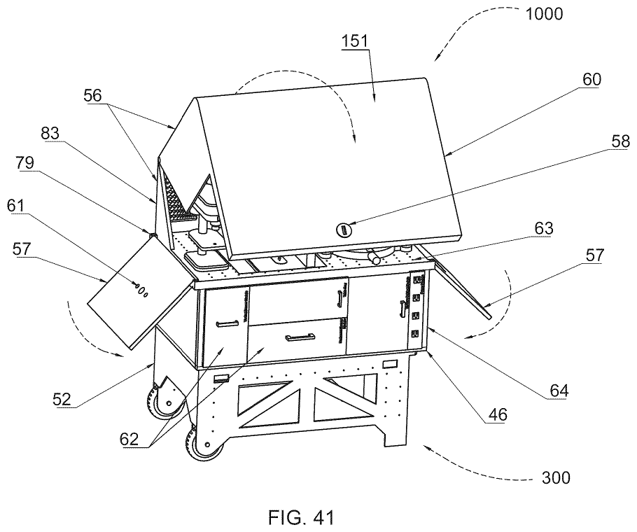

As shown on FIGS. 40-41, in some embodiments, the workstation work cell (1000) may include a work cell frame (64) that may be connected to the plate member (46), for instance, the top surface (140) of the plate member (46); and the table (63) may be mounted atop of the work cell frame (64). The work cell frame (64) may be configured to bring the top surface of the table (63) up to the level of a standing desk/table, making it more comfortable for the user to interact with, and providing extra space to host drawers, storage, or power tools.

The work cell frame (64) may include at least one storage compartment, such as drawers (62). In some embodiments, the workstation work cell (1000) may include lifting means operable to adjust the height of the table (63) relative to a supporting surface, such as ground. The lifting means may be manual or powered; and may be positioned between the work cell frame (64) and the table (63); or alternatively, between the plate member (46) and the work cell frame (64). The lifting means may include jacks, cranks, leadscrews. but not limited thereto.

The plate member (46) may be configured to detachably couple to the cart body (135); for example, and without limitation, to the cart platform (36). The plate member (46) of the workstation work cell (1000) may be configured to detachably couple to the cart platform (36) by the cart-to-work cell coupling mechanism. For example, and without limitation, the cart-to-work cell coupling mechanism may include bolting, latching, tongue and grooves, pinning, or adhering, straps, fasteners, screws, mechanical linkages, Velcro-type fasteners. In some embodiments, the cart-to-work cell coupling mechanism may include the plate member (46) of the workstation work cell (1000) including the third plurality of apertures extending therethrough; so that the workstation work cell (1000) may be connected to the cart platform (36) through matching apertures the third and the first pluralities; for instance, by fasteners. The third plurality of apertures may include a plurality of openings arranged in a pattern/array, which may be threaded. In some embodiments, the third plurality of apertures may include strategically located openings that may be threaded, wherein the openings may be arranged in one of the connecting bolt opening patterns (CBOPs), wherein the openings may be used to secure the workstation work cell to the cart platform (36). Exemplary non-limiting embodiment of CBOP that may be advantageous for the workstation work cell (1000) is disclosed herein and shown as CBOP (1300) on FIG. 35D. In some embodiments, other cart-to-work cell coupling mechanisms may be used, as aforementioned.

As shown on FIGS. 40-42, the workstation work cell (1000) may include a hood, herein referred to as a workstation hood (56), that may be operable to encase at least some part of the workstation work cell (1000). In some embodiments, the workstation hood (56) may be connected to the work cell frame (64), while in some other embodiments, it may be connected to the table (63), or the plate member (46). The workstation hood (56) may include a lock (58) to restrict access to the enclosed elements and contents. The workstation hood configuration conveniently allows users to expand the storage space, to securely store/lock all contents, serve as a cover from the weather elements, as well as providing other benefits disclosed herein.

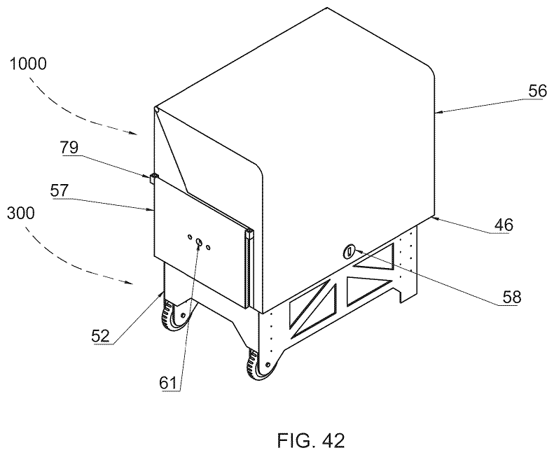

FIG. 42 shows an exemplary embodiment of the workstation work cell (1000) enclosed and locked under the workstation hood (56). However, as aforementioned, configurations of the hoods disclosed herein are not limited to the designated work cell. Hence, any other work cell (200) disclosed herein may be enclosed under the workstation hood (56) in a similar way, as depicted. Moreover, the workstation work cell (1000), and other disclosed work cells (200) may have any of the other hood configurations disclosed herein. For example, and without limitation, the heavy construction hood (65), that will be described in conjunction with the heavy construction tools work cell (1700), may be included with in the workstation work cell (1000) instead of the workstation hood (56); and the workstation hood (56) may be included in the heavy construction tools work cell (1700) instead of the heavy construction hood (65). Thus, wherein any of the disclosed work cells may be claimed comprising a hood, all of the disclosed hood configurations are intended to be included in the claimed scope, unless explicitly stated otherwise.

The workstation hood (56) may include tool storage means configured to safely and conveniently hold tools, such as levels, hand saws, screw guns, nail guns, but not limited thereto. For example, and without limitation, the tools storage means may include specialized compartments (59). The tool storage means may include, for example, and without limitation, designated spaces, holders, hooks, clamps, magnets, containers, drawers, cabinets, racks, and patterns of threaded/unthreaded mounting holes; that may be mounted to an inner surface (150) of the hood (56). The tools storage means may also include at least one small tools container, such as drawer, basket, peg board, that may be configured to store organize small tools, such as drill bits, blades, screwdrivers, nails, screws, but not limited thereto that may be connected to the inner surface of the hood. Alternatively, or additionally the small tools container may be located within the work cell frame (64). The tools storage means may also include at least one fastener connected to the inner surface (150) of the hood (56), wherein the fastener may be operable to store items, such as flat items, elongated items, small tools, but not limited thereto; and may include straps, Velcro-type fasteners, but not limited thereto. The tools storage means may include at least one slot-shaped holder formed within the inner surface (150) of the hood (56). The tools storage means may be included on the outer surface (151) of the hood (56). The tools storage means may be lockable for restricted access. The tools storage means may be fixedly or detachably mounted to the hood (56). In some embodiments, the hood (56) may include reinforcement struts (83). The reinforcement struts (83) are operable to uniformly distribute the structural load of the hood (56) while supporting the hood in elevated/open position. In some embodiments, the hood (56) may be detachable.

The table (63) may include device mounting means that may include elements that be operable to secure tools and devices, such as table saws, routers, drill presses, chop saws, but not limited thereto, to the table (63). For example, and without limitation, device mounting means may include: a plurality of threaded/unthreaded openings (152) that may be formed within the table (63) for securing the tools by fasteners; a clasp that may be connected to the table (63) and operable to secure the tool/device; an orifice within the table that may be operable to receive some portion of the tool/device and secure in within; or any combination thereof.

The table (63) may include at least one extendable platform (57), that may provide additional working area. The extendible platform (57) may include mounting hardware, such as at least one mounting hole (61), mechanical connectors for power tools, but not limited thereto. For example, and without limitation, the mounting hardware may include at least one mounting hole for mounting a table router, that may allow a routing bit to be leveled with the extendable platform. The extendable platform (57) may be pivotally connected to the table (63), for example, by hinges (79); and may be foldable. Alternatively, the extendable platforms (57) may be configured to extend and retract from the table (63). A table saw (149), may be fixedly or detachably mounted to, or built into the table (63); and the work cell frame (64) may have a leveling assembly operable to level the table (63), so that it may assume a substantially horizontal orientation. In some embodiments, the work cell frame (64) may include at least one additional extendable platform. In some embodiments, the extendable platform (57) may be detachable, and may be stored within the workstation work cell (1000) when not in use. The extendable platform (57) may be configured to be used in conjunction with sawhorses.

In some embodiments, the work cell frame (64) may include at least one extendable platform, that may provide additional working area. In some embodiments, the extendable platform may be configured as the extendable platform (57).

In some embodiments, the extendable platform (57) may be extendable from a space or compartment, that may be located under/within the plate member (46), the table (63), or the work cell frame (64).

In some embodiments, the plate member (46) may include at least one extendable platform, that may be foldable and may be pivotally/hingedly connected to the plate member (46) or be retractable from the plate member (46); and that may provide an additional working area. In some embodiments, the extendable platform may be configured as the extendable platform (57).

In some embodiments, the workstation work cell (1000) may include at least one alternative or additional detachable platform-like structure that may be stored within the workstation work cell (1000), for instance, within the work cell frame (64) and/or the hood (56), when not in use; and that may be configured to be supported by the table (63) or the extendable platform (57) on one side, and by sawhorses or other supporting features on another side when installed.

The workstation hood (56) may include a roof (60), that may extend over the table (63) when the hood (56) is open. In some embodiments the roof (60) may include a roof extension (153) that may be connected to the roof (60) and may be operable to extend or unfold from the roof (60). The roof extension (153) may be operable to slide out or unfold from the roof (60) to shield the user from elements, such as sun or rain. The roof (60) and/or roof extension (153) may include additional compartments, curtains, umbrellas, tarps, drawers, holders, straps, that may be detachable. For example, and without limitation, detachable elements of the system (2500) may be stored within a pouch, a compartment, or a drawer, that may be included in the hood (56). In some embodiments, the hood (56) and/or the roof extension (153) may include attachment means, such as hooks, rings, or rails; that may allow to connect curtains, tarps, umbrellas, or straps.

In some embodiments, the roof extension (153) may be configured to cover at least one extendable platform (57), when the extendable platform (57) is in extended position. The roof (60) and/or roof extension (153) may also have connecting elements operable to secure tarps or canopies.

In some embodiments, the workstation work cell (1000) may include at least one lighting feature, that may include light-reflective feature, allowing a user to safely operate the system and use the work cell in low-light conditions. For example, and without limitation, the lighting feature may include a headlight, a light bulb, a linear light bulb, light panel, chemiluminescent element, light emitting diodes, incandescent lights, or any combination thereof. The lighting feature may be mounted, for example, and without limitation, to the hood (56), the plate member (46), the work cell frame (64), or the table (63). The roof (60) and/or roof extension (153) may as well include at least one lighting feature.

The workstation work cell (1000) may include at least one tool carrier (not shown), that may include tool mounting means, that may include hooks, fasteners, Velcro-type fasteners, clamps, magnets, but not limited thereto. The tool carrier may include the tool carrier (53) that is shown on FIGS. 38-39. In some embodiments, the tool carrier may comprise at least two spaced apart holders; wherein the holders may include tool mounting means, that may be attached thereto or be integrally monolithic with the holders; and that may be operable to hold, for instance, shovels, bars, brooms, vacuum cleaners, but not limited to thereto. The tool carrier (53) may be mounted to the plate member (46) fixedly or detachably. The tool carrier may be conveniently used for transporting and organizing tools and equipment, such as shovels, bars, brooms, vacuum cleaners, axes, crowbars, pry bars, but not limited thereto. The tool carrier (53) may be alternatively mounted to the work cell frame (64) or the table (63). In some embodiments there may be at least one additional tool carrier that may be attached to the work cell frame (64) and/or the table (63). In some embodiments, the tool carrier may be mounted to the cart body (135); for example, to the cart platform (36).

In some embodiments, the workstation work cell (1000) may include a detachable disposal container and may also include janitorial tools, such as a vacuum cleaner, compressor, a mop bucket, but not limited thereto.

In some embodiments, the workstation work cell (1000) may include a detachable ladder.

The power tools, including janitorial tools, may be powered by a power source that may be permanently or detachably mounted within the work cell frame (64). The work cell frame (64) and/or the table (63) may include at least one electrical outlet (175). In some embodiments, the workstation work cell (1000) may not be configured to include the power source, and the electrical outlet may draw power from a battery that may be powering the lifting assembly of the transportation module (200); for example, and without limitation, through an additional battery having a power inverter, or through a 12V automotive connector. The workstation work cell (1000) may include a power strip operable to connect the included power tools to an external device; wherein the power strip may be operable to plug into a power source at the work site.

In some embodiments, the workstation wok cell (1000) may have at least one device for mounting it to an external wall or vertical surface when it is not being immediately connected to the cart (300); that may advantageously allow the work cell to be used at the owner's shop or place of business, and may also ease the efforts involved in coupling it to the cart (300), when it needs to be transported to a work cite. The devices may include, but not limited to, hooks, holes, adhesive, Velcro-type fasteners, or latches or any combination thereof.

In some embodiments the workstation work cell (1000) may further include at least one of the following: a charging station, operable to charge mobile devices, a charging station for a battery; a power source/plug-in for tools requiring AC power, such as compressors, external generators, power tools.

In some embodiments, of the workstation work cell (1000) may include labeling system, to facilitate items organization and sorting. The labeling system may include alphanumeric designations and/or color coding.

In some embodiments, one or more of the elements, such as the plate member (46), the work cell frame (64), or the table (63) may be omitted; and the workstation hood (56) and some of the remaining the elements may be configured to be detachably mounted to the platform member (1) of the transportation module (200), the cart body (135), or the cart platform (36). In some embodiments, the workstation hood (56) may be mounted to a frame-like structure that may be detachably mounted to the cart platform (36) or the platform member (1) of the transportation module (200). In some embodiments, the plate member (46) may be omitted, and the workstation work cell may be mounted atop the cart platform (36) by the work cell frame (64).

The workstation work cell (1000) may additionally include at least one of the elements that are described herein in reference to the work cell (400). Moreover, it should be noted, the transportation module (200) included in the workstation transportation system (2500) may further include any of the elements and their variations disclosed herein for the transportation module (200); and the cart (300) included in the workstation transportation system (2500) may include any of the elements and their variations disclosed herein for the cart (300).

The aforementioned methods provided for loading a transportation system (100) to an elevated surface, wherein the methods may include providing the system (100) comprising a transportation module (200), a cart (300), and a work cell (400); as well as exemplary aforementioned modifications of the methods, may be applicable for loading the workstation transportation system (2500), wherein the work cell (400) in the methods comprising a workstation work cell (1000).

According to some embodiments, the transportation system (100) may include a heavy construction tools work cell (1700), wherein the system may be referred herein as a heavy construction tools transportation system (2600). The heavy construction tools transportation system may include the transportation module (200), the cart (300), and the heavy construction tools work cell (1700).

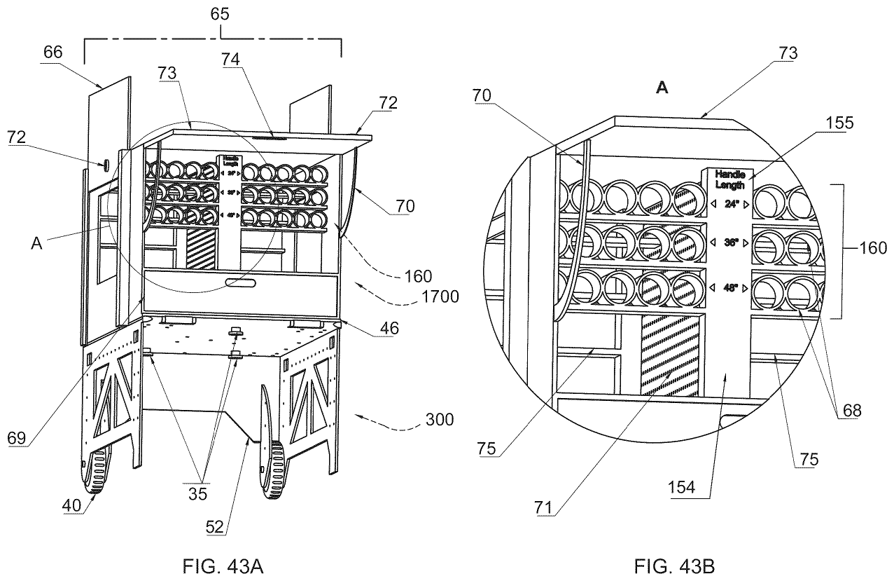

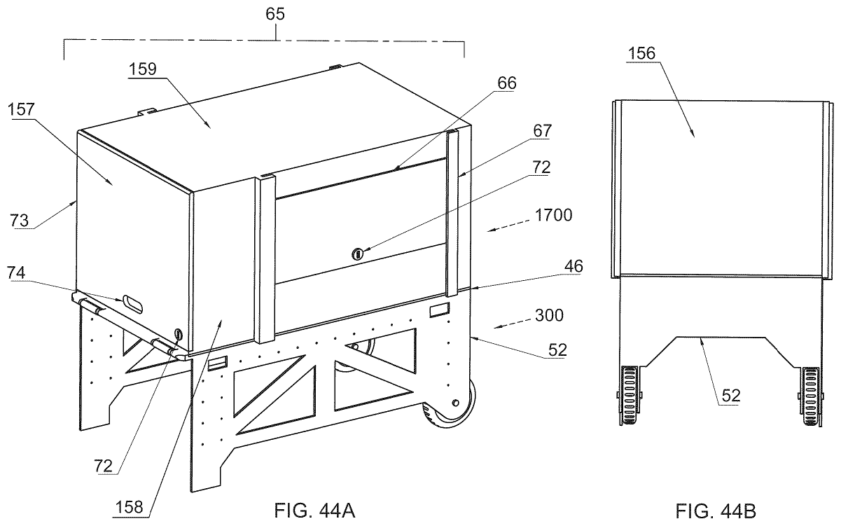

FIGS. 43A-B, 44A-B, and 45A-C show the heavy construction tools work cell (1700) coupled to the cart (300), the transportation module (200) is disengaged and not shown.

As best shown on FIG. 3A, the transportation module (200) may include a frame member (122) defining a longitudinal axis X1 and having a front (123) and a rear (124) opposing ends, wherein the front end includes an overhang member (125) having an overhang portion (2) protruding downwardly below the frame member (122), the overhang portion having at least one approach wheel (32); a base member (15) comprising a plurality of ground wheels (16), the wheels configured for engaging and rolling over a supporting surface; a lifting assembly connected between the base member (15) and the frame member (122), the lifting assembly configured to lift and lower the frame member (122) relative to the base member (15); and a leg member (127), having a leg body (19) and at least one loading wheel (20), the leg body having a first end (129) and a second end (130), the first end connected to the frame member (122); and the loading wheel (20) connected to the second end.

As best shown on FIGS. 43A-B, 44A-B, and 45A-C and FIGS. 25A-H, the cart (300) may include a cart body (135); and at least one front wheel (40); the cart body having a front (136) and a rear (137) opposing sections, the front wheel (40) mounted to the front section of the cart body; wherein the cart body (135) may be configured to detachably couple to the frame member (122) of the transportation module (200).

As best shown on FIGS. 43A-B, 44A-B, and 45A-C, and FIG. 35 A-G, the heavy construction tools work cell (1700) may include a plate member (46) that defines a longitudinal axis X2, and comprising a first end (142), an opposite second end (143), a first lateral side (144) and an opposite second lateral side (145), wherein the plate member (46) may have a top surface (140), a bottom surface (141), and a width defined by the first and second lateral sides; the plate member extends longitudinally between the first and second ends; and a perimeter defined by the first and second ends and the first and second lateral sides, and wherein the plate member (46) may be configured to detachably couple to the cart body (136). The heavy construction tools work cell includes at least one retainer assembly (160).

The retainer assembly (160) may be mounted to the plate member (46) directly, or indirectly. In some embodiments, the retainer assembly (160) may be mounted directly to the plate member (46). In some other embodiments, the retainer assembly (160) may be mounted to a supporting structure, such as a pole, a frame grid, but not limited thereto; and wherein the supporting structure, in its turn, may be mounted to the plate member (46), or another element. As shown on FIGS. 43A-B, in some embodiments, the retainer assembly (160) may be mounted to the pole (154), the pole (154) may be mounted a storage unit (69), and the storage unit (69) may be mounted to the plate member (46). The storage unit (46) is optional, and the pole (154) may be mounted directly to the plate member (46), in some embodiments.

The retainer assembly (160) may include a plurality of holders, that may be configured to hold tools and items, such as, tubes, pipes, picks, shovels, digging bars, sledgehammers, rakes, push-brooms, lumber but not limited thereto. The retainer assembly (160) may include a plurality of tubular holders (68). The tubular holder within the plurality may have the same or assorted diameters. The retainer assembly (160) may also include at least one holder, such as a hanger, a tube, a slot, a rack, but not limited thereto.

The supporting structure, such as pole the (154), may include a labeling system (155), that may include alphanumeric and/or color-coded indicators, that may be located adjacent to a designated location for the particular tool/item. The labeling system (155) that may be advantageous to keep tools organized, preserve a space for a designated tool, and facilitate sorting; thus, improving labor efficiency, preventing tools misplacement or loss, and save time that otherwise would be required to locate and retrieve a desired tool/item.

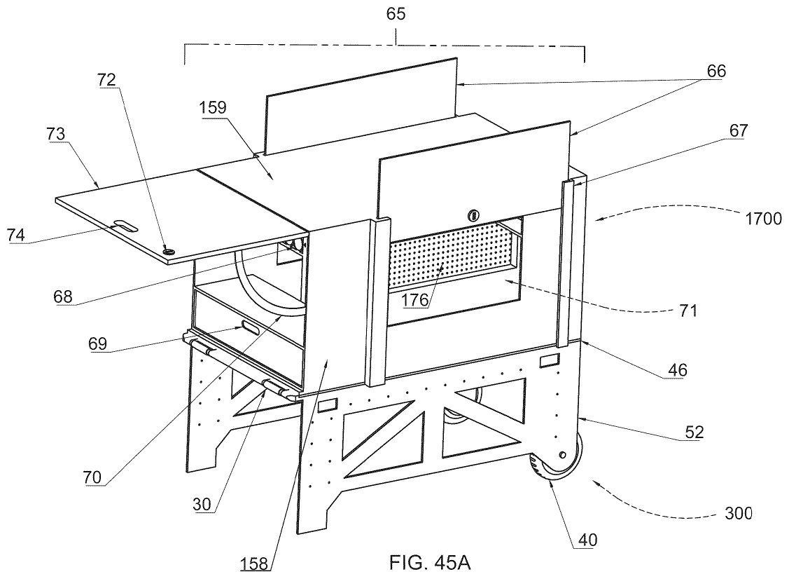

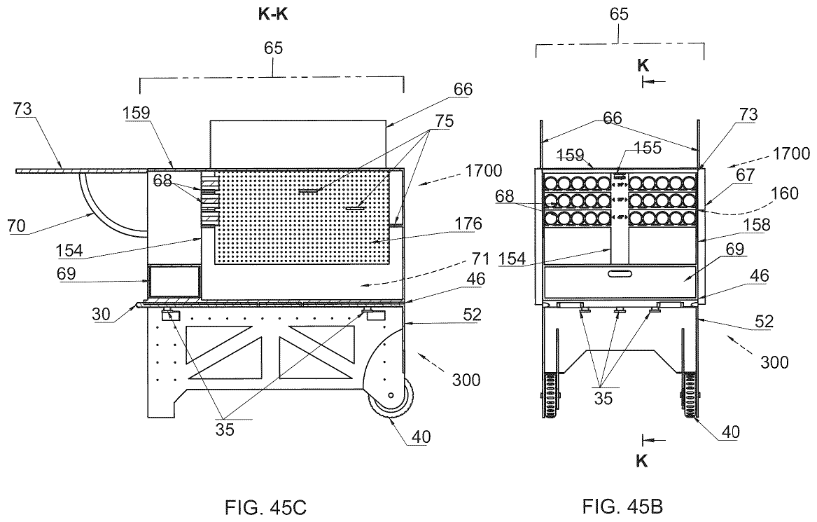

In some embodiments the heavy construction tools work cell (1700) may include storage means. The storage means may include, for example, and without limitation, a storage unit, a cabinet, a drawer, a pegboard, a magnetic rail, a bucket, a slot for small tools, or any combination thereof, wherein the elements of the storage means may be interconnected or discrete. In some embodiments, the heavy construction tools work cell (1700) may include the storage means, that may include at least one storage unit (69), at least one shelf (75), and at least one peg board (176), as shown on FIGS. 43A-B and FIGS. 45A-C. For example, and without limitation, the storage means may be connected to or be an integral part of at least one of the following: a heavy construction hood (65), the plate member (46).

In some embodiments, the retainer assembly (160) and/or the storage means may include additional, built-in, holding means, that may be operable to hold items in place during transit. For example, and without limitation, the holding means may include ratchet straps, magnets, Velcro-type fasteners, pins, zip ties, magnets, fasteners, or mechanical linkages.

In some non-limiting embodiments, the heavy construction tools work cell (1700) may include at least seven cubic feet of storage means, such as drawer space, cabinet space, but not limited thereto.

In some embodiments, the heavy construction tools work cell (1700) may include a divider (71) that may be mounted to the plate member (46). The divider (71) may extend longitudinally to the plate member (46) and may include at least one peg board. In some embodiments, the divider (71) may be mounted atop of the storage unit (69), as shown on FIGS. 43A-B. In some embodiments, the storage means may be connected to or be an integral part of the divider (71).

The plate member (46) configured to detachably couple to the cart body (135); for example, and without limitation, to the cart platform (36). The plate member (46) of the heavy construction tools work cell (1700) may be configured to detachably couple to the cart platform (36) by the cart-to-work cell coupling mechanism. For example, and without limitation, the cart-to-work cell coupling mechanism may include bolting, latching, tongue and grooves, pinning, or adhering, straps, fasteners, screws, mechanical linkages, Velcro-type fasteners. In some embodiments, the cart-to-work cell coupling mechanism may include the plate member (46) of the heavy construction tools work cell (1700) including the third plurality of apertures extending therethrough; so that the heavy construction tools work cell (1700) may be connected to the cart platform (36) through matching apertures the third and the first pluralities; for instance, by fasteners. The third plurality of apertures may include a plurality of openings arranged in a pattern/array, that may be threaded. In some embodiments, the third plurality of apertures may include strategically located openings that may be threaded, wherein the openings may be arranged in one of the connecting bolt opening patterns (CBOPs), wherein the openings may be used to secure the heavy construction tools work cell (1700) to the cart platform (36). Exemplary embodiments of CBOPs that may be advantageous for the heavy construction tools work cell (1700) are disclosed herein.

Exemplary, non-limiting embodiments of CBOPs that may be advantageous for the heavy construction tools work cell (1700) are disclosed herein, and shown as CBOPs (1400) and (1500) on FIGS. 35 E-F. In some embodiments other cart-to-work cell coupling mechanisms may be used, as aforementioned.

In some embodiments, the plate member (46) may include at least one extendable platform, that may be foldable and may be pivotally/hingedly connected to the plate member (46) or be retractable from the plate member (46); and that may provide an additional working area. In some embodiments, the extendable platform may be configured as the extendable platform (57).

In some embodiments, the heavy construction tools work cell (1700) may include a table (63), configured to fixedly or detachably mount to the plate member (46). In some embodiments, the heavy construction tools work cell (1700) may include a work cell frame (64), that may be configured to connect to the plate member (46); for instance, to the top surface (140) of the plate member (46) and the table (63) may be mounted atop of the work cell frame. The work cell frame (64) may be configured to bring the top surface of the table (63) up to the level of a standing desk/table, making it more comfortable for the user to interact with, and providing extra space to host drawers, storage, or power tools.

The work cell frame (64) may include at least one storage compartment, such as drawers (62). In some embodiments, the heavy construction tools work cell (1700) may include lifting means operable to adjust the height of the table (63) relative to a supporting surface, such as ground. The lifting means may be manual or powered; and may be positioned between the work cell frame (64) and the table (63); or alternatively, between the plate member (46) and the work cell frame (64). The lifting means may include jacks, cranks, leadscrews, but not limited thereto.

The exemplary embodiments of the table (63), the work cell frame (64) and the extendable platform (57) are depicted on FIG. 40, that shows an exemplary embodiment of the system (100) including the workstation work cell (1000), however, any other work cell (400) disclosed herein, including the heavy construction tools work cell (1700), may include similar structures.

The work cell frame (64) may include at least one storage compartment. The retainer assembly (160) may be mounted to the table (63). In some embodiments, the retainer assembly (160) may be mounted to the supporting structure, such as the pole (154), that may be mounted to the table (63). The table (63) may include at least one extendable platform (57), that may provide additional working area. The extendible platform (57) may contain mounting hardware, such as at least one mounting hole, mechanical connectors for power tools, but not limited thereto. For example, and without limitation, the mounting hardware may include at least one mounting hole for mounting a table router, that may allow a routing bit to be leveled with the extendable platform (57). The extendable platform may be pivotally connected to the table (63) and may be foldable. Alternatively, the extendable platforms (57) may be configured to extend and retract from the table (63). In some embodiments, the work cell frame (64) may include at least one additional extendable platform, that may provide additional working area.

The heavy construction tools work cell (1700) may include a hood, herein referred to as a heavy construction hood (65), that may operable to encase at least some part of the heavy construction tools work cell (1700), wherein the heavy construction hood (65) may be mounted to the plate member (46), and may include a front panel (156), an opposing back panel (157) and two opposing side panels (158), that define its perimeter, and a top panel (159) that may function as a roof. The hood may include the storage means, wherein the storage means may be lockable for restricted access. For example, and without limitation, the storage means may include designated spaces, holders, hooks, clamps, magnets, containers, drawers, cabinets, racks, and patterns of threaded/unthreaded mounting holes; and may be mounted to inner surfaces of the panels. The storage means may also include at least one small tools container, such as drawer, basket, peg board, that may be configured to store organize small tools, such as drill bits, blades, screwdrivers, nails, screws, but not limited thereto; that may be connected to the inner surfaces of the panels. Alternatively, or additionally, some storage means may be located within the work cell frame (64). The storage means may also include at least one fastener that may be connected to inner surfaces of the panels, wherein the fastener may be operable to store items, such as flat items, elongated items, small tools, but not limited thereto; and may include straps, Velcro-type fasteners, but not limited thereto. The storage means may include at least one slot-shaped holder formed within at least one of the panels. The storage means may be fixedly or detachably mounted to the hood panels.

In some embodiments, the heavy construction hood (65) may be connected to the work cell fame (64); while in some others, it may be connected to the table (63). In some embodiments, the hood may include a top panel extension (not shown), that may be configured to extend out of the top panel (159) and shield the user from weather elements.

The top panel extension may be operable to slide out or unfold from the top panel (159) to shield the user from elements, such as sun or rain. The top panel (159) and the top pane extension may include additional compartments, curtains, umbrellas, tarps, drawers, holders, straps, that may be detachable. For example, and without limitation, detachable elements of the system (2600) may be stored within a pouch, a compartment, or a drawer, that may be included in the hood (65). In some embodiments, the panels of hood (65) and/or top panel extension may include attachment means, such as hooks, rings, or rails; that may allow to connect curtains, tarps, umbrellas, or straps.

The top panel extension may include storage means. This top panel extension may be extendable to cover the extendable platform(s) (57) and/or include elements to connect tarps or external features, or to secure a larger canopy.

The hood panels may include a plurality of doors that may conveniently allow the user access enclosed structures and items from a most convenient side. The doors may include, for example, and without limitation, a rolling door, a hinged door, a pivoting door, a sliding door, or any combination thereof. The doors may conveniently allow the user to easily access the tools and materials. In some embodiments, the back panel (157) may include a back door (73); that may allow the user to conveniently access the tools, even without unloading the system from the vehicle/elevated surface. The back door (73) may be hingedly connected to the top panel (159), for example, by hinges (70); and may be further configured to shield a user from elements, such as sun or rain, when opened. At least one side panel (158) may include at least one sliding door (66) that may be mounted to the side panel (158) by sliding rails (67). The doors may have locks (72).

As aforementioned, the heavy construction tools work cell (1700) may have alternative hood configuration; and may include any one of the hood configurations disclosed herein, and that are described in conjunction with other disclosed work cells (400). Hence, wherein the heavy construction tools work cell (1700) may be claimed comprising a hood, all hood configurations disclosed herein are included in the claimed scope, unless stated otherwise.

In some embodiments, the heavy construction tools work cell (1700) may include at least one lighting feature, that may include a light-reflective feature, allowing a user to safely operate the system in low-light conditions. For example, and without limitation, the lighting feature may include a light bulb, a linear light bulb, light panel, chemiluminescent element, but not limited thereto. The lighting feature may be mounted to, for example, and without limitation, the plate member (46), the hood (65), the back door (73).

The heavy construction tools work cell (1700) may have at least one tool carrier, that may include tool mounting means, that may include hooks, fasteners, Velcro-type fasteners, clamps, magnets, but not limited thereto. In some embodiments, the tool carrier, may include the tool carrier, such as the tool carrier (53), that may comprise at least two spaced apart holders; wherein the holders may include tool mounting means, that may be attached thereto or be integrally monolithic with the holders; and that may be operable to hold, for instance, shovels, bars, brooms, vacuum cleaners, but not limited to thereto. The tool carrier may be mounted to the plate member (46) fixedly or detachably. The tool carrier may be conveniently used for transporting and organizing tools and equipment, such as shovels, bars, brooms, vacuum cleaners, axes, crowbars, pry bars, but not limited thereto. The tool carrier may be alternatively mounted to the work cell frame (64) or the table (63). In some embodiments there may be at least one additional tool carrier that may be attached to the work cell frame and/or the table.

The heavy construction tools work cell (1700) may include at least one electrical outlet that may draw a power from a battery that may be powering the lifting assembly of the transportation module. The heavy construction tools work cell (1700) may include a power strip operable to connect power tools to an external device; wherein the power strip may be operable to plug into a power source at the work site.

In some embodiments, the heavy construction tools wok cell (1700) may have at least one device for mounting it to an external wall or vertical surface, when it is not being immediately connected to the cart; that may advantageously allow the work cell to be used at the owner's shop or place of business, and may also ease the efforts involved in coupling it to the cart (300), when it needs to be transported to a work cite. The devices may include, but not limited to, hooks, holes, adhesive, Velcro-type fasteners, or latches or any combination thereof.

In some embodiments the heavy construction tools work cell work cell may include at least one of the following: a charging station, operable to charge mobile devices, a charging station for a battery; a power source/plug-in for tools requiring AC power, such as compressors, external generators, power tools.

In some embodiments, at least one of the elements, such as the plate member (46), the work cell frame (64), or the table (63) may be omitted and the heavy construction hood (65) and some of the remaining the elements, such as the retainer assembly or the supporting structure may be configured to be detachably mounted to the platform member (1) of the transportation module (200) or the cart platform (36). In some embodiments, the heavy construction hood (65) may be mounted to a frame-like structure that may be detachably mounted to the cart platform (36), or the platform member (1) of the transportation module (200). In some embodiments, the plate member (46) may be omitted, and the heavy construction tools work cell may be mounted atop the cart platform (36) by the work cell frame (64).

The heavy construction tools work cell (1700) may additionally include at least one of the elements that are described herein in reference to the work cell (400). Moreover, it should be noted, the transportation module (200) included in the heavy construction tools transportation system (2600) may further include any of the elements and their variations disclosed herein for the transportation module (200); and the cart (300) included in the heavy construction tools transportation system (2600) may include any of the elements and their variations disclosed herein for the cart (300).

The aforementioned methods provided for loading a transportation system (100) to an elevated surface, wherein the methods may include providing the system (100) comprising a transportation module (200), a cart (300), and a work cell (400); as well as exemplary aforementioned modifications of the methods, may be applicable for loading the heavy construction tools transportation system (2600), wherein the work cell (400) in the methods comprising a heavy construction tools work cell (1700).

According to some embodiments, the transportation system (100) may include a custom toolbox work cell (1800), wherein the system may be referred herein as a custom toolbox transportation system (2700). The custom toolbox transportation system (2700) may include the transportation module (200), the cart (300), and the custom toolbox work cell (1800).

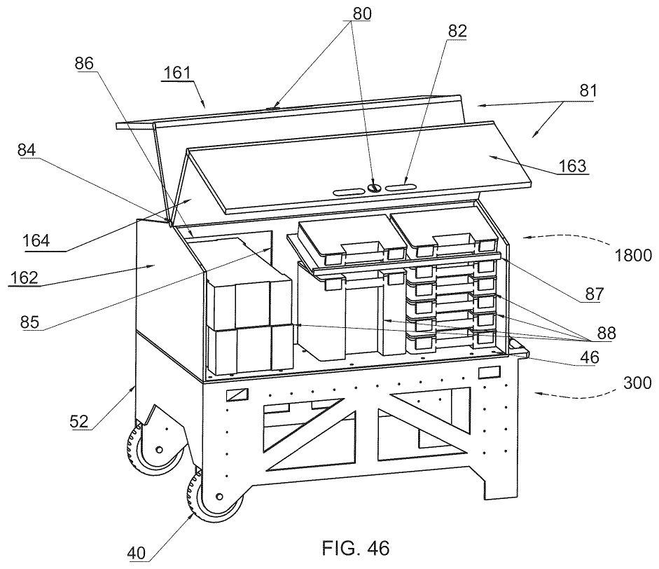

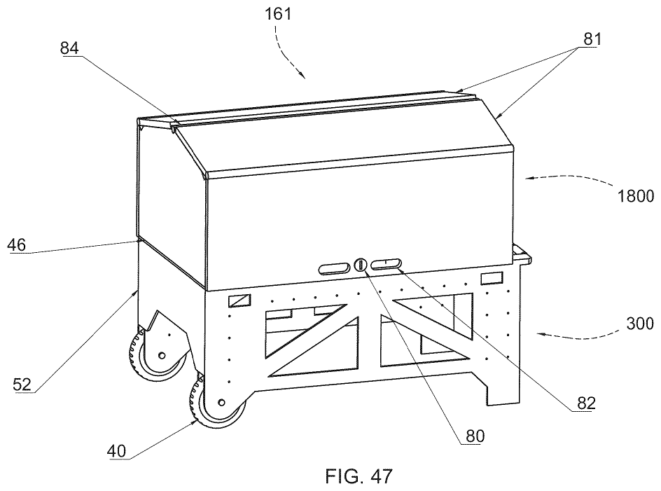

FIGS. 46-47, show the custom toolbox work cell (1800) coupled to the cart (300), the transportation module (200) is disengaged and not shown.

As best shown on FIG. 3A, the transportation module (200) may include a frame member (122) defining a longitudinal axis X1 and having a front (123) and a rear (124) opposing ends, wherein the front end includes an overhang member (125) having an overhang portion (2) protruding downwardly below the frame member (122), the overhang portion having at least one approach wheel (32); a base member (15) comprising a plurality of ground wheels (16), the wheels configured for engaging and rolling over a supporting surface; a lifting assembly connected between the base member (15) and the frame member (122), the lifting assembly configured to lift and lower the frame member (122) relative to the base member (15); and a leg member (127), having a leg body (19) and at least one loading wheel (20), the leg body having a first end (129) and a second end (130), the first end connected to the frame member (122); and the loading wheel (20) connected to the second end.

As best shown on FIGS. 46-47 and FIGS. 25A-H, the cart (300) may include a cart body (135); and at least one front wheel (40); the cart body having a front (136) and a rear (137) opposing sections, the front wheel (40) mounted to the front section of the cart body; wherein the cart body (135) may be configured to detachably couple to the frame member (122) of the transportation module (200).

As best shown on FIGS. 46-47, and FIGS. 35A-G, the custom toolbox work cell (1800) may include a plate member (46) that defines a longitudinal axis X2, and comprising a first end (142), an opposite second end (143), a first lateral side (144) and an opposite second lateral side (145), wherein the plate member (46) may have a top surface (140), a bottom surface (141), and a width defined by the first and second lateral sides; the plate member extends longitudinally between the first and second ends; and a perimeter defined by the first and second ends and the first and second lateral sides, and wherein the plate member (46) may be configured to detachably couple to the cart body (136). The custom toolbox work cell (1800) may include a plurality of toolboxes.

The plate member (46) may be configured to detachably couple to the cart body (135); for example, and without limitation, to the cart platform (36). The plate member (46) of the custom toolbox work cell (1800) may be configured to detachably couple to the cart platform (36) by the cart-to-work cell coupling mechanism. For example, and without limitation, the cart-to-work cell coupling mechanism may include bolting, latching, tongue and grooves, pinning, or adhering, straps, fasteners, screws, mechanical linkages, Velcro-type fasteners. In some embodiments, the cart-to-work cell coupling mechanism may include the plate member (46) of the custom toolbox work cell (1800) including the third plurality of apertures extending therethrough; so that the custom toolbox work cell (1800) may be connected to the cart platform (36) through matching apertures the third and the first pluralities; for instance, by fasteners. The third plurality of apertures may include a plurality of openings arranged in a pattern/array, that may be threaded. In some embodiments, the third plurality of apertures may include strategically located openings that may be threaded, wherein the openings may be arranged in one of the connecting bolt opening patterns (CBOPs), wherein the openings may be used to secure the custom toolbox work cell (1800) to the cart platform (36). Exemplary embodiments of CBOPs that may be advantageous for the custom toolbox work cell are disclosed herein, and shown as CBOPs (1400) and (1500) on FIGS. 35 E-F. In some embodiments other cart-to-work cell coupling mechanisms may be used, as aforementioned.

The custom toolbox work cell may include a hood, herein referred to as a custom toolbox hood (161), that may include a pair of spaced apart peripheral walls (162), at least one longitudinal wall (85) and at least one hood wing (81). The peripheral walls (162) may be mounted to the first (142) and the second (143) end of the plate member (46). The longitudinal wall (85) may be connected to the plate member (46); for example, along one of its lateral sides. Alternatively, the longitudinal wall (85) may be connected to the plate member (46) substantially parallel or along its longitudinal axis X2. At least one hood wing (81) may be mounted to the longitudinal wall (85). For example, and without limitation, the hood wing (81) may be pivotally or hingedly connected to one or more of the following: the longitudinal wall (85), the peripheral walls, a beam extending between the peripheral walls. The hood (161) may be locked, and a lock (80) may be included in the hood wing (81). The hood wing (81) may include at least one handle (82) that may be mounted thereto or be integrally formed as monolithic structure with the wing (81). The hood wing (81) may include a single wing panel or include a plurality of wing panels. As shown, on FIG. 46, in some embodiments, the hood (161) may include a pair of wings (81), wherein each wing (81) may include a medial panel (164) and lateral panel (163). The shown number of wing panels is not limiting, and each hood wing (81) may include at least one wing panel. Moreover, the hood wing (81) may include a concave shaped structure.

As aforementioned, the custom toolbox work cell (1800) may have alternative hood configuration; and may include any one of the hood configurations disclosed herein, and that are described in conjunction with other disclosed work cells (400). Hence, wherein the custom toolbox work cell (1800) may be claimed comprising a hood, all hood configurations disclosed herein are included in the claimed scope, unless stated otherwise.

The custom toolbox work cell (1800) may include at least one holder, such as a fastener, a strap, a Velcro-type strap, a magnet, a slot-shaped compartment, a peg board, a container, a basket, a drawer, a hook, a loop, or combination thereof. The holder may be mounted to the inner surface of the hood wing (81). The holder may be additionally, or alternatively mounted to the hood walls; for example, and without limitation, to the inner surfaces of the hood walls. The holder may be lockable for restricted access.

In some embodiments, at least one shelving unit (87) may be mounted to the hood walls. for example, to the inner surface of the hood walls. The shelving unit (87) may include at least one shelf. The shelving unit (87) may be detachably mounted to the hood walls and may be repositionable.

The plurality of toolboxes may include an assortment of boxes (88), herein referred as toolboxes, that may be configured to interlock to each other to form a custom arrangement, that most suits immediate needs of the user. The toolboxes may be stackable. At least one of the toolboxes (88) may be configured to detachably couple to the plate member (46). The plate member (46) may include means for coupling with at least one toolbox, wherein the means may include, for example, and without limitation: at least one opening, that may be threaded, protruding pin/peg, a latch, a fastener, or any combination thereof. The user may choose to use a single toolbox (88) or create a custom arrangement that may include multiple or all toolboxes (88) of the plurality. The toolboxes may have assorted sizes and shapes. The number of the toolboxes in the plurality (88) is not limited to the depicted number, and the plurality of toolboxes may include at least two toolboxes (88). The toolboxes may include a color-coded and/or alphanumeric labeling system. At least one of the toolboxes (88) may include compartments and/or drawers, that may, likewise, be labeled. In some embodiments, the plurality of toolboxes (88) may include at least two task-specific sets of boxes; wherein the boxes may be compatible between the sets; so that the user may mix-and-match boxes from different sets, and interlocked them together to create a custom arrangement according to a particular storage needs and task at hand. In some embodiments, at least one of the toolboxes of the plurality may be configured to fit onto and/or couple to the shelving unit. In some embodiments, the plurality of toolboxes (88) may include a pre-configured arrangement of toolboxes, that may be fixedly connected the plate member (46) or configured to detachably couple to the plate member (46). In some embodiments, the custom toolbox work cell (1800) may include at least one toolbox that may be fixedly connected to the plate member (46).

In some embodiments the custom toolbox work cell (1800) may include a ramp for rolling/sliding equipment and/or toolboxes onto the plate member (46).

In some embodiments, the custom toolbox work cell (1800) may include a fastening means, such as a ratchet trap, that may be operable to secure the toolboxes in place during transit.

In some embodiments, the custom toolbox work cell (1800) may additional storage means, such as drawers, cabinets, but not limited thereto; wherein the storage means may be mounted to, for example, and without limitation, the hood walls, the plate member (46).

In some embodiments, the plate member (46) may include at least one extendable platform, that may be foldable and may be pivotally/hingedly connected to the plate member (46) or be retractable from the plate member (46); and that may provide an additional working area. In some embodiments, the extendable platform may be configured as the extendable platform (57).

In some embodiments, the custom toolbox work cell (1800) may include a table (63), configured to fixedly or detachably mount to the plate member (46). In some embodiments, the custom toolbox work cell (1800) may include a work cell frame (64), that may be configured to connect to the plate member (46); for instance, to the top surface (140) of the plate member (46) and the table (63) may be mounted atop of the work cell frame (64). The plurality of toolboxes (88) may be mounted to the table (63). In some embodiments at least one of the boxes (88) may be configured to detachably couple to the table (63).

The work cell frame (64) may be configured to bring the top surface of the table (63) up to the level of a standing desk/table, making it more comfortable for the user to interact with, and providing extra space to host drawers, storage, or power tools.

The work cell frame (64) may include at least one storage compartment, such as drawers (62). In some embodiments, the custom toolbox work cell (1800) may include lifting means operable to adjust the high of the table (63) relative to a supporting surface, such as ground. The lifting means may be manual or powered; and may be positioned between the work cell frame (64) and the table (63); or alternatively, between the plate member (46) and the work cell frame (64). The lifting means may include jacks, cranks, leadscrews. but not limited thereto.

The exemplary embodiments of the table (63), the work cell frame (64) and the extendable platform (57) are depicted on FIG. 40, that shows an exemplary embodiment of the system (100) including the workstation work cell (1000), however, any other work cell (400) disclosed herein, including the custom toolbox work cell (1800), may include similar structures.

The work cell frame (64) may include at least one storage compartment. The table (63) may include at least one extendable platform (57), that may provide additional working area. The extendible platform (57) may contain mounting hardware, such as at least one mounting hole, mechanical connectors for power tools, but not limited thereto. For example, and without limitation, the mounting hardware may include at least one mounting hole for mounting a table router, that may allow a routing bit to be leveled with the extendable platform (57). The extendable platform may be pivotally connected to the table (63) and may be foldable. Alternatively, the extendable platforms (57) may be configured to extend and retract from the table (63). In some embodiments, the work cell frame (64) may include at least one additional extendable platform, that may provide additional working area.

In some embodiments, the plate member (46) and/or the table (63) may include at least one ratchet strap or clamp, that may be operable to secure the plurality of toolboxes (88) during transit.

In some embodiments, the longitudinal wall (85) is mounted to the plate member (46) substantially along the X2 and may divide the toolbox work cell (1800) lengthwise into two sections. A pair of hood wings (81) may be mounted to the longitudinal wall (85); for instance, hingedly or pivotally, but not limited thereto; and the wings (81) may be operable to provide the user a separate access to each section, wherein the access may be restricted by a lock (80). The longitudinal wall (85) may define an enclosed void, herein referred to, as a cutout (86). For example, and without limitation the cutout (86) may be substantially rectangular or square. In some embodiments, the longitudinal wall (85) may include at least two spaced apart wall sections, wherein the wall section may be separated by a gap, wherein the gap may be operable as the cutout.

In some embodiments, the custom toolbox hood (161) may be connected to the work cell frame (64); while in some others, it may be connected to the table (63).

In some embodiments, at least one hood wing (81) may include a wing extension, that may be configured to extend out of the hood wing (81) and shield the user from weather elements. The wing extension, in its turn, may include compartments and/or holders. This section may be extensible to cover the extendable platforms, such as platforms (57), and/or include elements to connect tarps or external features, and/or to secure a larger canopy.

In some embodiments, the custom toolbox work cell (1800) may include at least one lighting feature, that may include a light-reflective feature, allowing a user to safely operate the system and use the work cell in low-light conditions. The lighting feature may include, for example, and without limitation, a headlight, a light bulb, a linear light bulb, lighting panel, chemiluminescent element, or any combination thereof. The lighting feature may be mounted to, for example, and without limitation, the plate member (46), the custom toolbox hood (161), the hood wing (81).

The custom toolbox work cell (1800) may include at least one tool carrier, that may include tool mounting means, that may include hooks, fasteners, Velcro-type fasteners, clamps, magnets, but not limited thereto. In some embodiments, the tool carrier may have configuration of the tool carrier (53). In some embodiments, the tool carrier may comprise at least two spaced apart holders; wherein the holders may include tool mounting means, that mat be attached thereto or be integrally monolithic with the holders; and that may be operable to hold, for instance, shovels, bars, brooms, vacuum cleaners, but not limited to thereto. The tool carrier may be mounted to the plate member (46) and may be mounted fixedly or detachably. The tool carrier may be conveniently used for transporting and organizing tools and equipment, such as shovels, bars, brooms, vacuum cleaners, axes, crowbars, pry bars, but not limited thereto. The tool carrier may be alternatively mounted to the workstation frame (64) or the table (63). In some embodiments there may be at least one additional tool carrier that may be attached to the work cell frame (64) and/or the table (63).

The custom toolbox work cell (1800) may include at least one electrical outlet that may draw a power from a battery that may be powering the lifting assembly of the transportation module (200). The custom toolbox work cell (1800) may include a power strip operable to connect power tools to an external device; wherein the power strip may be operable to plug into a power source at the work site.

In some embodiments, the custom toolbox wok cell (1800) may have at least one device for mounting it to an external wall or vertical surface, when it is not being immediately connected to the cart (300); that may advantageously allow the custom toolbox work cell to be used at the owner's shop or place of business, and may also ease the efforts involved in coupling it to the cart (300), when it needs to be transported to a work cite. The devices may include, but not limited to, hooks, holes, adhesive, Velcro-type fasteners, or latches or any combination thereof.

In some embodiments the custom toolbox work cell work cell may include at least one of the following: a charging station, operable to charge mobile devices, a charging station for a battery; a power source/plug-in for tools requiring AC power, such as compressors, external generators, power tools.

In some embodiments, the custom toolbox work cell (1800) components may be comprising at least one of the following: metal, metal alloy, wood, or plastic. For example, and without limitation, metal may include aluminum, titanium, steel.

In some embodiments, at least one of the elements, such as the plate member (46), the work cell frame (64), or the table (63) may be omitted and some of the custom toolbox elements, such as the custom work cell hood (161), the plurality of toolboxes (88), or other elements, may be configured to be detachably mounted to the platform member (1) of the transportation module (200), or to the cart platform (36). In some embodiments, the custom toolbox hood (161) may be mounted to a frame-like structure that may be detachably mounted to the cart platform (36) or the platform member (1) of the transportation module (200). In some embodiments, the plate member (46) may be omitted, and the custom toolbox work cell (1800) may be mounted atop the cart platform (36) by the work cell frame (64).

The custom toolbox work cell (1800) may additionally include at least one of the elements that are described herein in reference to the work cell (400). Moreover, it should be noted, the transportation module (200) included in the custom toolbox system (2700) may further include any of the elements and their variations disclosed herein for the transportation module (200); and the cart (300) included in the custom toolbox transportation system (2700) may include any of the elements and their variations disclosed herein for the cart (300).

The aforementioned methods provided for loading a transportation system (100) to an elevated surface, wherein the methods may include providing the system (100) comprising a transportation module (200), a cart (300), and a work cell (400); as well as exemplary aforementioned modifications of the methods, may be applicable for loading the custom toolbox transportation system (2700), wherein the work cell (400) in the methods comprising a custom toolbox work cell (1800).

Different features, variations and multiple embodiments of the transportation system (100) and its modules have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

What is claimed is:

1. A heavy construction tools transportation system comprising: a transportation module, a cart, and a heavy construction tools work cell, wherein said transportation module comprising:
a. a frame member defining a longitudinal axis and having a front and a rear opposing ends, wherein said front end comprising an overhang member having an overhang portion protruding downwardly below said frame member; said overhang portion having at least one approach wheel;
b. a base member comprising a plurality of ground wheels, said wheels configured for engaging and rolling over a supporting surface;
c. a lifting assembly connected between said base member and said frame member; said lifting assembly configured to lift and lower said frame member relative to said base member;
d. a leg member comprising a leg body and at least one loading wheel; said leg body having a first end and a second end; said first end connected to said frame member; and said loading wheel connected to said second end;
said cart comprising
a cart body; and
at least one front wheel;
said cart body comprising a front and a rear opposing sections, said front wheel mounted to said front section of said cart body; said cart body configured to detachably couple to said frame member of said transportation module;
said heavy construction tools work cell comprising
a plate member comprising a first end, an opposite second end, a first lateral side and an opposite second lateral side, wherein said plate member having a top surface, a bottom surface, a width defined by said first and second lateral sides; said plate member extending longitudinally between said first and second ends; and a perimeter defined by said first and second ends and said first and second lateral sides, wherein said plate member configured to detachably couple to said cart body;
a supporting structure connected to said plate member; and
one or more retainer assemblies connected to said supporting structure.

2. A system as in claim 1, wherein said frame member further comprising leg-receiving means, so that said leg member operable to extend from and retract to said means.

3. A system as in claim 2, wherein said leg-receiving means comprising a leg receiving assembly, said assembly comprising a pair of spaced apart linear slide rails extending longitudinally, each of said rails having a medially facing track; and wherein said first end of said leg body mounted to said medially facing tracks by mounting means having rotational axes; said tracks configured to translatably receive said leg body, so that said leg body operable to extend and retract from said tracks; and pivot about said rotational axes when extended.

4. A system as in claim 1, wherein said transportation module further comprising leg body immobilizing means configured to secure said leg member in substantially vertical position.

5. A system as in claim 4, wherein said immobilizing means comprising at least one locking pin on said leg body and at least one gravity latch on said frame member, said gravity latch configured to releasably couple to said pin to secure said leg member in substantially vertical position.

6. A system as in claim 1, wherein said leg body is length-adjustable.

7. A system as in claim 1, wherein said transportation module further comprising a first motor, operable to drive at least two of said plurality of ground wheels, said motor configured to be connected to a source of power.

8. A system as in claim 1, wherein said transportation module further comprising a second motor, operable to drive said approach wheel, said motor configured to be connected to a source of power.

9. A system as in claim 1, wherein said lifting assembly is manual.

10. A system as in claim 1, wherein said lifting assembly is powered.

11. A system as in claim 10, wherein said lifting assembly comprising a scissor lift and an actuator configured to be connected to a source of electrical power.

12. A system as in claim 1, wherein said transportation module further comprising a handle connected to said rear end of said frame member.

13. A system as in claim 12, wherein said handle includes at least one user engagement portion.

14. A system as in claim 1, wherein said frame member further comprising a platform member extending longitudinally between said front and rear ends of said frame member.

15. A system as in claim 14, wherein said platform member comprising at least one aperture extending therethrough.

16. A system as in claim 1, wherein said rear end of said frame member comprising at least one user engagement portion.

17. A system as in claim 1, wherein said leg member further comprising at least one shock absorbing assembly.

18. A system as in claim 1, wherein said transportation module further comprising a motor operable to drive at least two of said plurality of ground wheels and said at least one approach wheel.

19. A system as in claim 1, wherein said overhang member having a height h1; and wherein said lifting assembly in substantially contracted state and said base member having a cumulative height h2; and wherein h1≥h2.

20. A system as in claim 1, wherein said frame member having a length l1, and said base member having a length l2, and wherein l1>l2.

21. A system as in claim 1, wherein said cart body configured to detachably couple to said frame member of said transportation module by transportation module-to-cart coupling mechanism.

22. A system as in claim 1, wherein said cart body further comprising a cart platform and a cart base; said cart platform having a top surface and a bottom surface; said cart base connected to said bottom surface of said cart platform; and wherein said rear section comprising at least one rear handle; and wherein said frame member of said transportation module further comprising a platform member extending longitudinally between said front and rear ends of said frame member; and wherein said cart platform configured to detachably couple to said platform member by a transportation module-to-cart coupling mechanism.

23. A system as in claim 1, wherein said cart body further comprising a cart platform and a cart base; said cart platform having a top surface and a bottom surface; said cart base connected to said bottom surface of said cart platform; wherein said plate member configured to detachably couple to said cart platform by the cart-to-work cell coupling mechanism.

24. A system as in claim 23, wherein said cart-to-work cell coupling mechanism includes said cart platform further comprising a first plurality of apertures extending therethrough, and said plate member further comprising a third plurality of apertures extending therethrough, so that said heavy construction tools work cell is operable to detachably couple to the cart through matching apertures of said first and third pluralities.

25. A system as in claim 1, further comprising a tool carrier, said carrier connected to one of said plate member, or said cart body.

26. A system as in claim 1, wherein said heavy construction tools work cell further comprising a hood connected to one of said plate member or said card body.

27. A system as in claim 26, wherein said hood comprising tools storage means.

28. A system as in claim 26, wherein said hood comprising a front panel, an opposing back panel, and two opposing side panels, wherein said front, said back and said side panels define a perimeter of said hood, and a top panel mounted atop of said panels and operable as a roof.

29. A system as in claim 28, wherein at least one of said front, said back or said side panels including a door.

30. A system as in claim 26, wherein said hood including a lock.

31. A system as in claim 1, wherein said one or more retainer assemblies comprising at least one retainer assembly including a plurality of holders.

32. A system as in claim 1, wherein said one or more retainer assemblies comprising at least one retainer assembly including a plurality of tubular holders.

33. A system as in claim 1, wherein said heavy construction tools work cell further comprising a divider mounted to the plate member.

34. A system as in claim 33, wherein said divider comprising at least one peg board.

35. A system as in claim 1, wherein said heavy construction tools work cell further comprising a storage unit mounted to the plate member.

36. A system as in claim 26, wherein said heavy construction tools work cell further comprising a lighting feature connected to one of said hood or said plate member.

37. A system as in claim 1, wherein said heavy construction tools work tools cell further comprising a power source.

38. A system as in claim 1, wherein said plate member including at least one extendable platform.

39. A system as in claim 1, wherein said supporting structure comprising a pole.

40. A system as in claim 28, wherein said heavy construction tools work cell further comprising at least one shelf connected to said front panel.

41. A system as in claim 28, wherein said top panel including a top panel extension.

42. A system as in claim 3, wherein said frame member further comprising a platform member extending longitudinally between said front and rear ends of said frame member, and
wherein said rear end comprising a strut and at least one user engagement portion;
wherein said slide rails mounted below said platform member, said rails having a front and a rear opposing portions; said strut mounted to said rear portions of said rails and protruding downwardly; said overhang portion having an upper end and a lower end; said upper end connected to said front portions of said slide rails, said overhand portion protruding downwardly below said rails, said approach wheel connected to said lower end;
wherein said mounting means include a pair of pins protruding laterally from said first end of said leg body, so that said first end of said leg body mounted said medially facing tracks by said pins;
wherein said leg member further includes a pair of laterally protruding locking pins and said strut includes a pair of gravity latches, said latches configured to releasably couple to said locking pins to secure said leg member in substantially vertical position;
wherein said lifting assembly is powered;
wherein said transportation module further comprising: a first motor, operable drive at least two of said plurality of ground wheels, said motor configured to be connected to a source of power, and a handle connected to said rear end of said frame member; and
wherein said cart body further comprising a cart platform and a cart base, said cart platform having a top surface and a bottom surface, said cart base connected to said bottom surface of said cart platform; and said rear section of cart body comprising at least one rear handle; and
wherein said cart platform configured to detachably couple to said platform member of said transportation module by a transportation module-to-cart coupling mechanism, said mechanism comprising: at least mating element having a first end and a second end; wherein said first end connected to said bottom surface of said cart platform; said second end protruding downwardly; and said platform member of said transportation module having at least one groove extending therethrough configured to receive said mating element; so that said cart operable to couple to, and uncouple from said transportation module by guiding said mating element into and out of said groove; and
wherein said plate member of said heavy construction tools work cell configured to detachably couple to said cart platform by the cart-to-work cell coupling mechanism, said mechanism comprising: said cart platform further comprising a first plurality of apertures extending therethrough, and said plate member further comprising a third plurality of apertures extending therethrough, so that said heavy construction tools work cell is operable to detachably couple to the cart through matching apertures of said first and third pluralities.

43. A heavy construction tools transportation system comprising: a transportation module, a cart, and a heavy construction tools work cell, wherein said transportation module comprising:
a. a frame member defining a longitudinal axis and having a front and a rear opposing ends, wherein said front end comprising an overhang member having an overhang portion protruding downwardly below said frame member; said overhang portion having at least one approach wheel;
b. a base member comprising a plurality of ground wheels, said wheels configured for engaging and rolling over a supporting surface;
c. a lifting assembly connected between said base member and said frame member; said lifting assembly configured to lift and lower said frame member relative to said base member;
d. a leg member comprising a leg body and at least one loading wheel; said leg body having a first end and a second end; said first end connected to said frame member; and said loading wheel connected to said second end;
said cart comprising
a cart body; and
at least one front wheel;
said cart body comprising a front and a rear opposing sections, said front wheel mounted to said front section of said cart body; said cart body configured to detachably couple to said frame member of said transportation module;
said heavy construction tools work cell comprising
a plate member comprising a first end, an opposite second end, a first lateral side and an opposite second lateral side, wherein said plate member having a top surface, a bottom surface, a width defined by said first and second lateral sides; said plate member extending longitudinally between said first and second ends; and a perimeter defined by said first and second ends and said first and second lateral sides, said plate member configured to detachably couple to said cart body; and
one or more retainer assemblies connected to said plate member.

44. A system as in claim 43, wherein said frame member further comprising leg-receiving means, so that said leg member operable to extend from and retract to said means.

45. A system as in claim 43, wherein said transportation module further comprising leg body immobilizing means configured to secure said leg member in substantially vertical position.

46. A system as in claim 43, wherein said leg body is length-adjustable.

47. A system as in claim 43, wherein said transportation module further comprising a first motor, operable to drive at least two of said plurality of ground wheels, said motor configured to be connected to a source of power.

48. A system as claim 43, wherein said transportation module further comprising a second motor, operable to drive said approach wheel, said motor configured to be connected to a source of power.

49. A system as in claim 43, wherein said lifting assembly is powered.

50. A system as in claim 43, wherein said transportation module further comprising a handle connected to said rear end of said frame member.

51. A system as in claim 43, wherein said rear end of said frame member comprising at least one user engagement portion.

52. A system as in claim 43, wherein said transportation module further comprising a motor operable to drive at least two of said plurality of ground wheels and said at least one approach wheel.

53. A system as in claim 43, further comprising a tool carrier, said carrier connected to one of said plate member, or said cart body.

54. A system as in claim 43, wherein said heavy construction tools work cell further comprising a hood, said hood connected to one of said plate member or said cart body.

55. A system as in claim 43, wherein said one or more retainer assemblies comprising at least one retainer assembly including a plurality of holders.

56. A heavy construction tools transportation system comprising: a transportation module, a cart, and a heavy construction tools work cell, wherein said transportation module comprising:
a. a frame member defining a longitudinal axis and having a front and a rear opposing ends, wherein said front end comprising an overhang member having an overhang portion protruding downwardly below said frame member; said overhang portion having at least one approach wheel;
b. a base member comprising a plurality of ground wheels, said wheels configured for engaging and rolling over a supporting surface;
c. a lifting assembly connected between said base member and said frame member; said lifting assembly configured to lift and lower said frame member relative to said base member;
d. a leg member comprising a leg body and at least one loading wheel; said leg body having a first end and a second end; said first end connected to said frame member; and said loading wheel connected to said second end;
said cart comprising
a cart body; and
at least one front wheel;
said cart body comprising a front and a rear opposing sections, said front wheel mounted to said front section of said cart body; said cart body configured to detachably couple to said frame member of said transportation module;
said heavy construction tools work cell comprising
a plate member comprising a first end, an opposite second end, a first lateral side and an opposite second lateral side, wherein said plate member having a top surface, a bottom surface, a width defined by said first and second lateral sides; said plate member extending longitudinally between said first and second ends; and a perimeter defined by said first and second ends and said first and second lateral sides, wherein said plate member configured to detachably couple to said cart body;
a work cell frame connected to said plate member,
a table mounted atop of said work cell frame,
a supporting structure connected to said table; and
one or more retainer assemblies connected to said supporting structure.

57. A system as in claim 56, wherein said frame member further comprising leg-receiving means, so that said leg member operable to extend from and retract to said means.

58. A system as in claim 56, wherein said transportation module further comprising leg body immobilizing means configured to secure said leg member in substantially vertical position.

59. A system as in claim 56, wherein said leg body is length-adjustable.

60. A system as in claim 56, wherein said transportation module further comprising a first motor, operable to drive at least two of said plurality of ground wheels, said motor configured to be connected to a source of power.

61. A system as claim 56, wherein said transportation module further comprising a second motor, operable to drive said approach wheel, said motor configured to be connected to a source of power.

62. A system as in claim 56, wherein said lifting assembly is powered.

63. A system as in claim 56, wherein said transportation module further comprising a handle connected to said rear end of said frame member.

64. A system as in claim 56, wherein said rear end of said frame member comprising at least one user engagement portion.

65. A system as in claim 56, wherein said transportation module further comprising a motor operable to drive at least two of said plurality of ground wheels and said at least one approach wheel.

66. A system as in claim 56, further comprising a tool carrier, said carrier connected to one of said plate member, said cart body, said work cell frame, or said table.

67. A system as in claim 56, wherein said heavy construction tools work cell further comprising a hood, said hood connected to one of said plate member, said cart body, said work cell frame, or said table.

68. A system as in claim 56, wherein said one or more retainer assemblies comprising at least one retainer assembly including a plurality of holders.

69. A heavy construction tools transportation system comprising: a transportation module, a cart, and a heavy construction tools work cell, wherein said transportation module comprising:
a. a frame member defining a longitudinal axis and having a front and a rear opposing ends, wherein said front end comprising an overhang member having an overhang portion protruding downwardly below said frame member; said overhang portion having at least one approach wheel;
b. a base member comprising a plurality of ground wheels, said wheels configured for engaging and rolling over a supporting surface;
c. a lifting assembly connected between said base member and said frame member; said lifting assembly configured to lift and lower said frame member relative to said base member;
d. a leg member comprising a leg body and at least one loading wheel; said leg body having a first end and a second end; said first end connected to said frame member; and said loading wheel connected to said second end;
said cart comprising
a cart body; and
at least one front wheel;
said cart body comprising a front and a rear opposing sections, said front wheel mounted to said front section of said cart body; said cart body configured to detachably couple to said frame member of said transportation module;
said heavy construction tools work cell comprising
a plate member comprising a first end, an opposite second end, a first lateral side and an opposite second lateral side, wherein said plate member having a top surface, a bottom surface, a width defined by said first and second lateral sides; said plate member extending longitudinally between said first and second ends; and a perimeter defined by said first and second ends and said first and second lateral sides, wherein said plate member configured to detachably couple to said cart body;
a work cell frame connected to said plate member,
a table mounted atop of said work cell frame; and
one or more retainer assemblies connected to said table.

70. A method for loading a heavy construction tools transportation system comprising a transportation module, a cart and a heavy construction tools work cell to an elevated surface, the method comprising:
providing the system comprising a transportation module, a cart, and a heavy construction tools work cell; said transportation module comprising:
a. a frame member defining a longitudinal axis and having a front and a rear opposing ends, wherein said front end comprising an overhang member having an overhang portion protruding downwardly below said frame member; said overhang portion having at least one approach wheel;
b. a base member comprising a plurality of ground wheels, said wheels configured for engaging and rolling over a supporting surface;
c. a lifting assembly connected between said base member and said frame member; said lifting assembly configured to lift and lower said frame member relative to said base member;
d. a leg member comprising a leg body and at least one loading wheel; said leg body having a first end and a second end; said first end mounted to said frame member; and said loading wheel mounted to said second end;
said cart comprising: a cart body and at least one front wheel; said body having a front and a rear opposing sections; said front wheel mounted to said front section of said body; said cart body configured to detachably couple to said frame member of said transportation module; and
said heavy construction tools work cell comprising a plate member, said plate member comprising a first end, an opposite second end, and a first lateral side and an opposite second lateral side, wherein the plate member having a top surface, a bottom surface, and a width defined by said first and said second lateral sides, the plate member extending longitudinally between said first and second ends; and a perimeter defined by said first and second ends and said first and second lateral sides, wherein said plate member configured to detachable couple to said cart body;
coupling said plate member of said heavy construction tools work cell to said cart body of said cart;
coupling said cart body of said cart to said frame member of said transportation module;
advancing said system along a supporting surface toward an elevated surface edge via said plurality of ground wheels of said base member;
lifting said frame member relative to said base member via said lifting assembly, so that said front wheel is elevated to a height exceeding a height of the elevated surface;
advancing said system via said plurality of ground wheels until said base member is adjacent to an edge of the elevated surface and said front wheel is positioned above the elevated surface;
extending said leg member; so that said leg body has achieved substantially vertical position relative to the supporting surface;
securing said leg member in a position substantially vertical to the supporting surface;
lowering said frame member relative to said base member via said lift assembly until said front wheel engages the elevated surface;
lifting said base member relative to said frame member via said lift assembly, so that said ground wheels have substantially aligned with the elevated surface;
advancing said system via said front wheel and said loading wheel until said ground wheels engaged the elevated surface;
retracting said leg member.

71. A heavy construction tools transportation unit comprising a cart, and a heavy construction tools work cell, wherein said cart comprising a cart body and at least one front wheel; said cart body comprising a front and a rear opposing sections, said front wheel mounted to said front section of said cart body;
said heavy construction tools work cell comprising
a plate member comprising a first end, an opposite second end, a first lateral side and an opposite second lateral side, wherein said plate member having a top surface, a bottom surface, a width defined by said first and second lateral sides; said plate member extending longitudinally between said first and second ends; and a perimeter defined by said first and second ends and said first and second lateral sides, wherein said plate member configured to detachably couple to said cart body;
a supporting structure connected to said plate member; and
one or more retainer assemblies connected to said supporting structure.

72. A unit as in claim 71, wherein said one or more retainer assembly comprising at least one retainer assembly including a plurality of holders.

73. A unit as in claim 71, further comprising a tool carrier, said carrier connected to one of said plate member, or said cart body.

74. A unit as in claim 71, wherein said heavy construction tools work cell further comprising a hood connected to one of said plate member or said cart body.
